(19) United States
(12) Patent Application Publication
(10) Pub. No.: US 2007/0124789 A1
(43) Pub. Date: May 31, 2007

(54) Wireless interactive communication system

(76) Inventors: Thomas I. Sachson, St. Louis, MO (US); Mike Gulett, Monte Sereno, CA (US); Hans-Peter Metzler, Lustenau (AU)

Correspondence Address: PILLSBURY WINTHROP SHAW PITTMAN LLP, P.O. BOX 10500, MCLEAN, VA, 22102, US

(21) Appl. No.: 11/588,860

(22) Filed: Oct. 26, 2006

Related U.S. Application Data
(60) Provisional application No. 60/730,795, filed on Oct. 26, 2005.
(60) Provisional application No. 60/742,728, filed on Dec. 5, 2005.

(51) Int. Cl. H04N 7/173; H04N 7/16; H04M 1/00

(52) U.S. Cl. 725/117; 725/112; 725/113; 725/135; 725/62; 455/550.1; 725/126; 725/118

(57) ABSTRACT

An interactive communication system including a web-based content brokerage engine for the matching of meta data to audio content and audio+video content, for the encoding of such meta data into the audio-band or video-band channel of the specified audio content and audio+video content with such resulting encoded content being capable of further dissemination through any traditional distribution system. Following such dissemination, the encoded content is played on a playback console, such as a radio, television, or related peripheral content playback device. A device connected to or incorporated within the playback console, both extracts the encoded meta data from the encoded content and transmits the resulting decoded meta data and related information via an attached short-range wireless transceiver to a target device (e.g. a short-range wireless enabled cellular phone). Thereafter, the user's target device allows the user to view relevant portions of the relayed data package as a textual message on the display of the target device, and respond to this message by submitting a user response via the target device keypad. The target device sends a textual message response (incorporating the user response and associated data) via the target device's wireless network's short message service (or equivalent) to an entity, such as the interactive communication system operator, which may thereafter act upon the textual message response so received. A further act of the entity could involve the entity auditing, storing, and analyzing the data relating to the textual message response, forwarding data related to the textual message response to an appropriate further entity, or initiating a subsequent communication back toward the user of the short-range wireless enabled cellular phone, or any combination thereof. The content brokerage engine can also be used for the matching of content and meta data in communication systems distinct from and separate to the interactive communication system.

### CROSS-RELATED APPLICATIONS

This application claims priority to U.S. Provisional Patent application Ser. No. 60/730,795 filed on Oct. 26, 2005, and U.S. Provisional Patent application Ser. No. 60/742,728 filed Dec. 5, 2005, which are hereby incorporated in their entirety by reference.

### FIELD OF THE INVENTION

The present invention relates generally to methods and systems of communication, and more particularly to a method and system wherein interactive meta data is commercially matched to audio and/or video content, meta data is encoded into such paired audio and/or video content, the encoded content is transmitted to a playback console, the meta data is extracted from the content and formatted with associated data, the extracted and formatted data is transmitted to a target device, and the target device transmits final data to an entity based upon the response generated by the user of the target device.

### BACKGROUND OF THE INVENTION

The Internet and the World-Wide Web (WWW) have demonstrated the tremendous utility and appeal of allowing consumers of WWW content (audio, video, or both) to engage in computer enabled interactivity relating directly or indirectly to their experience of that particular WWW content. As a result, numerous new service offerings have been made available to WWW participants, with web-based businesses combining various aspects of entertainment, news, search, advertising, commerce, and otherwise, with each enjoying tremendous user acceptance and economic growth. As proof of this success, it is estimated that the world now has in excess of one billion WWW users and revenues associated with WWW advertising and commerce are growing at a healthy pace. Notwithstanding this success, however, the majority of the world's population (currently in excess of six billion people) does not yet have regular WWW access. Furthermore, given current global economic realities, it is very likely that the majority of the world's population will not have consistent, reliable WWW access for many years to come.

As such, it is widely held that a supplemental system capable of providing content related interactivity that is not predicated upon having access to a traditional computer and Internet connection is desirable. Specifically, such a supplemental system would be capable of providing contextually relevant interactivity through devices that the majority of the world's population already, or will shortly, have access to—the traditional television set (or radio set) and the cellular telephone handset (or analogous mobile device). However, marshalling the functionality of these types of devices in a manner where their combined use is capable of providing an acceptable level and quality of content interactivity has proven elusive. Numerous proposals have already been put forth in the prior art, but none have managed to find widespread adoption in the markets due to limitations in their overall utility. Specifically, earlier proposals have failed to cure deficiencies impacting not only prospective end-users, but have also failed to take into consideration the needs of prospective value-chain participants in the fields of traditional television and radio broadcast, advertising, original equipment manufacturer (e.g. audio and video playback consoles) cellular network operators, and other relevant fields

Accordingly, a need exists for a new system that can provide interactivity to the majority of the world's population leveraging upon the enormous pre-installed base of television sets, radio sets, and cellular phone handsets, and which also cures the deficiencies of the prior art as such relates to prospective end-users of such interactive content services, as well as the prospective value-chain participants in fields directly and indirectly supporting the delivery of such a new content related interactive service (device manufacturers, content creators, distributors, advertisers, etc.).

### Brief Description of the Prior Art

a. Traditional Content Distribution Systems Have Limited Interactivity.

The “value chain” relating to traditional content distribution systems is understood by content owners, advertisers, distributors/broadcasters, playback console manufacturers, and audience members. Traditional content distribution systems have established methods of putting content together with advertising messages to reach audience members, and for securing revenue streams for such; traditional content distribution systems have established methods of putting playback consoles into the market, and for securing revenue streams for such; and traditional content distribution systems have an established audience member base that knows how to use the playback consoles, and to a lesser extent, engage in interactive activities using the playback consoles (e.g. interactivity via the cable TV set-top box). Moreover, traditional content distribution systems have shown promise in terms of fostering audience member interactivity via alternative content distribution systems. In particular, mixing audience member content experience and cellular telephone interactivity (American Idol SMS/short message service voting, etc.).

However, the revenue model associated with traditional content distribution systems is being diluted by numerous developments, including the growth in the content rental market (e.g. NetFlix), growth in content piracy (e.g. peer-to-peer sharing), growth in Internet content competition (e.g. portals), growth in subscription content competition (e.g. cable TV), and degradation of the commercial sponsor revenue model (e.g. 30 second commercials not being watched by owners with personal video recording (PVR/TiVo) capabilities). As such, it is widely held that the future of traditional content distribution systems will turn on the ability of traditional market participants to introduce new, viable revenue streams to supplement the current dilution referred to above. It is further held that introducing interactive capabilities into the traditional content experience will be a crucial component of any newly formulated revenue model to be generated.

Unfortunately, apart from cable and fiber optic broadcast distribution channels, no viable data return path exists within traditional content distribution systems to effect audience member interactivity (e.g. terrestrial TV is a “one-way” proposition, as is satellite TV for the most part), and therefore suffers in comparison to competing interactive content delivery systems (e.g. Internet). Yet, despite the potential return path capabilities, both cable and fiber optic broadcast channels have clumsy or limited interactivity components in that such are constrained by the need for a separate user interface (e.g. keyboard) or embodiment in the form of a generic remote control (e.g. “red button” solutions). Further, cable and fiber optic broadcast channels have limited user interactivity due to the difficulty in having more than one person registered with the content provider to engage in interactivity (e.g. a cable TV subscription is typically in the name of only one member of the household). As such, it is difficult to have multiple users interacting and conversely, an audience member cannot take their interactivity with them “on the road”.

These limitations (and similar limitations relating to other content distribution systems via CD and/or DVD playback) have prompted value-chain market participants to look for alternative and/or supplemental methods for imbuing a form of user-friendly, scalable interactivity into these traditional content distribution systems. To this end, the traditional content distribution system has shown promise in terms of promoting interactivity relating to an audience member's content experience by utilizing an alternative content distribution system in the form of cellular telephone messaging (American Idol SMS voting, etc.). However, in this scenario, the audience member interactivity must be prompted by a visual and/or audible cue on the screen and/or speaker of the playback console, thereby limiting the applications mostly to those involving content concerning games or voting. Further, the insertion of cues onto the screen and/or into the audio tend to be a distraction to the primary content being experienced, especially for any audience members who are not seeking to interact with the content but merely wish to experience the content in a passive, non-interactive manner.

Techniques designed to eliminate the use of visual and/or audible cues on the screen and/or speaker of the playback console are in and of themselves limited since such cues have only been avoided by sending cues directly to cellular phones as SMS or IM messages at the time of the content airing (i.e. the message must be synchronized to a particular broadcast recordings). This has the negative aspect of generating large message distributions (spam) at great cost to the audience members and the sender of the message. In addition, efforts to curb the “spamming” of audience members involve the audience member registering for the messages in advance (again, highly impractical).

b. Prior Art Solutions Bolster Traditional Content Distribution Systems With Alternative Data Return Path Capabilities

Traditional content distribution systems are capable of utilizing alternative content distribution systems to affect a viable data return path for content that traditionally would be non-interactive. While many alternative content distribution systems have been put forth, only those focusing on utilizing the cellular telephone network appear feasible. Cellular telephone networks are standardized, global, and tied into the basic communication-networking grid. Moreover, the handsets used by cellular telephone network users are well understood by their owners, are currently deployed in high numbers, are anticipated to continue to be deployed in even higher numbers, and have declining price to performance ratios. For these reasons, the current invention puts forth a comprehensive interactive communication system for creating a novel and-useful alternative content distribution system that utilizes the cellular telephone network or analogous mobile communication systems.

The prior art has tried to fashion an alternative content distribution system out of the cellular telephone system by formulating methods of connecting playback consoles to cellular telephones. However, the proposed connection techniques have failed to result in meaningful market adoptions. Efforts focused on affecting a playback console to cellular telephone connection based upon establishing a wired (cabled) connection have failed due to the physical limitations of the technique, and specifically the limitations imposed by the having to attach a data cable to the playback console. Such a requirement typically mandates that only one audience member can interact at a time (absent a splitting device), and even then the cellular phones would require identical data connection interfaces to use the splitter. Further, an audience member would be forced to experience the content within a radius no larger than the length of the data cable. Finally, cables become unplugged easily, and are not always convenient to plug back in.

Efforts focused on effecting a playback console to cellular telephone connection based upon establishing a audible (acoustic transport) connection have failed due to the physical limitations of the technique, and specifically the need for hyper-sensitive acoustic transducers to be housed within or attached to the cellular telephone. In addition, sophisticated decoding capabilities would also be required in or attached to the transducer, adding weight, further cost, and pronounced power drain to the cellular telephone. Finally, even where the pre-installed cellular telephone microphone could affect the transducer function, the need to have a clear audible signal would be paramount. As such, signal degradation caused by ambient sound in the operating environment or a loss of acoustic quality due to poor speaker condition (or volume) effectively preclude market wide adoption of this type of technique.

Efforts focused on affecting a playback console to cellular telephone connection based upon establishing an optical (light pattern or image recognition type) connection have failed due to the physical limitations of the technique, and specifically the need for hyper-sensitive optical sensors to be housed within or attached to the cellular telephone. In addition, sophisticated decoding capabilities would also be required in or attached to the optical sensor, adding weight, further cost, and pronounced power drain to the cellular telephone. Finally, even where the pre-installed cellular telephone camera lens could affect the optical sensor function, the need to have a clear optical signal would be paramount. As such, signal degradation caused by ambient light in the operating environment or a loss of optical quality due to poor screen condition (or loss of line of sight with the screen) effectively preclude market wide adoption of this type of technique. Another limitation is that the technique is not suited to the radio content experience, which typically does not utilize a video screen.

Efforts focused on effecting a playback console to cellular telephone connection based upon establishing a infrared connection have failed due to the physical limitations of the technique, and specifically the need for there to be both an infrared send capability mounted in the front of any playback console (e.g. added cost, form factor issues for manufacturers of consoles). Further, infrared sensors would also need to be housed within or attached to the cellular telephone as well. In addition, sophisticated decoding capabilities would also be required in or attached to the infrared sensor, adding weight, further cost, and pronounced power drain to the cellular telephone, as would decoding capabilities be required in the infrared send device attached to the console (again, added cost). Finally, even where the infrared functionality could be affected by the pre-installed cellular telephone's infrared capabilities (in some, but not all phones), there would always be a need to have a clear line-of-sight between the sensor and the playback console.

Notwithstanding the fact that the major deficiencies set forth above relating to wired, audible, optical, and infrared connection techniques are not shared by short-range radio frequency connection techniques, efforts focused on creating a viable playback console to cellular telephone connection based upon such radio frequency connection techniques have also failed to result in meaningful market adoptions. However, the reason behind this failure is not rooted in the physical limitations of radio frequency transport itself. Radio frequency connection techniques are superior in most regards to the techniques set forth above, being capable of reliable operation in environments lacking line-of-sight, poor ambient light conditions, poor ambient sound conditions, as well as working irrespective of playback console screen and speaker deficiencies, working irrespective of interfering structures and objects, working over long distances, having functional components already mass produced in the markets and at times (e.g. Bluetooth) already being deployed in cellular handsets in great quantities. Instead, radio frequency solutions have not been adopted as a means of connecting a playback console to a cellular telephone due to failures in the prior art to incorporate technical features into the proposed system that will motivate value chain participants (content providers, advertisers, equipment manufacturers, etc.) to deploy and promote such a connection system and provide the one-way content delivery market with the viable alternative content distribution system it needs to effect audience member interactivity with content.

### BRIEF SUMMARY OF THE INVENTION

The technical requirements associated with an alternative content distribution system based on connecting playback consoles to cellular telephones (or analogous) touches on several technical fields, specifically the fields of: (i) discrete data encoding into audio and/or video content, (ii) discrete decoding of the same, (iii) radio frequency transmission of data from decoding entities to targeted relay devices, (iv) platform independent interactive software applications (e.g. java applications), (v) database construction and data management, and (vi) web-based, client-server commerce systems.

In the aggregate, the prior art relating to the creation of an alternative content distribution system based on connecting playback consoles to cellular telephones has touched on points (i) through (v). The prior art, however, has not contemplated the importance of incorporating a relevant web-based, client-server commerce systems as an integrated and vital element of such an alternative content distribution system. As such, much of the discussion relating to the current invention will focus on this element as embodied in a content brokerage engine. In short, absent a viable system for the matching of content providers with parties seeking to encode their interactive messages into such content, there will not be enough interactive content available in the market (or anticipated to be in the market in the future) to justify the time, reputation, and monetary investment by value chain participants to make such an alternative content distribution system a reality.

Further, while the prior art has addressed techniques relating to points (i) through (v) above, the prior art has failed to include certain technical features that underpin the commercial motivation of value chain participants to deploy and promote an alternative content distribution system based on connecting playback consoles to cellular telephones.

For instance, looking to existing stand-alone devices that link cellular telephones to television sets (e.g. externally hosted device resident on a television set), the only devices that have come to market are those that allow the sending of audio (MP3) and image (JPEG) content data from the cellular phone to the television (see Sony Ericsson MMV-100). These devices, however, do not allow for the sending of content data from the television set to the cellular phone. These sophisticated device manufacturers; having looked at the state of the current market saw no commercial value to be gained by having the radio frequency link (save for the initial Bluetooth handshake communications) go both ways. Proposals set forth only in patent prior art (i.e. patented, but not deployed in the market), show that thought given to the idea of having content data flow from the television set to a cellular phone (or mobile communication target device as the case may be). But these prior art proposals have not manifested themselves in real world deployments, because something is still “missing” in the prior art that would facilitate such a deployment. For instance, some of the prior art requires the installation of intrusive, user “profiling” software on an audience member's cellular telephone to insure the contextual relevancy of interactive content delivered to the device. The present invention does not require any such invasiveness, instead relying on other technical features to affect a contextually relevant experience for the user. Moreover, the prior art fails to incorporate technical features that serve to accurately monitor the flow of interactive data through the interactive communication system, specifically focusing on what specific data flows through which particular devices (decoders, transceivers, and cellular handsets). In this regard, it is one purpose of the current invention to map those devices in the market that serve to enable the success of the interactive communication system and thereafter reward the enablers (e.g. manufacturers) of such devices by sharing with these enablers portions of the revenues resulting from the interactive services offered by the system and flowing through their deployed devices. Conversely, the current invention incorporates technical features to monitor those parties that are system abusers in the sense that they seek to acquire the benefits of the interactive system without paying for the right to use the same, and do so by pirating some of the proprietary encoding techniques utilized by the interactive communication system.

The present invention therefore provides the critical technical elements required to bring such an alternative content distribution system to the commercial market.

Further, in setting forth the technical requirements necessary to effect a viable alternative content delivery system, the current invention has also set forth a new and useful market mechanism in the form of a content brokerage engine that is capable of creating and distributing interactive content, whether such interactive content is to be distributed within the alternative content distribution system contemplated above or whether such interactive content is to be distributed within the any other interactive content distribution system (e.g. the Internet, print media). Specifically the content brokerage engine of the present invention is a web-based commerce platform that allows owners of primary content (TV and radio shows, music videos, music, live events, etc.) to market and sell to other parties the right to encode their own interactive meta data (sponsored content in the form of advertisements, contests, voting functions, etc.) into the seller's primary content. Similarly, the content brokerage engine allows parties wishing to encode their interactive meta data into such primary content the ability to search for, review, purchase the rights to encode, and the technical ability to encode their data into such primary content. Such commercial transactions can be effected on the web-platform through a straight purchase, bid, or analogous transaction format. Further, the rights purchased may relate to either a live or recorded segment of primary content to be distributed through a variety of means (radio broadcast, physical means, etc.) and in a variety of markets (local, regional, national, etc.). As such, the content brokerage engine is a new and useful tool in the developing field of interactive content. This tool is distinguished from the prior art in several regards. First, the most relevant prior art concerns itself with the matching of primary content (e.g. shows) to sponsored content (e.g. advertising) that is affirmatively presented to the audience member (e.g. the viewer is presented the sponsored content without their prior consent to experience such). The prior art does not contemplate a participant managed (e.g. non-automated) web-based marketplace for the pairing of primary content to sponsored content where the latter is discretely encoded into the former so that the audience member must affirmative seek out exposure to the sponsored content. By way of example, much of the prior art provides for content matching platforms allowing advertisers to bid for time slots offered by broadcasters (TV, radio, Internet) in conjunction with the broadcaster broadcasting the primary content. In the case of the current invention's content brokerage engine, there is no attempt toward temporal “sequentially placement” of sponsored content (advertising or analogous message) to primary content (i.e. program's primary content is followed by 30-second commercial sponsored content is followed by program's primary content, etc.), nor is there an attempt to “embed” sponsored content (advertising or analogous message) into the program's primary content (i.e. an ad banner on a TV or Internet screen or advertiser's paid for link on an Internet search results page). In the current invention the content brokerage engine facilitates only pairing exercises that involve the encoding of interactive meta data within the content signal, with such encoded data providing audience member interactivity potential only where the audience member affirmatively seeks such interactivity (no sequential placement and no embedding of sponsored content into primary content). Second, the web-based commerce platforms in the prior art focus on commercial bidding models engaged in the bidding for particular key words in the content (Google) or key words associated with content—as opposed to bidding on the right to encode into content per se based upon a bidder's substantive review of the content and its associated properties (targeted demographics, market for distribution, subject matter, etc.). For these reasons, and others set forth in the materials below, the current invention's content brokerage engine is a useful innovation over the prior art.

### IN THE DRAWING

FIG. 1 is a flow chart of the communication environment in which the present invention operates;

FIG. 2 is a flow chart of the communication environment in which the present invention operates and shows the basic direction of data communication flows;

FIG. 3 is a flow chart of the communication environment in which the present invention operates, highlighting the new short-range wireless data “bridge” communication path to be created by the present invention;

FIG. 4 is a flow chart of the communication environment in which the present invention operates, highlighting the new short-range wireless data “bridge” communication path to be created by the present invention, and showing the resulting direction of data communication flows;

FIG. 5 shows the matching of meta data to content utilizing a content brokerage engine, as well as the subsequent data mapping and transmission sequence used for the delivery of meta data through a typical communication environment in the preferred embodiment of the present invention;

FIG. 6 is a schematic block diagram of the meta data encoder used for modulating and mixing the meta data of the present invention into either an analog or digital signal associated with the content;

FIG. 7 is a schematic block diagram of the meta data decoder used for decoding the meta data of the present invention from either an analog or digital signal associated with the content;

FIG. 8 is a schematic block diagram of the meta data bridge of the present invention comprised of the meta data Decoder and a short-range wireless transceiver respectively used for the decoding of meta data from content for subsequent transmission of such decoded meta data (and related information) to a target device via a short-range radio frequency channel broadcast;

FIG. 9 is a schematic block diagram of the meta data bridge of the present invention comprised of the meta data decoder and a short-range wireless transceiver, with such diagram highlighting the functional ability of the current invention to identify system abusers as well as system enablers, with such identification by the interactive communication system operator enabling him to take punitive measures against the former while simultaneously rewarding the latter.

FIG. 10 is a schematic block diagram of the meta data bridge in the form of an externally hosted adaptor to be attached to a playback console, such attachment drawing encoded meta data through either an RCA of SCART data transfer interface connection;

FIG. 11 shows two SCART configurations for a meta data bridge in the form of Externally hosted adaptors which contain the meta data Decoder, short-range wireless transceiver, and wall plug power source in the preferred embodiment of the invention;

FIG. 12 shows two SCART configurations for a meta data bridge in the form of Externally hosted adaptors which contain the meta data Decoder, short-range wireless transceiver, and self-contained alternatives to a wall plug power source in the preferred embodiment of the invention;

FIG. 13 shows the data mapping used for the transport of relayed data packages as sent from a playback console's meta data bridge in the form of an externally hosted adaptor to any number of target devices in the preferred embodiment of the present invention;

FIG. 14 shows the data mapping, decoding, and transmission sequence used for the delivery of a relayed data package to a target device, as well as the modification of such relayed data package by a the user response as effected by the java application hosted on the target device in the preferred embodiment of the present invention;

FIG. 15 shows the data mapping used for the transport of textual message responses through a target device wireless network for subsequent delivery to the back-end services database of the interactive communication system operator in the preferred embodiment of the present invention;

FIG. 16 shows a flow chart illustrating a web-based process by which a content provider may submit and annotate his own content segments for subsequent search, review, selection, purchase, and encoding by a party seeking to encode her own primary meta data into a particular content segment submission in the preferred embodiment of the present invention;

FIG. 17 shows a flow chart illustrating a web-based process by which a content encoder may search, review, select, purchase, and encode their own primary meta data into a particular content segment submission made available for such by a content provider in the preferred embodiment of the present invention;

FIG. 18 shows a flow chart illustrating a web-based sample process by which a content encoder may engage in a structured auction process, competing with other similarly situated content encoders, each vying for the right to encode their own primary meta data into a particular content segment submission made available for such by a content provider in the preferred embodiment of the present invention;

FIG. 19 shows a flow chart illustrating a web-based process by which a content provider and content encoder interact to effect an encoding of auxiliary meta data and primary meta data into content, and where such interaction results in matched content and primary meta data being submitted to a meta data encoder for encoding in the preferred embodiment of the present invention;

FIG. 20 shows the incremental aggregation of data within the content brokerage engine resulting from the content provider's input of content and related information and from the content brokerage engine's processing of such inputs in the preferred embodiment of the present invention;

FIG. 21 shows the incremental aggregation of data within the content brokerage engine resulting from the content encoder's input of primary meta data and related information and from the content brokerage engine's processing of such input in the preferred embodiment of the present invention;

FIG. 22 shows the process by which content, meta data, and associated information is disseminated across and through a communication environment in which the system of the present invention operates in the preferred embodiment of the present invention;

FIG. 23 shows the process by which content, meta data, user response, and associated information is incrementally aggregated within the collective operations of the interactive communication system comprised of the content brokerage engine and corresponding back-end services database, with such aggregation derived from input generated by the content brokerage engine, content providers, content encoders, users, and various third-party participants within the affiliated communication environment in which the system of the present invention operates in the preferred embodiment of the present invention;

FIG. 24 shows an overview of the current video and audio pairing models characterized by the sequential time placement of sponsored content next to primary content;

FIG. 25 shows an overview of the current video, audio, web page, and print media pairing models characterized by the perceptible embedding of sponsored content into primary content;

FIG. 26 shows an overview of the video, audio, web page, and print media pairing models enabled by the current invention's content brokerage engine which is characterized by the discrete, imperceptible encoding of sponsored content into primary content;

FIG. 27 provides a basic flow chart outlining the possible video related applications for the delivery and use of discrete, imperceptible encoding of sponsored content into primary content as enabled by the current invention's content brokerage engine;

FIG. 28 provides a basic flow chart outlining the possible audio related applications for the delivery and use of discrete, imperceptible encoding of sponsored content into primary content as enabled by the current invention's content brokerage engine;

FIG. 29 provides a basic flow chart outlining the possible web page related applications for the delivery and use of discrete, imperceptible encoding of sponsored content into primary content as enabled by the current invention's content brokerage engine;

FIG. 30 provides a basic flow chart outlining the possible print related applications for the delivery and use of discrete, imperceptible encoding of sponsored content into primary content as enabled by the current invention's content brokerage engine; and

FIG. 31 shows an overview of the various types of content brokerage models currently found in the prior art, focusing on those that use auction processes to determine highest and best utility, and how the content brokerage engine set forth in the current invention is unique in comparison to the prior art.

### DETAILED DESCRIPTION OF THE INVENTION

The following description of the interactive communication system is an example of the principals of the current invention and is not intended to limit the invention to the specific embodiments described herein. The current invention is susceptible to many different forms. Nonetheless, the following is an example of the preferred embodiment as presently conceived, taking into consideration the need to standardize certain elements in the interests of describing a practical implementation of the principals contained herein.

Basic Functionality of the Invention

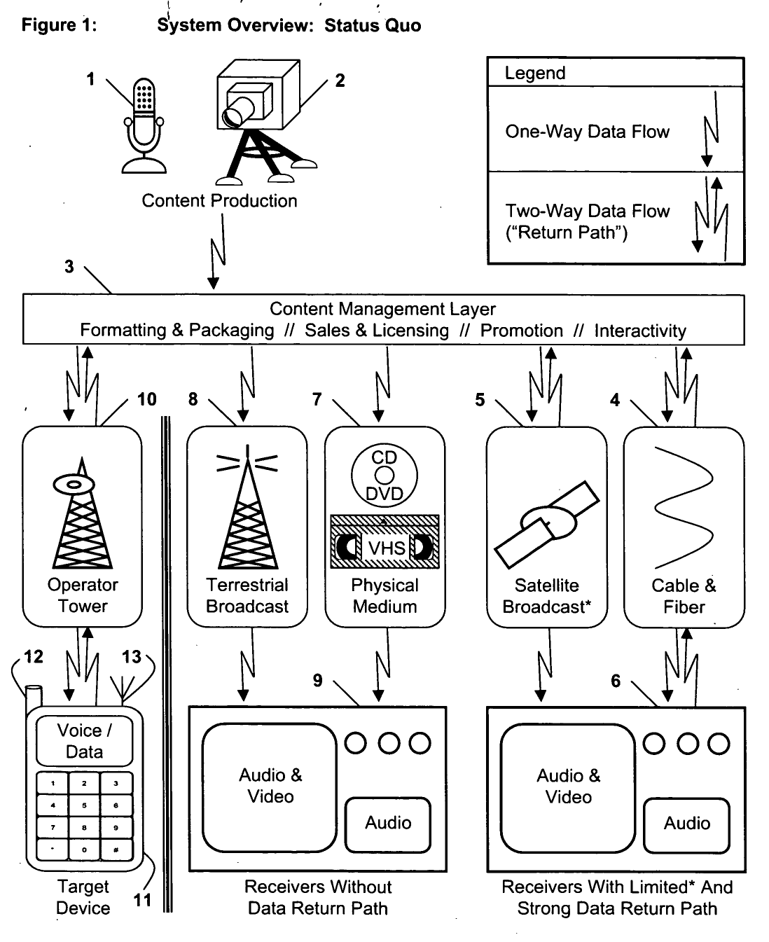

Referring now to FIG. 1 of the drawings, the present invention seeks to enhance the communication paths currently associated with traditional audio and video content distribution. In a traditional content delivery system, audio content and video content (collectively content) is created at a content production facility, with such content being either Recorded for subsequent distribution or prepared for live broadcast. Following the production of such, the content is forwarded through a content management layer typically providing the content owners (parties entitled to distribute, modify, or otherwise control the content) the ability to format, package, sell, license, promote, and interact with the content to facilitate its dissemination through traditional distribution channels. Traditional channels are usually distribution channels for delivering the content to television and radio sets (including peripheral playback devices such as receivers, tape players, CD players, DVD players and analogous, and collectively with their associated radio and television sets, termed herein as playback consoles), with such channels typically being characterized as cable and fiber optic broadcast systems, satellite broadcast systems, and terrestrial broadcast systems, as well as encompassing delivery through a physical medium like an audio CD, DVD, VHS tape, silicon memory device, or analogous storage device. Of these systems, terrestrial broadcast and physical medium are almost exclusively “one way” distribution systems in the sense that once the content has been delivered to a playback console, there is no viable means for an interactive response to that content to be sent back through the same delivery channel to the content management Layer by the audience member experiencing that content (save that some storage devices have functions that allow some interactivity if played back on a computer or set-top box with an Internet connection). The same is more or less true for satellite broadcast systems (although some sophisticated systems utilizing expensive receivers do have some limited “two way” capabilities). It is only the cable and fiber optic broadcast systems that possess a credible “two way” communication capability (termed herein as a data return path), allowing attached playback consoles to transmit back to the distributor and/or owner of the content an interactive response of the audience member experiencing such content through a cable or fiber optic broadcast system.

In addition to these traditional channels, there are mature voice and data cellular telephone networks which are now evolving into early-stage rich media distribution channels that may over time provide comprehensive content delivery and data return path capabilities akin to those of cable and fiber optic broadcast systems. Nonetheless, in their current form they are limited in the amount of content they in fact distribute to cellular telephone handsets by virtue of a combination of their bandwidth constraints, lack of suitable content for mobile viewing, lack of customer demand, and excessive data delivery costs. But over time, the cellular distribution channel will become a competitive platform for the delivery of content to audience members and to facilitate those audience members' interaction with content. In the meantime, however, the cellular telephone platform (cellular networks, cellular network operators, and participating handsets) is a tremendously successful system enabling mobile voice and basic data services (text messaging, ring tones, instant messaging, photo sharing) and continues to grow in terms of services offered and persons served.

Further, it is important to note that cellular telephones tend to have more than one way to communicate with other communication objects, and do so utilizing an assortment of radio frequency techniques. For example, there are currently estimated to be over 300 million cellular telephones with non-cellular short-range wireless transmission capabilities already built into cellular telephone handsets in the form of embedded Bluetooth transceivers, in addition to the cellular transmission capabilities used for their networked voice services. Moreover, industry analysts expect this Bluetooth penetration to increase rapidly in the years to come, with perhaps 1.5 billion cellular telephone handsets being Bluetooth enabled by 2010 (roughly every other cellular handset in use in 2010 to have a Bluetooth capability).

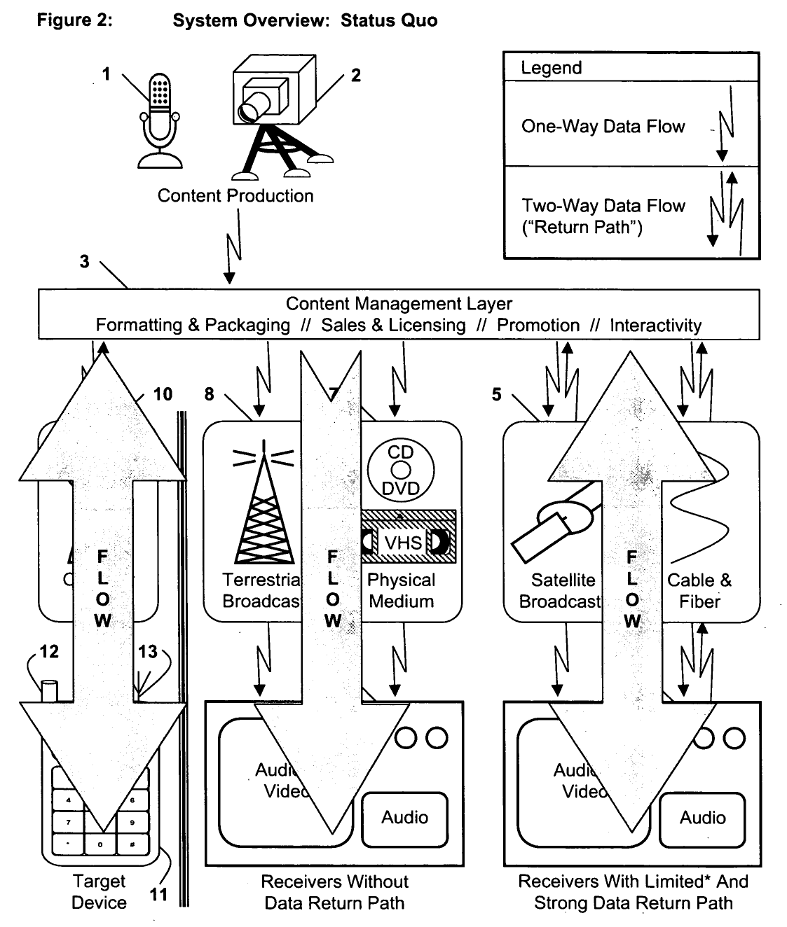

Turning to FIG. 2, one can see the basic data flow properties typically associated with each distribution system. In particular, the terrestrial broadcast and physical delivery channels (and to a meaningful extent the satellite broadcast channel) are one-way, and arguably of declining relative value when compared to the channels capable of providing data return path capabilities (e.g. cellular network and cable/fiber optic). It is one of the purposes of the current invention to mitigate this one-way deficiency and provide a viable data return path for those channels that currently do not have meaningful two-way capabilities (e.g. terrestrial broadcast), and to do so by providing a comprehensive system by which these one-way systems can access and utilize the data return path capabilities of cellular telephones (or analogous wireless networked devices) and, in particular, exploit the large deployment of short-range wireless transmission capabilities (e.g. Bluetooth) incorporated within those cellular telephones already in the market.

Specifically, the current invention proposes that interactive data (termed herein as meta data) be encoded into all content where the owners of such wish to offer prospective audience members the opportunity to interact with such content, and to do so using their short-range wireless transmission enabled cellular telephones (termed herein as target devices) as the “bridge” between the one-way content delivery system and the two-way data return path system. As such, it is a purpose of the current invention to have the target device act as the user interface for such audience member's content interaction, as well as the relay device capable of sending these interactive responses back to the content owners and their affiliates (advertisers, etc.). It is worth noting for purposes of the current invention, the term target devices should be deemed to also include PDAs, laptops, or other mobile communication devices, now or in the future, that rely on existing or next generation cellular and/or radio frequency transmission standards.

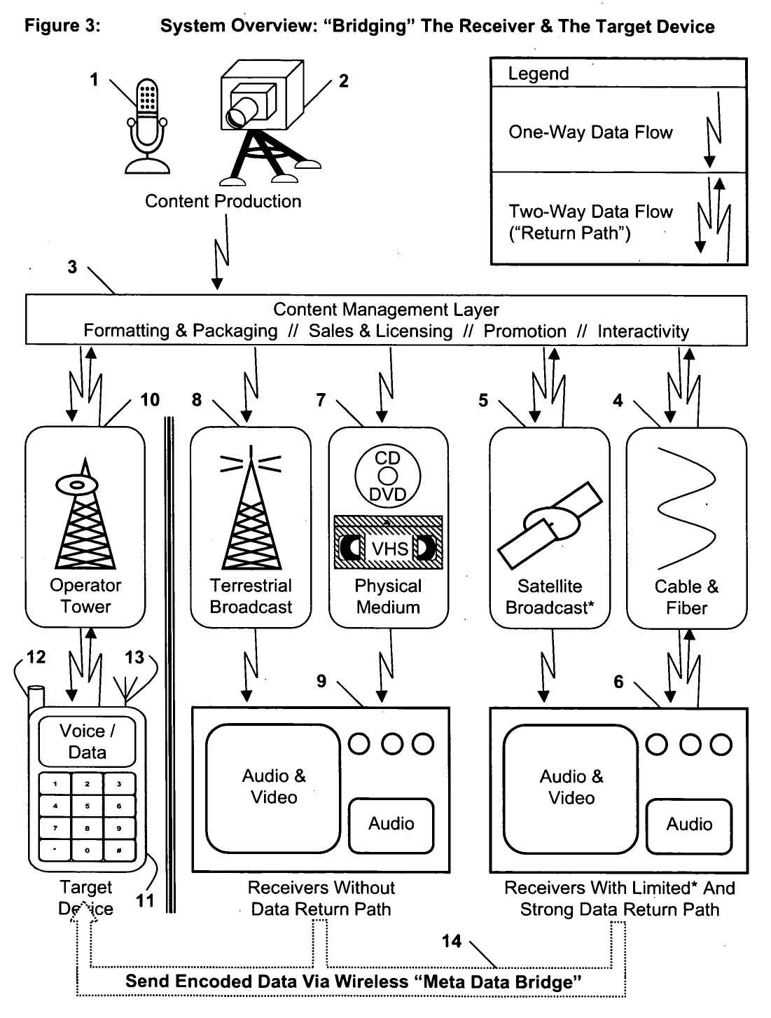

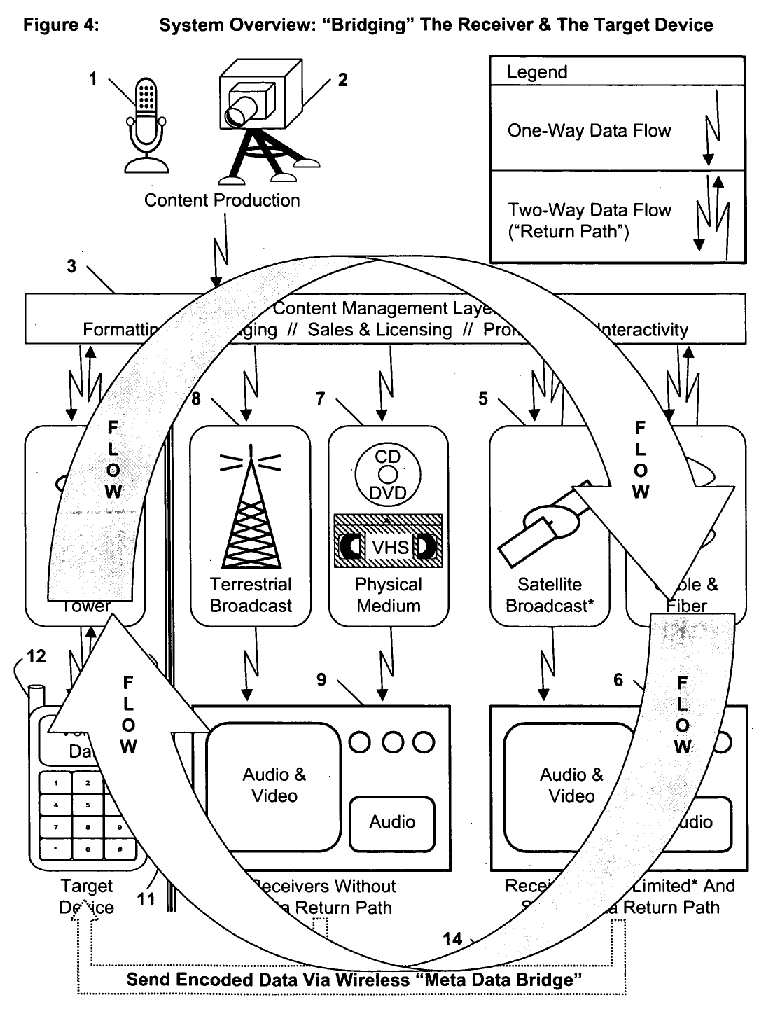

Referring to FIG. 3, the current invention proposes to bridge playback consoles (whether such playback consoles are part of a one-way distribution system playback console or two-way distribution system playback consoles) to target device by sending interactive data wirelessly across a short-range wireless link established between the playback console and the target device, with such bridging being affected by a device (termed herein as a meta data bridge) attached to or housed within the playback console in question. As seen in FIG. 4, the meta data bridge results in an enhanced data flow where the previously one-way systems now have a viable data return path and can be deemed two-way systems by leveraging upon the target device's interactive user interface, short-range wireless link, and cellular relay 9 or analogous) capabilities.

As previously mentioned, similar wired and wireless bridges have been envisioned in some of the prior art and the current invention recognizes such. However, the prior art does not contemplate how the parties to such a bridged communication might actually effect such a bridge in a real world scenario involving issues distinct from merely the technical aspects associated with basic encoding of data into content, decoding the same, and passing the results onto a rely device for further interaction, and delivery of the resulting interactive data to a content owner, advertiser, and/or their affiliates. As those versed in the art will concede, such a bridging will require the support and participation of any one or more of content owners, parties wishing to encode into that content, distributors and broadcasters of that content, equipment manufacturers charged with deploying the bridging devices (as external attachments to playback consoles or as built within playback consoles), cellular network operators, cellular telephone handset manufacturers, and participating audience members. The current invention contemplates these real world factors and has developed technical solutions that will allow these parties to effectively work together on a viable bridging initiative.

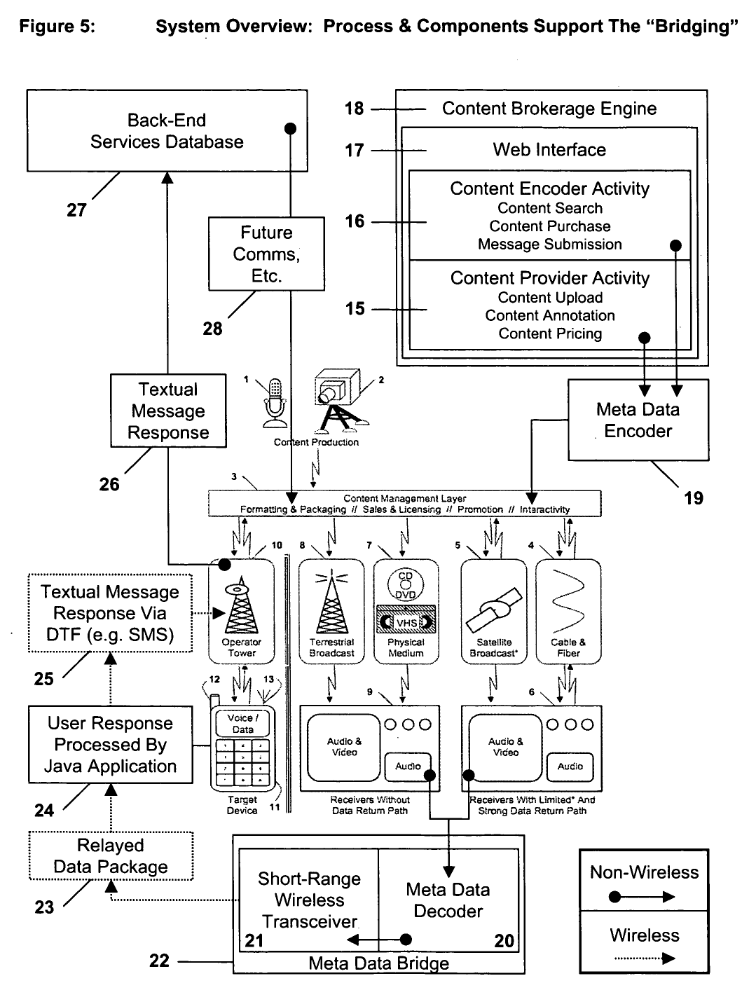

Turning to FIG. 5 one can see the six functional elements of the current invention (content brokerage engine, meta data encoder, meta data decoder, short-range wireless transceiver, java application, and back-end services database), which as an integrated system, has not been contemplated by the prior art.

Of these six elements, perhaps the content brokerage engine is the most critical element in terms of real world utility in that its absence precludes any large-scale (local, regional, and national), simple, low-cost, and accurate matching of content to contextually relevant meta data. Without a viable technique to automate the matching process, there is simply too much content dispersed across too many fragmented media markets to reasonably expect content owners and parties wising to encode meta data into that content to seek each other out and negotiate mutually agreeable terms for the encoding of meta data into a particular segment of content to be distributed in a particular market. As such, the current invention sets forth a unique content brokerage engine which functions as a web-based platform and intuitive web interface allowing content owners (content providers) to submit and annotate their content for subsequent search, review, purchase, and encoding by content encoders wishing to encode their meta data into such content prior to its distribution to audience members via a permissible distribution system (terrestrial broadcast, cable broadcast, physical medium, etc.). Conversely, it is also worth noting that absent a viable mechanism for the pairing of content to meta data, there will never be enough encoded content available at any one time to justify the cost and effort associated with deploying bridging devices (each a meta data bridge comprised of a meta data decoder and short-range wireless transceiver) throughout the market.

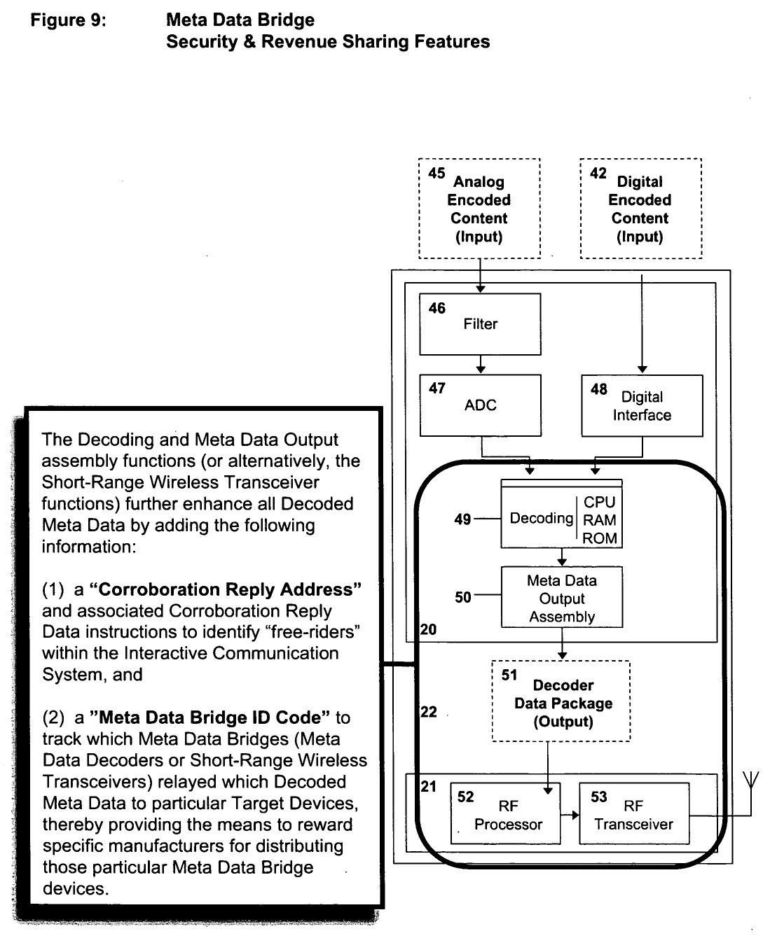

The second element of the current invention set forth in FIG. 5 is the meta data encoder which takes paired content and meta data from the content brokerage engine and mixes the latter into the former as discrete encoding within the content's audio-band channel or the content's video-band channel. As will be described in further detail later in this description, the meta data encoded within the content by the meta data encoder is either primary or auxiliary in nature. Briefly, meta data provided by the content encoder is termed primary meta data (see FIG. 9) because it includes the body and functional components of the interactive message to be delivered to the audience member's target device at the time such audience member experiences the content embedded with such meta data. In contrast, auxiliary meta data (see FIG. 9) is meta data generated by the content brokerage engine that facilitates the delivery of any audience member interactive response to a back-end services database that processes the interactive responses so received.

Once the content is encoded with meta data by the meta data encoder, the resulting encoded content is sent back into the content management layer (e.g. typically through either the content owner or their agent) for further dissemination through various distribution channels (e.g. terrestrial broadcast, physical medium). Thereafter, the encoded content will be received by a playback console and experienced by the audience member as audio content and/or audio+video content. It is at this point relating to the audience member's content experience that the meta data bridge (attached to or housed within the playback console) extracts the encoded meta data from the encoded content and transmits it along with other data provided by the meta data bridge as a relayed data packaged to any target device capable of receiving such relayed data package. Specifically, the meta data is extracted via a decoding process managed by the meta data decoder (the third element of the current invention set forth in FIG. 5), with such resulting decoder data package (comprised of the decoded meta data and other data provided by the meta data decoder) thereafter being handed-off to a short-range wireless transceiver (the fourth element of the current invention set forth in FIG. 5). The short-range wireless transceiver then process the decoder data package and, if appropriate, adds its own internally generated information producing a transceiver data package which is broadcast as a relayed data package to the target devices willing and able to receive such data pursuant to their having established a short-range wireless link to the short-range wireless transceiver (these target devices termed herein as permission granting target devices).

Where a permission granting target device accepts and receives such a relayed data package from the short-range wireless transceiver, the package is processed by a java application (the fifth element of the current invention set forth in FIG. 5) resident on the permission granting target device. The java application thereafter presents to the user of the permission granting target device (such target device user also being an audience member) an interactive textual message on the display of permission granting target device. The user may then respond to the displayed textual message (e.g. choosing from multiple user response choices), delete the displayed textual message, or ignore the displayed textual message. In the case of the former, the user response effects a modification to the meta data embodied within the relayed data package, with the modified meta data being forwarded as a textual message response (comprised of user response and associated data) to the back-end services database, with such forwarding being effected by the permission granting target device's data transport functionality (DTF) (e.g. SMS/short messaging) capability.

The back-end services database (the sixth element of the current invention set forth in FIG. 5) processes the textual message response so received, and where required, may take action upon the receipt of the textual message response in a manner previously specified by the content provider and/or content encoder affiliated with the creation of the encoded content and subsequent generation of a textual message response by an audience member. Such actions might include, but not be limited to, forwarding data relating to the interaction to various affiliated parties, responding directly to the user sending the textual message response, analyzing the received data in conjunction with the data previously input into the content brokerage engine, or any other action permissible by the operator of the current invention.

The Invention: Overview

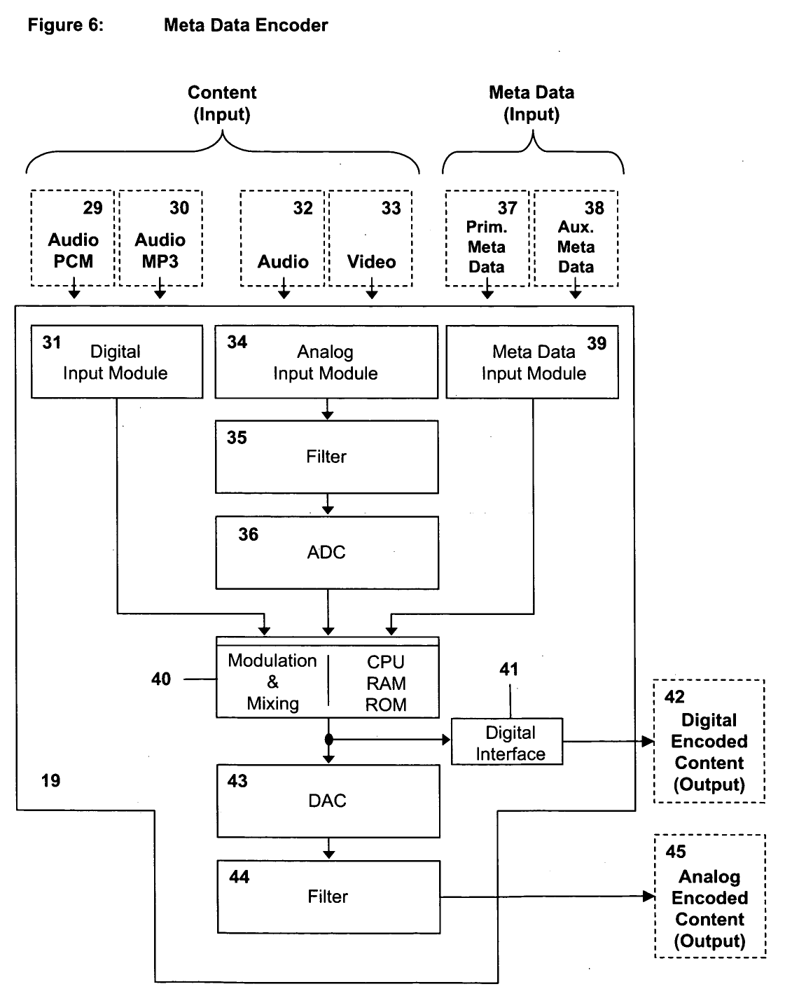

While FIG. 5 sets forth the invention starting with the content brokerage engine, for purposes of individually examining each of the six elements of the invention, it is more productive to start our discussion with the meta data encoder (see FIG. 6), and proceeding in tandem with the data flow to the meta data decoder, the short-range wireless transceiver, the java application, and then the back-end services database. Once these elements are more fully described, including specific features inherent within each that contribute to the utility and novelty of the overall system, a full description of the content brokerage engine is provided.

Meta Data Encoder

Turning to FIG. 6, one sees a schematic block diagram of the meta data encoder which is the element of the current invention that manages the encoding of meta data into either the content owner's submitted audio content and/or audio+video content prior to the resulting encoded content's dissemination to audience members via assorted distribution systems. Specifically, the meta data encoder is comprised of three input modules: a digital input module, an analog input module, and a meta data input module. The digital input module is a basic device for the integration of digital audio data (typically, in the form of audio PCM (Pulse Code modulation) or audio MP3 (Moving Picture experts Group Layer-3) data, and could also take alternative forms such as SPDIF (Sony Philips digital interface Formats)) into the meta data encoder. And while not specifically set forth in FIG. 6, the digital input module could reasonably be configured to integrate digital video data as well (e.g. MPEG-2 or MPEG-4 video), with such capability being apparent to those reasonably versed in the art (as a substitute for the audio encoding or combined with the audio encoding). In addition to the digital input module, the meta data encoder also possesses an analog input module that is a basic device for the integration of analog audio and/or video content (e.g. Composite video, S-video, or RGB video) streams into the meta data encoder. The third and final input module is a meta data input module that integrates both primary meta data and auxiliary meta data into the meta data encoder. As mentioned above, the primary meta data is meta data provided by a content encoder who seeks to embed their own interactive message into content for an audience member to respond to, whereas auxiliary meta data is meta data generated by the content brokerage engine to facilitate the delivery and processing of the content encoder's interactive meta data moving through the communication system associated with the current invention.

Once the meta data encoder has internalized the analog and/or digital content streams, as well as the primary meta data and auxiliary meta data, the process of encoding the latter into the former takes place. Given that the actual encoding process is a digital process (as opposed to an analog process), digital audio data received by the digital input module and meta data received by the meta data input module will not require significant alteration prior to the encoding of the latter into the former. As set forth in FIG. 6, both the digital input module and the meta data input module forward their respective data to a modulation And mixing stage, where the meta data is discretely encoded into the digital audio content provided. However, this is not the case for content delivered to the analog input module that is to be subsequently encoded with meta data at the modulation And mixing stage. Instead, the analog content must first be transformed into a digital format, with such transformation being effected by running the analog content through a filter and then through an analog to digital converter (ADC). Specifically, the filter engages in a filtering process (e.g. low pass) on the analog signal associated with the content to remove any frequencies above or below the permissive frequency of the encoded signal, preventing inappropriate high or low frequency data from being represented in the frequency domain to be associated with the relevant meta data to be encoded. Following this filtering process the content's filtered analog signal is delivered to the ADC for subsequent conversion into a digital format. Specifically, the ADC thereafter acts to convert the filtered analog signal to a series of low-bit values (e.g. 16-bit) for further delivery to the modulation And mixing stage as content in a digital form.

It is during the modulation And mixing stage that the digitized content (whether sourced from the digital input module or from the analog input module) and digital meta data (primary and auxiliary) are combined via a signal modulation process using standard combining techniques, including but not limited to psychoacoustic, direct multiplication, logical exclusive, spread spectrum, and/or analogous and combined techniques, so long as the data elements are combined in a ratio designed to maintain imperceptibility by an audience member and utilizing the central processing unit (CPU) and accompanying random access memory (RAM) and read only memory (ROM).

The resulting modulation of both digitized content and meta data produces a digital identification signal representative of the combined content and meta data. The digital identification signal is produced using standard transform techniques, including, but not limited to wavelet transform, short-time Fourier transform (STFT), fast Fourier transform (FFT), and/or analogous techniques. The digital identification signal is then received by a buffer which is capable of handling several thousand data items (e.g. amounts may vary depending on the encoding technique utilized) and manages the data through a random access memory/FIFO (first in, first out) scheme.

In the case of content that is to be distributed via digital means (DVD, digital terrestrial broadcast, etc.), the process of encoding meta data into content comes to an end once the digital identification signal is formatted for output and protocols for creation or conversion are effected by passing the digital identification signal through the digital interface. The digital interface thereafter produces the final digital encoded content that is delivered to the party responsible for distributing such digital encoded content (typically the content owner or their agent) by placing the same into the content management layer for dissemination pursuant to the mechanisms of the content management layer.

In the case of content that is to be distributed via analog means (analog terrestrial broadcast), the buffered digital identification signal (still embodying the substance of the combined content and the encoded meta data) is next forwarded from the buffering memory unit to a standard digital to analog converter (DAC) capable of transforming the digital identification signal into an analog signal, thereby becoming an analog identification signal. In the preferred embodiment, the DAC will be a 16-bit converter, capable of providing an adequate decibel range to the analog identification signal. Further, DAC sampling may be adjusted depending on the data length permitted by the buffer, as well as the length of the transform in the desired frequency range, likely to be in the very low or high frequency ranges (again, presuming that the encoding is the audio channel only, human hearing can typically perceive frequencies between 20 Hz to 20 KHz, and is extremely sensitive to sounds in the frequency range about 1 kHz to 4 kHz). The analog identification signal is then passed to a second filter (in the preferred embodiment a low-pass filter, but other embodiments could employ a high-pass or bandpass filter) to remove undesirable signals laying outside of the targeted frequency range, thereby producing a filtered analog identification signal, termed herein as analog encoded content.

As such, the meta data encoder is capable of taking analog content or digital content as submitted by a content owner and encode meta data into either submission formats, and produce analog encoded content and digital encoded content respectively.

In addition to the fundamental goal of embedding interactive meta data into the content, a further goal of the meta data encoder will be to ensure that the resulting encoding will be effected in such a manner that the audio content (and/or video content) are not perceptibly altered from the perspective of an audience listener and/or viewer. Further, resulting encoding will be completed in a manner so that a subsequent distributor, broadcaster, and/or other entity disseminating the encoded content will be unlikely to remove the encoded meta data without perceptibly altering the audio content and/or video content from the perspective of the audience listener and/or viewer. To ensure that the embedded data remains immune to intentional attempts at removal, the encoding technique will anticipate likely removal techniques (e.g., channel noise, filtering, compression, re-sampling, digital-to-analog conversion, and analog-to-digital conversion, etc.) and take steps to defensively encode so as to rebuff these removal attempts. Further, the encoding technique will take into consideration the anticipated content distribution systems (terrestrial broadcast, physical medium, etc.) prior to such encoding and will take steps to ensure that the encoded content is suitably formatted for distribution through that particular distribution system(s).

In sum, the meta data encoder seeks to achieve goals, including:

(i) the minimal degradation to the source audio and/or video signal so that the encoded meta data is not perceptible (or minimally perceptible) to the audience,

(ii) the embedded meta data is encoded directly into the audio and/or video portion of the content (as opposed to merely encoding into the header or wrapper,) to ensure that the encoded meta data remains intact across a variety of data file formats,

(iii) the embedded data should resist removal (scrubbing) attempts by anticipating removal techniques (including processes relating to removal of channel noise, filtering, lossy compression, re-sampling, digital-to-analog conversion, and analog-to-digital conversion, etc.), and take steps to defensively encode so as to rebuff these removal attempts,

(iv) make the embedded data easy to access by the meta data decoder, preferably through the use of asymmetrical coding techniques (the preferred method in the art),

(v) utilization of error correction coding to preserve data integrity during the meta data encoding process, and

(vi) employ self-clocking and/or arbitrary re-entrant functions to facilitate encoded meta data recovery where a portion of the encoded content signal is lost.

The current invention's meta data encoder will utilize a meta data encoding protocol that will be capable of being decoded only by an associated meta data decoder decoding meta data from the encoded content according to the same protocol. Further, the meta data decoder will not be equipped to recognize other, non-affiliated encoding protocols. This feature of linking the meta data encoder and the meta data decoder to only one or more shared protocols is an important technical feature in that it serves as an economic motivator for certain parties to distribute meta data decoders throughout the market.

For instance, it is the view of the inventors that meta data decoders will be distributed more quickly and in greater numbers if the distributors of the meta data decoders have a meaningful incentive to do so (such distributors being termed herein as system enablers). One such incentive might be to create a revenue share arrangement (e.g. share of advertising revenues) with these system enablers so that they may benefit economically from any interactive communications enabled by the meta data decoders distributed into the market. To maximize and preserve this incentive, the interactive communication system operator must take reasonable steps to ensure that all parties wishing to send interactive meta data through the system have paid the interactive communication system operator for the right to do so. Once such way to do this is to base the encoding and decoding of meta data on a proprietary algorithm which only interactive communication system operator can rightfully use. All others must seek permission (e.g. paying for such permission) to use the proprietary encoding algorithm. For those content encoders that choose to “pirate” the algorithm and encode their own version of meta data into content without notifying and paying the interactive communication system operator (such pirates being Free-Riders or system abusers), they will be de facto infringing upon the intellectual property rights of the interactive communication system operator since they will have used a proprietary encoding scheme to encode meta data prior to its dissemination through the various distribution systems available to the encoded content. It is one of the intentions of the current invention to create a system-wide technical framework where any meta data recognized by a meta data decoder can only do so by its having been originally encoded into content according to the proprietary algorithm of the interactive communication system operator.

Further details of anticipated encoding methods are not described herein, as those skilled in the art will understand how to apply such technology to the present invention upon reading the present disclosure, including techniques relating to low bit coding, redundancy and error correction coding, adaptive data attenuation, sound context analysis, echo data hiding, spread spectrum, and phase coding. The techniques employed will be determined on a case-by-case basis depending upon the characteristics of the anticipated content management layer for the encoded content, which will be driven by the transmission needs relating to the following distribution systems:

| | | Analog | | Digital | |
|---|---|---|---|---|---|
| | | Audio | Video | Audio | Video |
| Broadcast | Terrestrial | AM, FM | NTSC, PAL | DAB, DRM | DVB-T, DVB-H, |
| | | | | | DMB |
| | Satellite | FM | NTSC, PAL, | DSR, WorldSpace, | DVB-S, DVB-S2 |
| | | | D2-MAC | SDARS, XM | |
| | Satellite* | | | ADR, DVB-S | |
| | Cable | FM | NTSC, PAL | DAB | DVB-C |
| | Cable* | | | DVB-C | |
| | Internet | | | MP3, AAC, Real, | Quicktime, Real, |
| | | | | VC-1, Other | VC-1, Other |
| Media | Tape | CC | VHS, S-VHS | DAT, DCC | DV |
| | Record | Single, LP | | | |
| | Laserdisc | FM | NTSC, PAL | PCM, DTS, AC-3 | |
| | CD | | | PCM | video-CD |
| | | | | | (MPEG-1) |
| | MiniDisc | | | ATRAC | |
| | DVD | | | PCM, MP2, DTS, | DVD-video |
| | | | | AC-3 | (MPEG-2) |
| | HD-DVD | | | PCM, MP2, DTS, | MPEG-2, MPEG- |
| | | | | E-AC-3, MLP | 4, VC-1 |
| | Blu-ray | | | PCM, MP2, DTS, | MPEG-2, |
| | Disc | | | E-AC-3, MLP | AVCHD |
| | Memory | | | Numerous types | Numerous types |
| | Card | | | | |
| | Microdrive | | | Numerous types | Numerous types |

*digital audio in video formats.

Meta Data Decoder

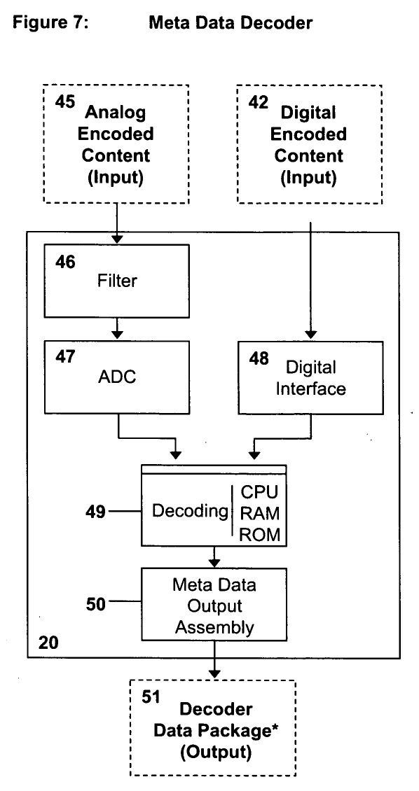

Turning to FIG. 7, one can see a schematic block diagram of the meta data decoder used for decoding meta data from either analog encoded content or digital encoded content. As is the case with the meta data encoder, the processing of meta data by the meta data decoder requires first that the encoded content be reduced to a digital form. As such, the initial processes of the meta data decoder are charged with transforming the encoded content into a digital identification signal.

Taking first the scenario where a playback console receives digital encoded content from a particular distribution system (digital broadcast, DVD), the meta data decoder recognizes and captures the target signal through either a data transfer interface with the playback console (e.g. perhaps a standard digital audio format in the form of SPDIF—Sony Philips digital interface Format, or for digital video perhaps DVI—digital video interactive, or perhaps HDMI—High Definition Multimedia interface, HDMI scheduled to be the standard for HDTV, or through an analogous data transfer interface offered by the playback console) or, where the meta data decoder is housed internally within the playback console, at any internal data transfer point where the target signal can be ascertained by the meta data decoder. Once the signal has been recognized and captured, the meta data decoder forwards the same to a digital interface which effects an input protocol and format conversion process upon the signal, thereby rendering a digital identification signal capable of being separated into its original content and meta data components once forwarded to the decoding stage.

In contrast, the scenario where a playback console captures analog encoded content (perhaps through a SCART or other data transfer interface connection, or as a connected component within the playback console itself) involves a distinct two-step process before the captured signal may be reduced to a digital identification signal. As is the case with the meta data encoding process, the digitizing of the captured analog signal is effected by running the analog encoded content signal through a filter and then through an analog to digital converter (ADC). To avoid aliasing, input to the ADC must be low-pass filtered to remove frequencies above half the sampling rate. Following this anti-aliasing filtering process the filtered analog encoded content signal is delivered to the ADC for subsequent conversion into a digital format. Specifically, the ADC acts to convert the filtered analog signal to a series of low-bit values (e.g. 16-bit), the result being the generation of a digital identification signal capable of being separated into its original content and meta data components once forwarded to the decoding stage.

It is during the decoding stage (utilizing the functional elements of a CPU, RAM, and ROM) that the meta data is extracted from the digital identification signal (whether sourced from the digital encoded content or from the analog encoded content). This meta data (primary and auxiliary) is then formatted into a decoder data package by a meta data output assembly component so that the meta data is in the format suitable for delivery by the short-range wireless transceiver for subsequent broadcast to a target device (e.g. Bluetooth enabled cellular telephone).

The current invention's meta data decoder will utilize a meta data decoding protocol that will be capable of decoding meta data only from encoded content that was itself encoding according to the same protocol. The meta data decoder will not be equipped to recognize other, non-affiliated encoding protocols. This feature of linking the meta data encoder and the meta data decoder to only one or more shared protocols is an important technical feature in that it serves as an economic motivator for certain parties to distribute meta data decoders throughout the market.

For instance, it is the view of the inventors that meta data decoders will be distributed more quickly and in greater numbers if the distributors of the meta data decoders have a meaningful incentive to do so (such distributors being termed herein as system enablers). One such incentive might be to create a revenue share arrangement (e.g. share of advertising revenues) with these system enablers so that they may benefit economically from any interactive communications enabled by the meta data decoders distributed into the market. To maximize and preserve this incentive, the interactive communication system operator must take reasonable steps to ensure that all parties wishing to send interactive meta data through the system have paid the interactive communication system operator for the right to do so. Once such way to do this is to base the encoding and decoding of meta data on a proprietary algorithm which only interactive communication system operator can rightfully use. All others must seek permission (e.g. paying for such permission) to use the proprietary encoding algorithm. For those content encoders that choose to “pirate” the algorithm and encode their own version of meta data into content without notifying and paying the interactive communication system operator (such pirates being Free-Riders or system abusers), they will be de facto infringing upon the intellectual property rights of the interactive communication system operator since they will have used a proprietary encoding scheme to encode meta data prior to its dissemination through the various distribution systems available to the encoded content. It is one of the intentions of the current invention to create a system-wide technical framework where any meta data recognized by a meta data decoder can only do so by its having been originally encoded into content according to the proprietary algorithm of the interactive communication system operator.

In addition, a further purpose of the meta data decoder will be to imprint within the decoder data package two additional information sets representing information distinct from and in addition to the information included within the primary meta data and the auxiliary meta data (see FIG. 9).

With regard to the first of these two data sets, the meta data decoder will insert a meta data decoder ID code (also generically referred to herein as a meta data bridge ID code) into the decoder data package as generated by the meta data output assembly which will specifically identify the meta data decoder responsible for the processing of the analog encoded content (or digital encoded content as the case may be) as received by the playback console playing the content. This meta data decoder ID code will ultimately be forwarded along with the primary meta data, auxiliary meta data, and such other data as required to the audience member's target device, and then through the target device's cellular network as part of an audience member's textual message response, with such data being ultimately received by the back-end services database (such database having the benefit of all of the information from the content brokerage engine). As a result, the meta data decoder ID code can instruct the back-end services database as to which meta data decoders literally “enabled” which interactive communications as between an audience member and their experienced content. This being the case, it will be possible for the interactive communication system operator and the content owner to share with a particular meta data encoder manufacturer (also a system enabler) a portion of the revenue received by the interactive communication system operator and/or the content owner from a content encoder who has paid for the right to encode their meta data into a specific content segment prior to its dissemination to the markets through various distribution systems.

By way of example, if an original equipment manufacturer of television sets (TV OEM/system enabler) were to build the meta data decoder as described herein into their next generation television sets (or deploy within the market Externally hosted adaptors for existing television sets), the current invention provides the means of identifying what interactive content was viewed on that television set and subsequently prompted the audience member viewing content on that television set to send into the back-end services database a textual message response based upon watching that content on that television set. Such an ability would allow the TV OEM/system enabler to negotiate any number of performance-based remuneration terms with the interactive communication system operator and/or the content owners (e.g. the TV OEM/system enabler receiving 5% of all interactive advertising revenues generated from the content encoders engaging in this interactive bridging and payable to the interactive communication system operator and/or the content owner) in exchange for the TV OEM/system enabler integrating the meta data decoders into a set number of television sets, into a particular market, during a particular time period, etc. Given that TV OEMs/system enablers (and similarly situated system enabling manufacturers of playback consoles) continue to operate in a highly competitive and aggressive pricing environment, the potential for creating a long-term, recurring revenue stream will be highly appealing to such a manufacturer and will encourage them to deploy the necessary components enabling the adoption and wide-spread use of the system of the current invention.

With regard to the second of these two data sets, the meta data decoder will insert a corroboration reply address and associated corroboration reply data instruction set into the decoder data package as generated by the meta data output assembly which will instruct the target device receiving such data package (or in the alternative, instruct the java application resident on the target device) to send a corroborating SMS (or analogous IM, etc.) message containing one or more partial elements relating to a particular textual message response at the time a textual message response is sent by an audience member who is interacting with a particular content segment traveling through the system of the current invention. The purpose of inserting this corroborating message and address is to allow the interactive communication system operator the ability to identify potential system abusers (or Free-Riders) of the interactive communication system and attempt to convert them into paying customers of the system (e.g. fee paying content encoders). It is in this regard that tying the meta data decoders to a proprietary shared encoding protocol with that of the meta data encoders becomes key. Clearly, the interactive communication system operator will have no rights vis-à-vis the use of the meta data encoders once they have been distributed into the markets. But the interactive communication system operator will have the right to control which parties use the encoding algorithms, and as such, can ascertain whether a system abuser has infringed upon the interactive communication system operator's rights via the encoding algorithm by virtue of tracking which messages are actually decoded by the meta data decoder. If a corroboration message is received by the interactive communication system operator that cannot be traced back to a paid for activity logged on the content brokerage engine, the interactive communication system operator will have credible proof that a system abuser has unlawfully infringed on the rights of the interactive communication system operator by using the proprietary encoding protocol without the consent of the interactive communication system operator.

If it is determined that having the target device of the audience member sending out a corroborating message every time they send a textual message response is excessive (i.e. it effectively doubles the target device's message output), the current invention contemplates a system where the corroborating message function is only engaged periodically (perhaps one corroboration message for every hundred textual message responses), so long as the corroboration mechanism is statistically likely to identify system abusers across a large number of participating audience members. It is appreciated that the interactive communication system operator need not know every instance where a system abuser prompted a response from each audience member, but need only know of isolated instances when such abusive activity took place.

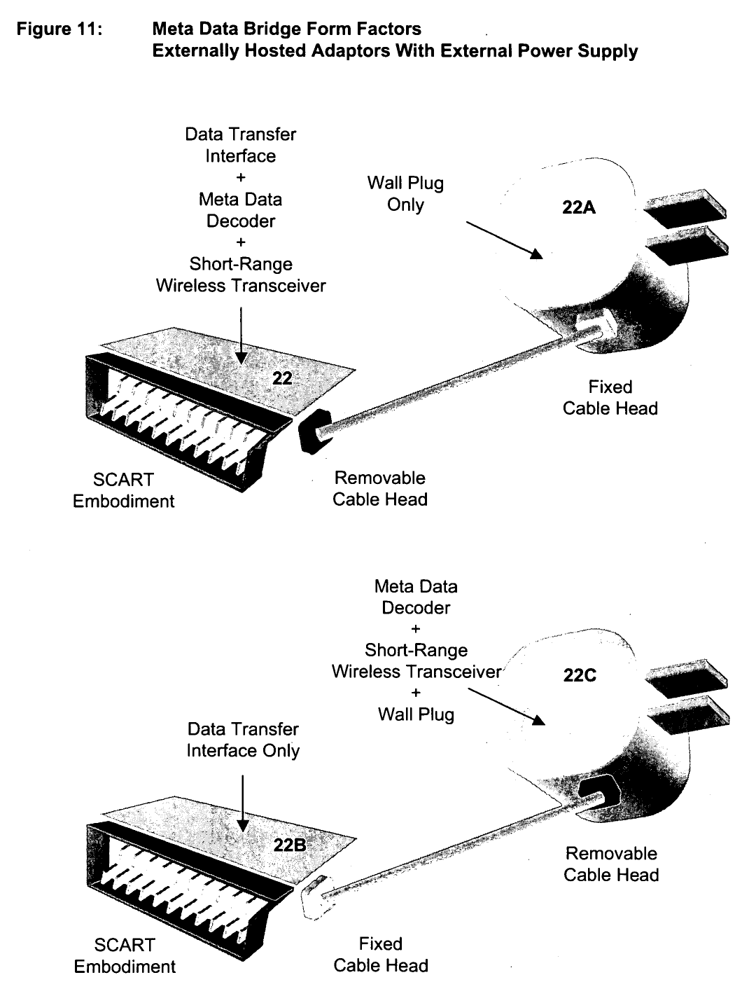

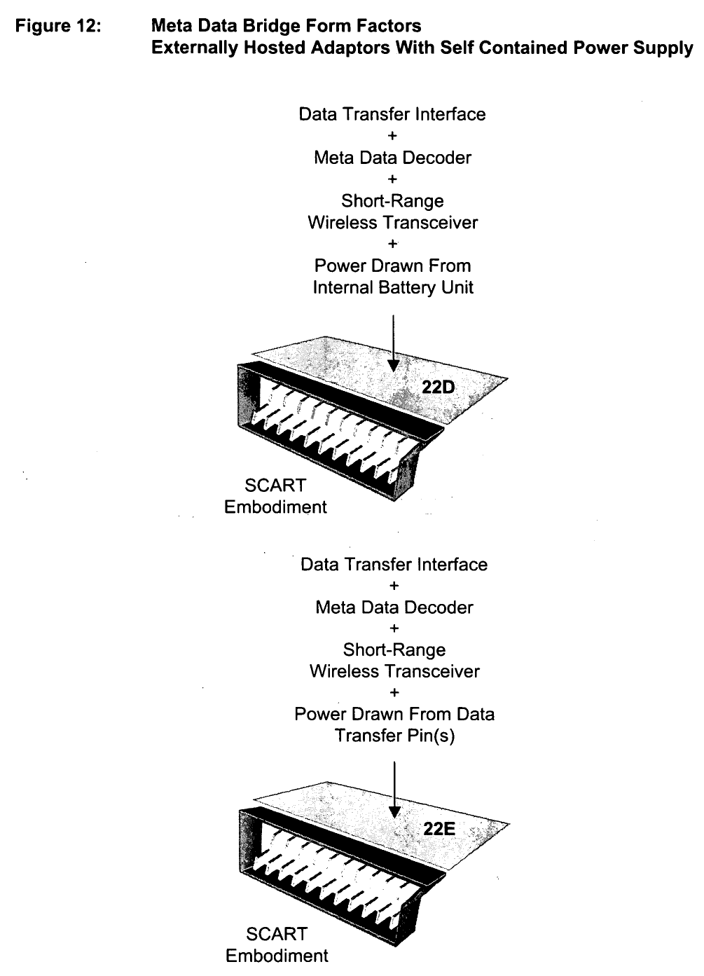

It is also worth stressing that an externally hosted adaptor (i.e. meta data decoder and the short-range wireless transceiver) may be deployed into the market in a variety of physical form factors (See FIG. 11 & FIG. 12), thereby increasing the likelihood of user adoption. One need only to look at the back panel of any given television or radio playback console to see the assortment of data transfer interface connection choices available. While the language of the current invention typically refers to SCART (Syndicat des Constructeurs d'Appareils radiorécepteurs et Téléviseurs), it will be understood by one familiar with the art that numerous embodiments are possible depending upon the encoding method chosen (e.g. into analog audio, analog video, digital audio, digital video) as well as the connector configuration resident upon the particular playback console. For instance, the externally hosted adaptor could draw data from connectors that are audio line signals or low-resistance headphone or loudspeaker signals. These analog audio signals are typically provided on RCA connectors (CINCH) or jack plugs (2.5 or 3.5 or 6.3 mm) and can be mono or stereo signals (the jack plugs for stereo signals are often referred to as TRS/Tip Ring Sleeve connectors). Similarly, they could draw from SCART connectors that provide analog audio and analog video signals. While not an exhaustive list, typical examples might include:
(a) any one of SCART, jack plug, RCA, or XLR for analog audio signals;
(b) any one of RCA, SCART, or BNC for analog video signals,
(c) any one of RCA, TOSLINK, HDMI, XLR, or BNC for digital audio signals; or
(d) any one of DVI or HDMI for digital video signals.

It will also be appreciated that various power sources will be available for these embodiment (wall power socket, playback console power socket, or in some cases, power from a connection ring/data transfer pins itself (e.g. USB and Apple 6-Pin FireWire). However, with regard to power sourcing, given the varying primary voltage standards in varying countries, it is reasonable to presume that an AC transformer power adaptor (plug) would be used in conjunction with a power chip on the externally hosted adaptor's printed circuit board (PCB) for DC supply. Such an embodiment could provide the greatest flexibility and the lowest cost rollout for a distributor of such an externally hosted adaptor. In another situation, some set-top box systems (predominantly for digital television) have one or more CICAM (Common interface Conditional Access module) slots therein. In the situation where the playback console had an available CICAM slot, the externally hosted adaptor could take the form of a PC card or PCMCIA interface and thereby effect the meta data decoding, processing, and the short-range wireless relay thereof to a target device without necessarily relying on a power source external (e.g. wall socket) to the playback console.

A further embodiment relating to the externally hosted adaptor would also include a removable memory slot (Memory Stick, SD Memory, etc.) where various software components relating to the meta data decoder, short-range wireless transceiver, and/or the java application for the target device could be stored prior to, during, or following installation of the externally hosted adaptor onto the playback console. The memory card slot function could also be used to update any one or more of the software components relating to the meta data decoder, short-range wireless transceiver, and/or the java application. Similarly, the inclusion of such a removable memory slot could be equally viable in the case where the meta data bridge were internally hosted within the playback console, save that there would have to be a means to access the memory slot by the user thereof (e.g. the slot aspect embedded into the front of the television console). The purpose of such a memory slot in the case of an internally hosted meta data bridge would be primarily the same as for the externally hosted adaptor, and in particular for the purposes of updating the software components relating to any one or more of the meta data decoder, short-range wireless transceiver, and/or the java application for the target device.

Short-Range Wireless Transceiver

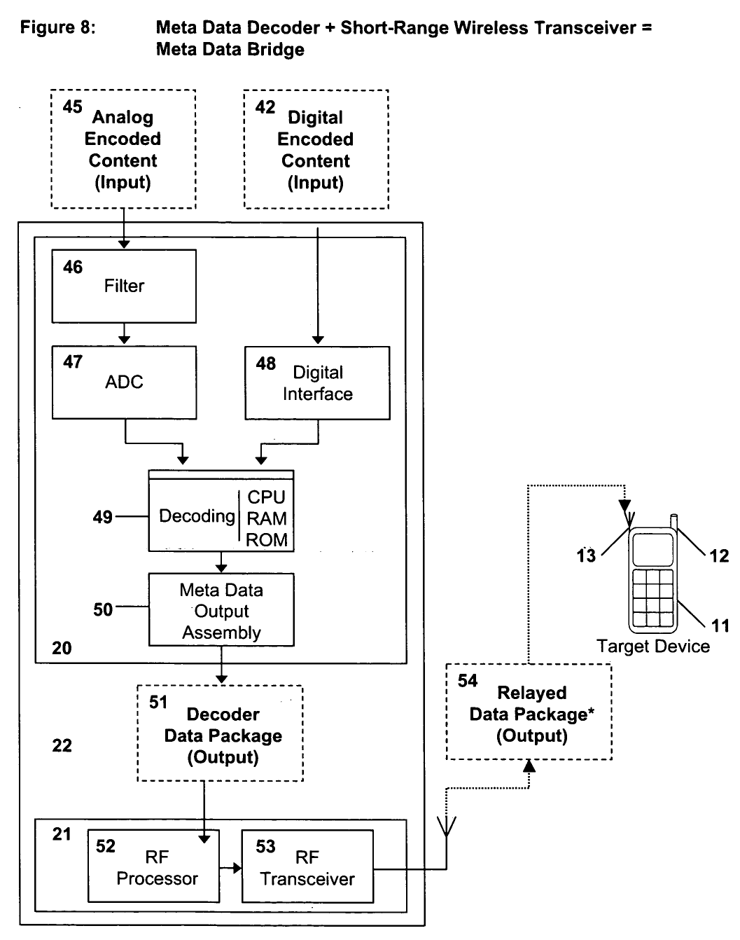

Turning to FIG. 8, one can see a schematic block diagram of the meta data decoder and its corresponding short-range wireless transceiver (collectively referred to herein as the meta data bridge). The purpose of the short-range wireless transceiver is to take the decoder data package as processed by the meta data output assembly and pass it along as relayed meta data to any target device in the possession of an audience member experiencing the encoded content.

While the likely form of such a short-range wireless transceiver will be Bluetooth, the current invention should not be limited to this single wireless transport protocol, as new developments and trends are making their way through the markets, and other wireless standards such as Wibree, ZigBee (IEEE 802.15.4), or analogous standards could effectively complete the wireless bridge. In any case, this element of the current invention will be comprised of a radio Frequency processor (RF processor) which receives the decoder data package from the meta data output assembly and acts to modulate the data to make it acceptable for transfer to the radio Frequency transceiver (RF transceiver) which takes the resulting relayed data package (the decoder data package as formatted by the short-range wireless transceiver) and broadcasts the same to a target device in the vicinity of the meta data bridge.

Specifically, the short-range wireless transceiver can be a typical radio frequency device (e.g. Bluetooth) following a standard “two-way” communication protocol that is applicable to all communications between itself and another similarly enabled device (e.g. target device/enabled cellular telephone). It is also contemplated by the current invention that the transceiver might engage in communications that are either predominantly or entirely “one-way” (send only), and furthermore, could take the form of a radio frequency “transmitter” if the situation relating to the short-range wireless communication associated with the bridging aspect of the current invention required such.

For purposes herein, however, it is envisioned that the short-range wireless transceiver would carry a fully functioning hardware and software complement for affecting two tasks: (i) the bidirectional connection initiation communications (e.g. a Bluetooth handshake) and (ii) the subsequent unidirectional content information flows (e.g. sending of decoded meta data, meta data bridge ID code, corroboration reply address, and corroboration reply data).

For the avoidance of doubt, the current invention does not seek to have any information returning back to the short-range wireless transceiver from the connected short-range wireless enabled cellular telephones, save for any communication initiation data that must be exchanged at the onset of establishing such connections (e.g. Bluetooth handshake). As a result, one of the strengths of the current invention is that the short-range wireless transceiver can operate more efficiently than corresponding radio frequency devices, as it may be reasonably subject to more modest hardware, software, and power requirements.

Similarly, by streamlining the hardware and software profile for the short-range wireless transceiver, more hardware and software resource can be applied to the “handshake” and subsequent content information flow, thereby increasing connection speed and efficacy. Specifically, the short-range wireless transceiver will be configured to maximize the nature of this predominantly “one-way” data flow and utilize only those acceleration and compression technologies that are requisite.

The short-range wireless transceiver may be externally or internally hosted by the playback console or similar host device. Further, the short-range wireless transceiver may be coupled with the meta data decoder to affect a meta data bridge form factor. Finally, while the likely embodiment of the current invention contemplates the transmission of extracted meta data and associated data over the 2.4 GHz frequency, the invention also contemplates deploying the stream-lined communication format consistent with bidirectional communications for handshake followed by unidirectional communications for relayed data package transport via other radio frequency standards where appropriate (e.g. Wi-Fi, Wi-Max, ZigBee, and/or otherwise).

In addition, in other embodiments, a further purpose of the short-range wireless transceiver could be to imprint within the relayed data package two additional information sets discussed above: (i) the short-range wireless transceiver ID code (generically referred to herein as a meta data bridge ID code) and (ii) the corroboration reply address and associated corroboration reply data instruction set (see FIG. 9). In this situation, the two data sets would not be inserted into the decoder data package by the meta data decoder, but instead would be inserted by the short-range wireless transceiver. Or in other embodiments, the meta data decoder could insert one of the two data sets and the short-range wireless transceiver could insert the remaining data set. The purpose motivating the insertion of these two additional information sets would be the same as those set forth in the preceding section, namely providing the means to identify system enablers and system abusers and the degree to which either improve upon or degrade the utility of the interactive communication system.

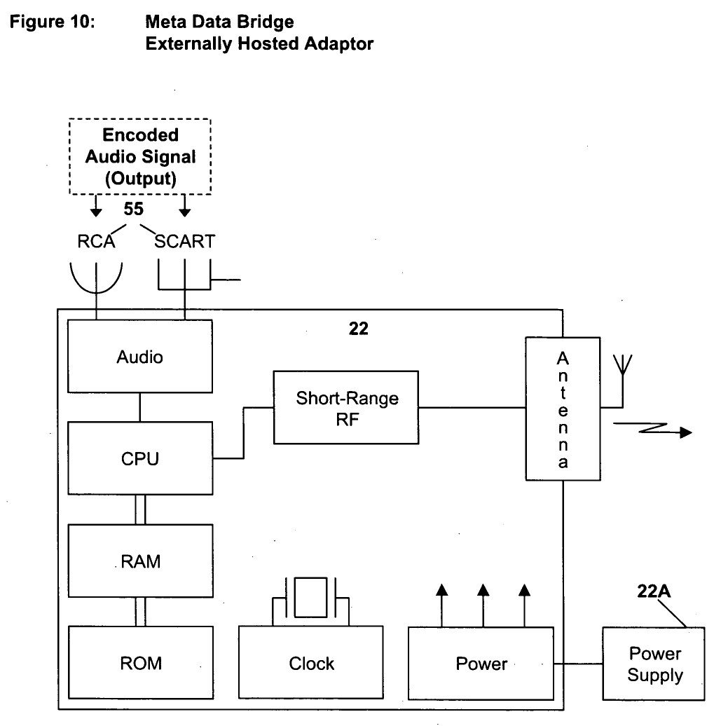

At this point, it is worth turning to FIG. 10 to see a simplified block diagram of a meta data bridge (meta data decoder+short-range wireless transceiver) in the form of an externally hosted adaptor. Note that the adaptor is connected to a playback console via a data transfer interface (typically an AV SCART or RCA connection) and is externally powered. Typical elements to be found in the basic meta data bridge would include a audio input, analog to digital converter chip (ADC), central processing unit+digital IO chip (CPU), read only memory for program functions (ROM), random access memory for data functions (RAM), baseband and radio chip (e.g. BBR or Bluetooth Baseband and radio), power conversion and control chip (PCC), a quartz clock generator (QCG), antenna (e.g. Bluetooth antenna), a power socket and power plug ensemble, as well as the requisite complement of printed circuit board components, including but not limited to rectifiers, diodes, capacitors, and resistors. Further as will be appreciated by those versed in the art, the CPU, RAM, and ROM chips might be combined into one or two chips, and other elements could be reasonably integrated into more compact components given adequate engineering resource. It is also contemplated that certain chips (e.g. CPU) can do more than one function (supporting both decoding and radio frequency functions).

This basic design is represented inn FIG. 11 that portrays two embodiments of a SCART adaptor. In the first embodiment the meta data bridge (meta data decoder+short-range wireless transceiver) and data transfer interface are housed within the same physical unit, and removable power cable and wall plug configured as separate units. The desire for a removable power cable is seen in the need to have “mix and match” components for the adaptors, as not all user's will wish to attach the adaptor to their SCART, but instead to an RCA connector or otherwise. In that situation, the removable power cable could be used for that embodiment as well.

Looking at the second SCART embodiment in FIG. 11, one sees the potential of hosting the meta data bridge (meta data decoder+short-range wireless transceiver) and the wall plug (power source) within the same physical unit. In this situation, the connection to the playback console's SCART would be effected through a stand-along data transfer interface. Moreover, the data transfer interface would be attached to the meta data bridge through a data cable that would be removable vis-à-vis the meta data bridge. As was the rational above, making this element removable allows for different data transfer interface connectors (e.g. RCA or otherwise) to be attached to the meta data bridge.

In FIG. 12, we see two further meta data bridge forms, each as an externally hosted adaptor in the SCART embodiment. In these situations, however, there are no wall plug power source elements. Instead, the power source is internal to the adaptor (batteries) or draws its requisite power directly from the playback console through the data transfer pins associated with the data transfer interface or analogous power source provided by the playback console.

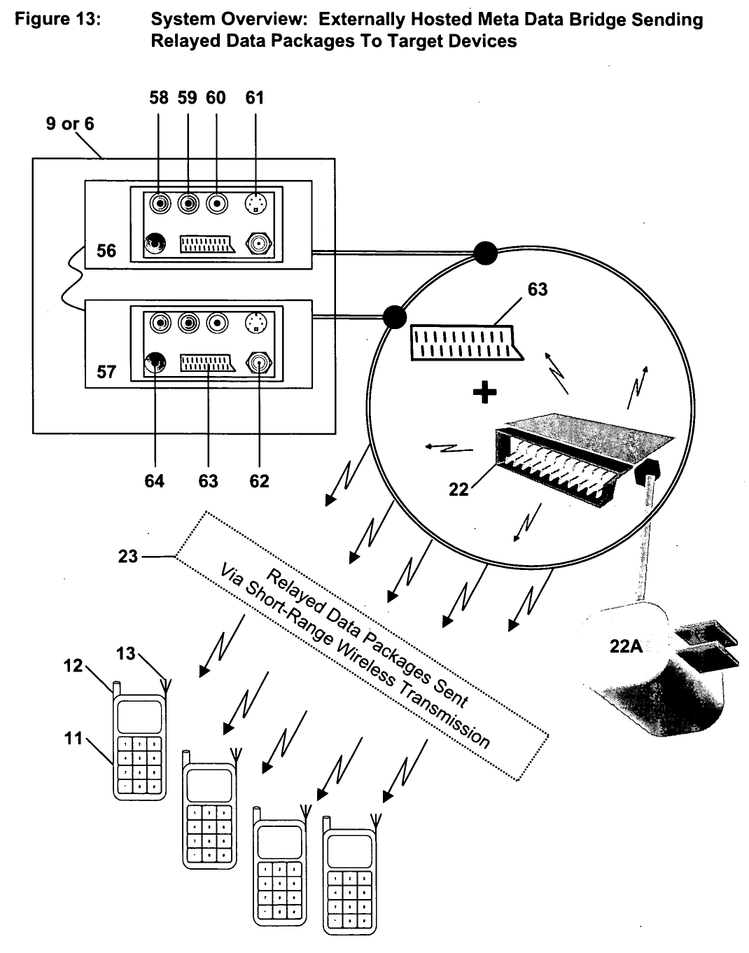

In FIG. 13 we see how such a meta data bridge adaptor might connect to a playback console—in this case through the back of a television set or its associated television receiver. Further, it should be clear that there will be alternatives to hosting the adaptor on the SCART connection inherent on the playback console, as most television and radio sets also have RCA, S-video, F-video, headphone audio, and analogous connection formats incorporated therein. Further, newer television and radio sets may also have data transfer interfaces comprised on USB ports, Fire Wire (i-Link) ports, Memory Stick ports, or analogous, and each offering the opportunity of having the externally hosted adaptor capture encoded data from a content signal and/or draw requisite power to drive the functions of the meta data bridge elements.

Finally, in FIG. 13 one can see how the meta data bridge interacts with the target devices by sending relayed data packages to any number of permission granting target devices within reach of the meta data bridge.

Java Application Resident Within Target Device

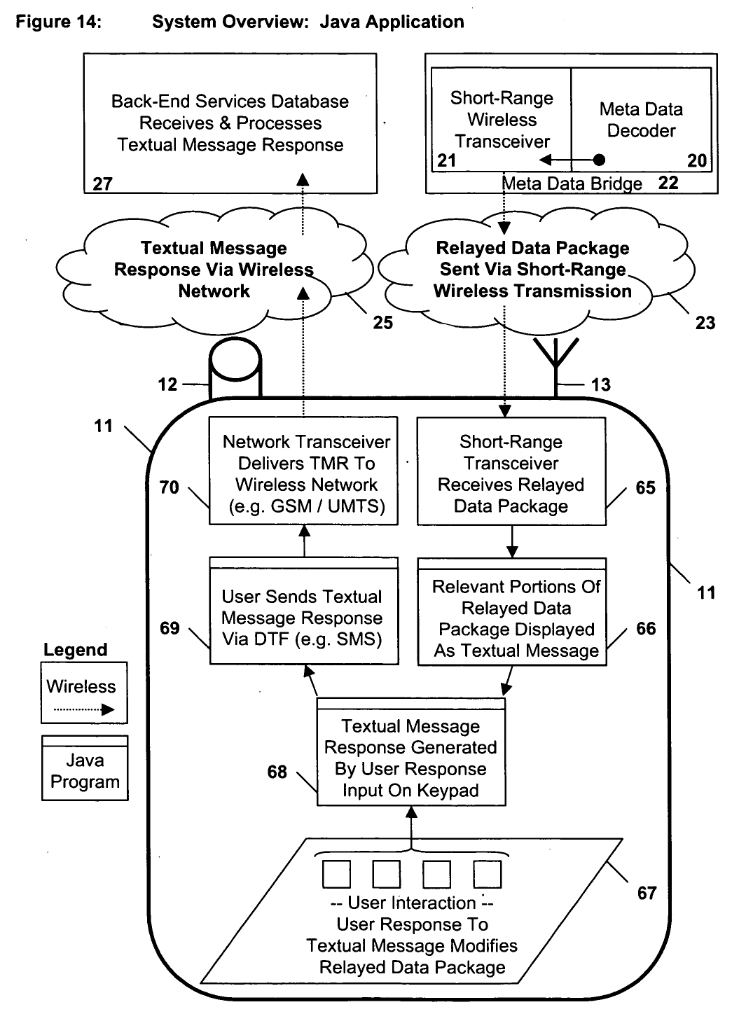

Turning to FIG. 14, one can see the basic data flow properties associated with the delivery of the relayed data package to a permission granting target device. For purposes of this diagram, it is presumed that the java application has already been installed on the target device and is now capable of processing relayed data packages sent by the meta data bridge. Further, it is contemplated by the current invention that the java application initiates the process by which the short-range wireless transceiver first establishes a connection with the target device and only does so when instructed to open (start) by the target device user. Similarly, it is contemplated by the current invention that the communication to the short-range wireless transceiver by the target device will cease upon the user instructs the java application to exit (turn off).

In the first instance, the relayed data packages are sent to the target device via the wireless transmission initiated by the short-range wireless transceiver. A corresponding transceiver within the target device (e.g. the short-range wireless transceiver and the target device transceiver are both Bluetooth) receives the relayed data package and delivers the same to the java application resident upon the target device. The java application processes all of the valid data so received (correct syntax only), and thereafter only displays the textual message data (the prompting textual message and user response choices) for the review by the user (e.g. other data, such as the response reply address, meta data bridge ID code, encoded segment tracking ID code, corroboration reply address, corroboration reply data, user age limits, location limits, time expiry limits are not displayed on the target device for review by the user). In simplest terms, the textual message as displayed will contain a main, prompting textual message and one or more user response choices for the user to select from in the course of responding to the main textual message. Further, it will be clear to one verse in the art that some of the data processed by the java application for forwarding to the back-end services database (see below) is not the result of meta data Decoding, as it is not sourced from encoded primary or auxiliary meta data. Instead, some data is resident within one or more of the meta data decoder, short-range wireless transceiver, and java application, in a sense “cached” for use in each interactive communication (e.g. meta data bridge ID code, corroboration reply address) are not displayed on the target device for review by the user.

Taking an interactive message relayed in connection with the viewing of a soap opera, a typical textual message displayed on a target device would therefore resemble the following: Should Dr. Smith have an affair with Nurse Kelly?
1. Yes
2. No
3. Surprise Me

data relating to a particular response reply address, meta data bridge ID code, corroboration reply address, encoded content tracking ID code, etc. would not be displayed.

Depending on the action of the user—either deleting the textual message, ignoring the textual message, or selecting from one of the user response choices provided—the data associated with the relayed data package will be either deleted by the java application (as in the case of the user deletion such or ignoring such) or modified by the java application (as in the case of the user choosing one of the user response choices). In the case shown in FIG. 14, the data is modified by the java application pursuant to the user response, the java application thereafter generating a shortened data set called a textual message response (TMR) which is then forwarded over the target device's wireless network (utilizing the target device's data transport functionality (DTF)) to a response reply address (e.g. SMS address linked to the back-end services database) specified by the interactive communication system operator at the time the original auxiliary meta data was encoded into the content. The textual message response will be comprised of the user response and the relevant encoded segment tracking ID code, and will forward this data along with the meta data bridge ID code and any other data that can be gleaned from the target device at the time (target device Phone number, response time, target device type, target device location, etc.). Further, when specified, the corroboration reply data will be forwarded to the corroboration reply address.

Finally, in other embodiments, a further purpose of the java application could be to imprint within the textual message response two additional information similar to the sets discussed above: (i) the java application ID code and (ii) the corroboration reply address and associated corroboration reply data instruction set. In this situation the two data sets would be inserted into the textual message response by the java application—but only where such insertion of data would not compromise similar actions taken by the meta data bridge. The purpose motivating the insertion of these two additional information sets would be the same as those set forth in the preceding sections, namely providing the means to identify system enablers and system abusers and the degree to which either improve upon or degrade the utility of the interactive communication system.

Back-End Services Database

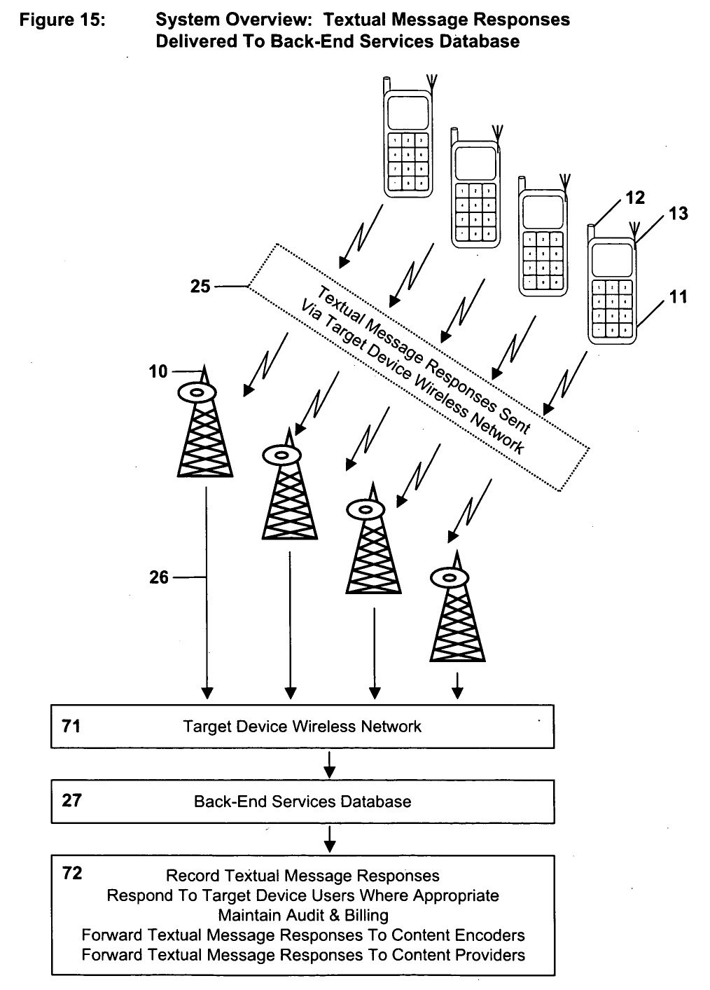

Turning to FIG. 15 one can see a data flow diagram of the target devices engaging in the transport of various textual message responses in furtherance of the interactive communication system's goal of making content interactive for the user. As set forth earlier, the target devices are anticipated to have at least two distinct radio frequency “send and receive” capabilities. The first being a short-range wireless transceiver package (antenna, RF processor, and data processing components) capable of communicating with the short-range wireless transceiver (probably based upon the Bluetooth standard). The second being a target device wireless network package (antenna, RF processor, and data processing components) capable of communicating with the target device's wireless network operator (e.g. likely a GSM or UMTS cellular provider of basic voice and mobile data services, and also referred to herein as a “device network operator”). The textual message response sent by the user will be forwarded over the target device wireless network using the appropriate data transport functionality (DTF) associated with that target device's wireless network (e.g. SMS or IM), such message first being received by the target device's wireless network operator Towers, and then subsequently being handed-off to the target device wireless network, which by association would utilize other attached networks (predominantly wired) to complete the delivery of the textual message response to its intended response reply address associated with the back-end services database. Once received by the back-end services database, the textual message response would be processed into its various data components and the resulting information fed into the appropriate databases and servers (both stand-alone and those linked to the databases and related components of the content brokerage engine).

The back-end services database would thereafter be charged with the efficient, secure, and accurate auditing, analyzing, and storing of data so received, and also for effecting the billing of and revenue collection from various parties (e.g. clients) responsible for creating the interactive content pursuant to the terms agreed during the content brokerage engine dialogue or otherwise. In addition, the back-end services database would be capable of generating and sending a further response to the sender of the textual message response where appropriate, forwarding data relating to any textual message response to an appropriate content owner and/or content encoder, sharing the data relating to any textual message response with the database systems associated with the content brokerage engine, and distributing to third parties data relating to any textual message response in a manner deemed permissible by the interactive communication system operator. All of these functions, and related aspects of the back-end services database would be designed and implemented so as to satisfy the expectations of the user of the target device, as well as the expectations of any content owners and content encoders who have effected the embedding of meta data within such content, as well as any appropriate third-parties.

It is also worth noting that the back-end services database will not seek to engage in traditional “fulfillment” activities. It will be one of the purposes of the back-end services database to facilitate the delivery of fulfillment services by others (e.g. content encoders), but not to engage directly in the fulfillment activities itself. By way of example, if a textual message response indicates that a user wishes to download a ring tone for her target device, the back-end services database will not seek to deliver such a ring tone and manage the billing of such user related to this transaction. Instead, the back-end services database will seek to merely forward the relevant information associated with the textual message response to the content encoder who will have systems and capabilities in place to provide fulfillment of the ring tone delivery and billing therein. To do otherwise introduces an element of complexity to the interactive communication system that is too difficult to manage and would be a distraction from one of core purposes of providing interactivity to audience members experiencing certain types of content. However, this limitation does not negate the ability of the back-end services database to engage in appropriate follow-on communications with the user (either as responses to textual message responses received from the user or as newly initiated communications to the user by the back-end services database motivated by data collected previously).

Further, it is a claim of the current invention that in certain circumstances the user response is capable of simultaneously initiating and completing a particular task between the user of the permission granting target device and a content owner, a content encoder, a related third-party, or combination thereof (doing so pursuant to the functionality of the java application and in conjunction with the back-end services database), and specifically effecting the initiation and completion of such task with only a single keypad entry (“one-click” interaction) on the target device. Notwithstanding that such a One-Click interaction capability exists, this should not be deemed to be traditional fulfillment since the interactive system operator will not seek to effect fulfillment, but only facilitate such fulfillment by another party by passing the appropriate information relating to that textual message response to such other party or providing a suitable response to the user that does not in and of itself amount to traditional fulfillment. Furthermore, the fact that any resulting fulfillment might require numerous operations and communications between any of one or more of the content owner, the content encoder, or related third-parties, from the perspective of the user providing the user response the activity was initiated and completed using only one keypad entry onto the target device and is therefore a One-Click interaction.

Content Brokerage Engine

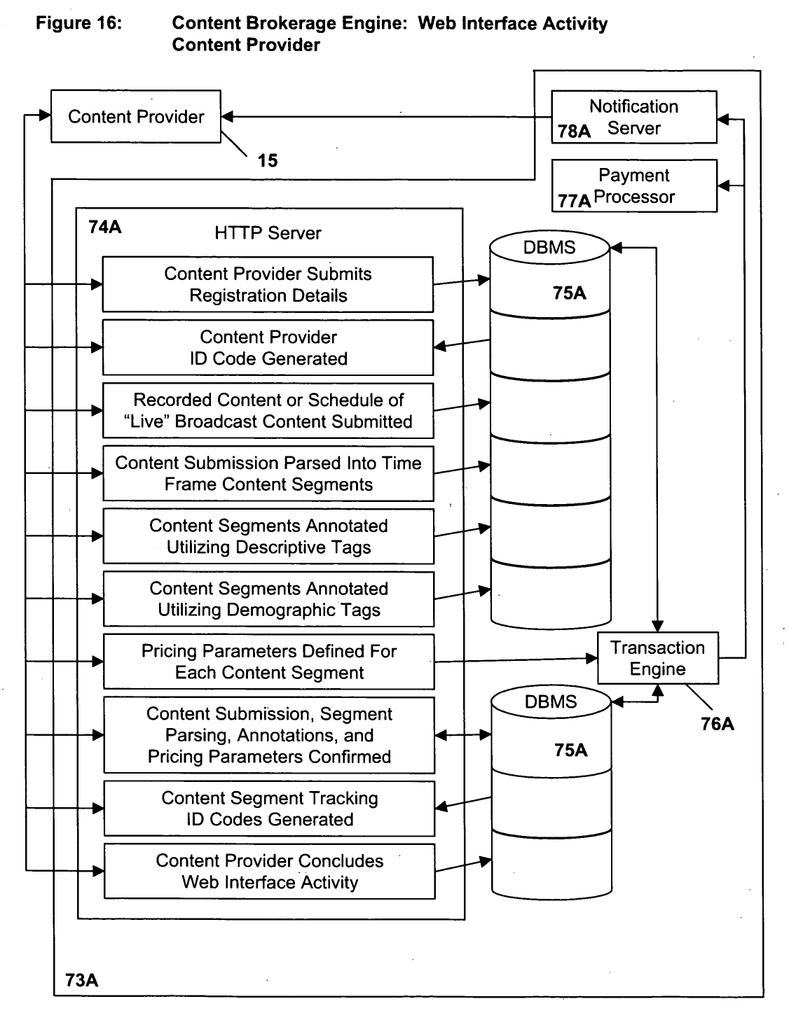

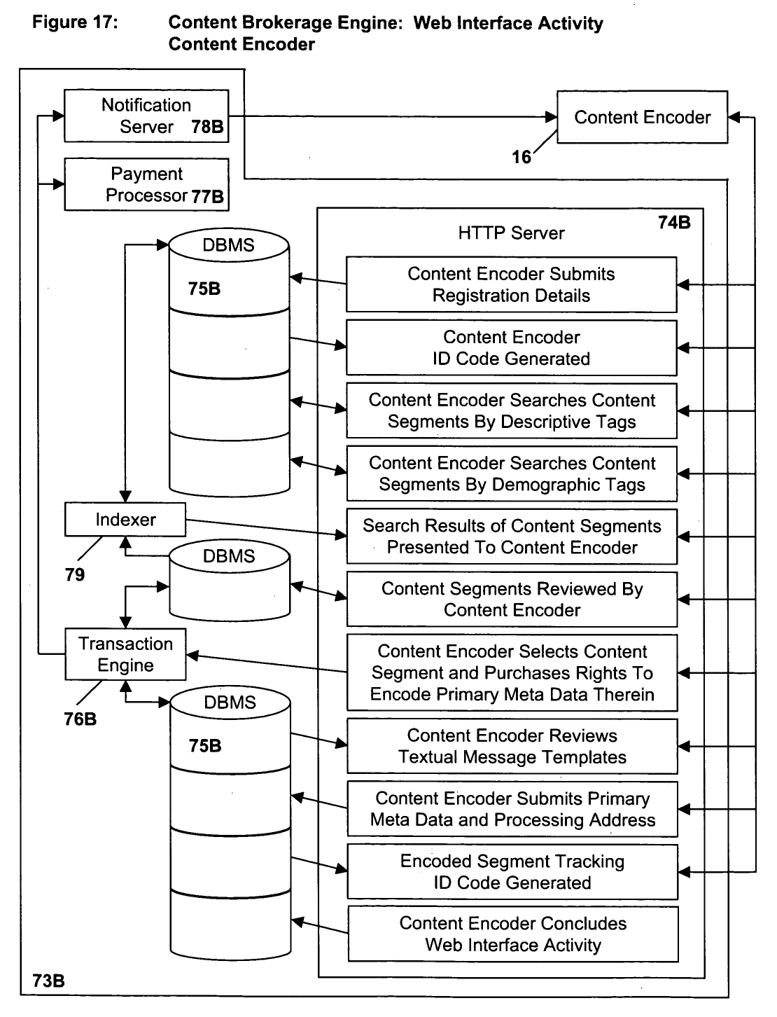

Turning to FIG. 16 and FIG. 17 (to be viewed side-by-side as a single diagram), one can see the basic data flow properties associated with the content brokerage engine. As mentioned earlier, when compared to the other five elements of the current invention, the content brokerage engine is perhaps the most critical element in terms of real world utility in that its absence precludes any large-scale (local, regional, and national), simple, low-cost, and accurate matching of content to contextually relevant meta data. Without a viable technique to automate the matching process, there is simply too much content dispersed across too many fragmented media markets to reasonably expect content owners and parties wising to encode meta data into that content to seek each other out and negotiate mutually agreeable terms for the encoding of meta data into a particular segment of content to be distributed in a particular market. As such, the current invention sets forth a unique content brokerage engine which functions as an intuitive web interface allowing content owners (content providers) to submit and annotate their content for subsequent search, review, purchase, and encoding by a content encoder seeking to encode their meta data into such content prior to its distribution to audience members via a permissible distribution system (terrestrial broadcast, cable broadcast, physical medium, etc.). Conversely, it is also worth noting that absent a viable mechanism for the pairing of content to meta data, there will never be enough encoded content available at any one time to justify the cost and effort associated with deploying bridging devices (externally hosted or internally housed meta data bridges, each comprised of a meta data decoder and short-range wireless transceiver) throughout the market by enablers of such devices (e.g. playback console manufacturers, broadcasting companies, advertiser, etc.). Finally, the content brokerage engine provides the technical platform for effective content to audience member interaction in that the content brokerage engine serves the core interactive data (including the textual message data, response reply address data, encoded content tracking ID code data, time expiry limit data, location limit data, and user age limit data) to the both content encoder as well as the back-end services database for end-to-end interactive experience creation and monitoring.

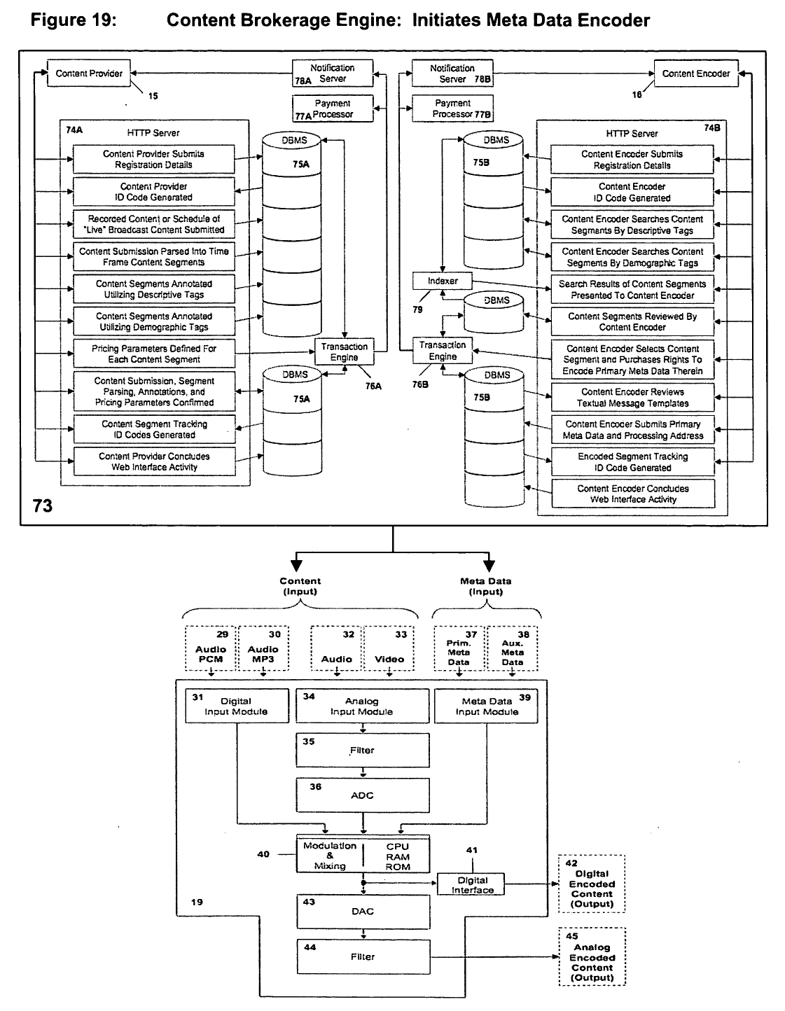

Taking a closer look, one can see from FIG. 16 and FIG. 17 that the content brokerage engine is a web-based platform that enables two parties (a content provider and a content encoder) to engage in a particular form of commerce. As a general matter, the content provider (see FIG. 16) can log onto the web-based content brokerage engine and proceed to load his content to the platform for other parties to review and, if terms can be agreed, to allow those other parties to encode their particular meta data into that uploaded content. Thereafter, a content encoder (see FIG. 17) may log onto the content brokerage engine, search for, review, and select that content he wishes to encode meta data into and agree terms with the content provider to purchase these encoding rights. Once there is an agreement as to which content and meta data are to be paired (matched) and the commercial terms surrounding such encoding (where it will be distributed, how, to whom, at what price, audience member performance incentives, etc.), the content brokerage engine processes the transaction and forwards the appropriate content and meta data to a content encoder for discrete encoding of the latter into the former (see FIG. 19). The encoded content is then sent back to the content owner (and/or the content encoder) who effects a dissemination of the encoded content through any one or more distribution channels available to such content (terrestrial television broadcast, physical medium, etc.).

Taking a look at the specific processes involved in matching such content to meta data, it is worth running through the diagram in FIG. 16 (the “sell side”). To begin the process, the content provider logs into the web-based platform (note, all such content provider communications with the content brokerage engine being interfaced by a HTTP server) by providing basic Registration data (content owner/company name, contact details, billing details, etc.). Once a content provider registers, the database management system of the content brokerage engine generates a user Name and Password set (or analogous identification system) for the that particular content provider to use then and for future sessions. The content brokerage engine also generates a content provider ID code (or analogous) that is associated with the user Name and Password and which is used to monitor all activity relating to this content provider on the system. In the preferred embodiment, it is envisioned that there will be distinct registration sections attributed to content providers seeking to submit Recorded content, and registration sections attributed to content providers seeking to submit live broadcast content, although other permutations can be expected as those well versed in the art will appreciate. However, the distinction between Recorded content (i.e. it exists and can be submitted to the content brokerage engine) and live broadcast content (i.e. it is anticipated to exist in the future and only the schedule describing such can be submitted to the content brokerage engine) appears to justify separating the providers of such into two groups for purposes of registration and tracking within the content brokerage engine and any affiliated system databases (e.g. back-end services database). It should also be noted that all submitted content provider data, and any data generated by the system relating to this content provider, remains within the database management system of the content brokerage engine system for future reference (and modification if needed) by the other components of the content brokerage engine system, as well as the data process, management, and storage components associated with the back-end services database, as well as any other affiliated database systems reasonably contemplated by the current invention.

Once a content provider is suitably registered, the content brokerage engine invites the content provider to submit their content for storage upon the system's database management system. Further, the system prompts the content provider to specify whether the content submitted should be parsed into particular time frame segments (each thereafter becoming a content segment), and if so, how the segmentation should apply to the submitted content. The purpose of such segmentation is to allow subsequent content encoders to identify and select discrete time segments of content that they wish to encode into. Absent such a feature, various content encoders would have difficulty pin-pointing the portion of content to buy/bid on, and consequently encode their content therein. Further, if the content segments are to be distributed in different markets or through different channels (e.g. terrestrial broadcast and DVD sales), the content provider may wish to upload the same content numerous times and segment the same for each market specified, and do so to maximize the effectiveness of the annotation process (descriptive and/or demographic tagging of content segments) outlined below.

At this stage, the content brokerage engine prompts the content provider to annotate their content submission using a variety of demographic fields, descriptive fields, radio buttons, or analogous. The fields will encompass a variety of categories, each designed to simplify and enhance the subsequent searching for content by the content encoders that is expected. For example, it is reasonable to presume that a content encoder (probably an advertiser) would wish to search for particular content segments that would be distributed to a certain demographic (age, sex, socioeconomic status, etc.) in a particular geographic region at a particular time. By having the content encoders annotate their submitted content segments on this basis, the content brokerage engine can serve search results to the content encoders that are extremely relevant to the target audience of the content encoder. Similarly, there will also be the ability for the content provider to annotate the content using key words, and this function in conjunction with the use of descriptive fields should provide a data set that is extremely useful to a content encoder.

A final aspect relating to annotation will involve the content provider setting pricing parameters associated with each content segment. The parameters and functions relating thereto are to operated within the content brokerage engine's designated transaction engine, payment processor, and notification server, each of which are to be operated in conjunction with the database management system (DBMS) and HTTP server, and serves to coordinate the agreement of commercial terms between the content provider (see FIG. 16) and the content encoder (see FIG. 17) who are engaging the content brokerage engine for the purpose of agreeing such terms.

Specifically, the pricing parameters may relate to fixed price purchases for each content segment, establishing a bid (auction) framework for content encoders to purchase said encoding rights, specifying performance terms to be incorporated into the payment terms (e.g. amount to be paid by the content encoder to the content provider per “hit” registered by the back-end services database following the pairing and subsequent distribution process) or a model combining elements of any one or more of these or analogous pricing models. Typically, the interactive communication system operates on the presumption that the content encoders pay content providers for the basic encoded content process—although some circumstances may exist where the opposite is true (e.g. strategic or joint ventures where the content encoder provides an interactive element that content providers wish to include in their audio and/or audio+video content), and the current invention should be read to include this contingency. In this scenario, the content encoder would access a suite of registration and submission pages within the content brokerage engine where they would submit and annotate the nature of their encoding proposal and the commercial terms under which they will allow such to be encoded into prospective content to be offered by a content provider.

Furthermore, while not part of the annotation process per se, it is worth noting that the interactive communication system operator will offer the services of the content brokerage engine for a fee to be paid by the content provider and/or the content encoder, where such fee can be a fixed “one time” encoding fee, a performance fee (e.g. USD 0.05 for each “hit” registered by the back-end services database and recorded and/or forwarded to the content encoder and/or content provider), an “all you can encode” licensing fee, or any combination of these or analogous fee models as deemed appropriate for the service provided.

Once the submitted content (recorded content or schedule of anticipated live broadcast content) is within the system and segmented, annotated, priced, and otherwise finalized, the content brokerage engine assigns each content segment a content segment tracking ID code which will be used to identify the content segment (as well as any user responses to that content segment) as it travels through the system of the current invention (e.g. through the content management layer, through distribution channels, onto playback consoles, across target devices, and back through the data return path network to the back-end services database). It is intended to be the only data element created by the content brokerage engine that is capable of traveling through the system of the current invention as an operational distinct data element (e.g. in retains its identification capabilities and properties at every stage in the system), thereby tying the encoding processes of the content brokerage engine to the execution elements associated with the back-end services database. While it will be true that part of the user response and subsequent textual message response will contain an element of the primary meta data (e.g. the one text answer chosen by the user in response to the text question), for purposes of describing the current invention herein, we take the view that the response element is really a data element derived from the primary meta data by virtue of the user's interaction upon the target device. As such, only the content segment tracking ID code can fairly be viewed as having made the journey from content brokerage engine to back-end services database essentially and operationally intact.

Subsequent to the generation of the content segment tracking ID code, the content brokerage engine concludes the session with the content provider, allowing the content provider to exit the web-interface or initiate a new encoding cycle with newly submitted or previously submitted content and/or content segments.

Turning to the content encoder's actions upon and with the content brokerage engine, FIG. 17 shows the basic data flow properties associated with the content brokerage engine's “buy side” functions. As an initial matter, however, it is worth pointing out that in the preferred embodiment it is presumed that the content brokerage engine will have the benefit of submitted content segments prior to a content encoder accessing the web-interface and searching for content segments suitable for encoding. This being said, the current invention does contemplate circumstances where content encoders will wish to submit their encoding preferences prior to suitable content segments being available for review by content providers, and the inventors of the current invention intend to provide a function within the content brokerage engine for content encoders to post their searches (for content provider review) before prospective content is submitted to the content brokerage engine by content providers. Nonetheless, for purposes of describing the basic functions of the content brokerage engine, it will be presumed that a suitable content segment catalog exists for purposes of content encoder search, review, purchase and encoding.

Moving back to FIG. 17, one can see the content encoder accessing the content brokerage engine via an interaction with the HTTP server. As was the case for the content provider, the content encoder registers herself with the content brokerage engine, receives a user Name and Password (or analogous), and is assigned a content encoder ID code by the content brokerage engine. Thereafter, the content encoder is allowed to browse the content brokerage engine database for content segments, and specifically, search via an assortment of demographic and descriptive tags. Further, should the content encoder wish to search via keyword, this option will also be made available. Having received any search request from the content encoder, the content brokerage engine's indexer processes the request and assembles the appropriate search results and relevant data, accessing all appropriate portions of the content brokerage engine (DBMS, transaction engine, etc.). The indexer thereafter serves a list of prospective content segments that may be of interest to the content encoder, with such list being capable of being sorted further by standardized fields (content title, airing date, geographic market, targeted demographic, etc.).

Thereafter, the content encoder may select content segments for review, such review including, but not being limited to the review of the actual audio content and/or audio+video content, the full annotation relating to such content segment, the associated pricing parameters, and/or any further relevant data available on the system at that time. It should be noted that certain content cannot be reviewed per se in advance of its distribution (e.g. anticipated live broadcast content) and proxies for review will have to suffice (schedules, descriptions, etc.). The same may also hold true for recorded content that is sensitive in nature (e.g. a secret plot line in a soap opera). As such, the level of information available for review relating to particular content segments will vary from circumstance to circumstance. However, given that most content is both recorded and previously aired (e.g. television repeats, music videos, etc.) it is anticipated that the current invention will be storing, processing, and serving content and related information that can be reviewed in a meaningful fashion by content encoders wishing to review such.

Following the review process, the content encoder will select the relevant content segment that she wishes to encode into. At this stage, the content encoder engages the transaction engine functions of the content brokerage engine and makes a registered offer to buy, bid upon, or otherwise commercially satisfy the pricing parameters set forth by the content Provider. Thereafter, depending upon the particular parameters set forth by the content provider, the content encoder satisfies the parameters (e.g. the transaction engine determines that the party has successfully outbid another competing content encoder) and is deemed to be the party entitled to encode into the particular content segment. The transaction engine then invokes the payment processor and notification server to affect the means for payment and to notify each party to the transaction of its completion. Further, as those well versed in the arts will appreciate, there may be additional confirmation steps required by the content brokerage engine to ensure that the winning party is capable or legally able to encode the data.

Following the payment execution phase, the content brokerage engine will offer an assortment of encoding templates (textual message templates) to the content encoders that serve to facilitate and streamline the content encoding process. The content encoders review these templates and then choose the one most appropriate for their encoding needs. For instance, the textual message template might be in the form of five empty fields (one question field being herein termed the textual message, and four answer fields herein termed the user response choices), with these fields being capable of satisfying advertising, entertaining, or similar functions once completed by the content encoder. In the case of an advertiser encoding into a typical television soap opera, the content encoder might input into the first field text that asks a question of the audience member (“For a chance to win a new Volvo, what color was the Volvo driven by Dr. Smith”). The next four empty fields could be filled in by the content encoder with various colors (“blue” “red” “white” “green”). As should be clear, the content encoder is trying to entice the target device user to respond to the soap opera product placement, and confirm whether people are indeed paying attention to the show (hopefully, they answer the question correctly and get entered into a contest to win a new Volvo).

Once the content encoder fills in the textual message template, the content brokerage engine serves additional templates to the content encoder relating to certain limitations that should be placed upon the encoded content. These limitations include time expiry limits, location limits, user age limits, and any analogous limits that can be envisioned by the interactive communication system operator in the course of maintaining the content brokerage engine. For instance, a content encoder may wish to encode messages that are for mature audience members only, and it would be a valuable feature to include in any message delivery that the target device user first confirm that they are of a particular age before being permitted to see the textual message and user response choices on their target device. Similarly, certain geographic locations may have laws in place that restrict certain gaming activities, and the content brokerage engine would be ideally suited to enforce such limitations by refusing to forward the textual message response data to the content encoder (effectively aborting the gaming activity before contact is made with the purveyor of the game in question). In terms of time limits, it is foreseeable that certain content encoders will wish for their encoded messages to disappear (or at least be invalid) after a particular date. Having a comprehensive set of input fields being offered by the content brokerage engine to the content provider will greatly enhance the effectiveness of the current invention, and subsequently encourage more market participants (content providers, content encoders, target device users, etc.) to use and promote the system of the current invention. Any instructions received from the content encoders may thereafter be incorporated into the encoding process by the content brokerage engine along with the textual submissions. As such, the submission of such to the content brokerage engine effectively translates these textual submissions and limitation instructions into primary meta data that will be forwarded to the meta data encoder referred to previously (See FIG. 19) and encoded into the relevant content segment selected by the content encoder. Once this information has been received by the content brokerage engine, a confirmation message will be served to the content encoder and content provider for contingent and/or final approval (e.g. the content provider may wish to manually review all encoded messages prior to final encoding, in which case the payment execution phase would be deemed contingent or preliminary in nature).

At the time (or shortly thereafter) of such confirmation stage, the content brokerage engine will seek a Processing address from the content encoder as such relates to that particular encoding activity. This address will be an electronic address (e.g. e-mail, IP) distinct from the contact address used in the registration process. The registration contact details pertain to general communications to the content encoder (e.g. billing), whereas the Processing address will be an pre-determined address where the content encoder wishes to collect the data generated by the content brokerage engine in the course of it receiving target device users' textual message responses (such user textual message responses being prompted by having interacted with the primary meta data submitted by the content encoder).

Following the Processing address and primary meta data submission stages, the content brokerage engine will generate an encoded segment tracking ID code that serves several purposes. First, because the content brokerage engine will be coordinating data sets between itself and those received and processed by the back-end services database, each audience member interaction with content (textual message response) will need to matched to the relevant encoded content segment. By generating the encoded segment tracking ID code and ensuring that it is present at every stage of transport through the interactive communication system, the content brokerage engine enables the interactive communication system operator to undertake any number of audit, analysis, processing, and forwarding activities on behalf of content encoders, content providers, third parties, and itself. In terms of the content encoder, the creation of an encoded segment tracking ID code gives the content encoder a unique identifier that can be used to track data sent to their Processing address. It should be clear to those versed in the art that the content encoder will subsequently act upon this data (reply to the target device user, enter them in a contests, authorize them to download a ring tone, etc.), and such actions by the content encoder arte typically referred to as fulfillment. As such, providing a unique encoded segment tracking ID code to the content encoder relating to each distinct encoding activity will be vital if the content encoder wishes to engage in any fulfillment activities. Similarly, the encoded segment tracking ID code will assist the content encoder analyze, audit, or otherwise process the data received since they will be able to tie such data back to a particular distribution of encoded content within a given market at a given time.

Subsequent to the generation of the encoded content segment tracking ID code, the content brokerage engine concludes the session with the content encoder, allowing the content encoder to exit the web-interface or initiate a new encoding cycle with newly selected or previously selected content and/or content segments.

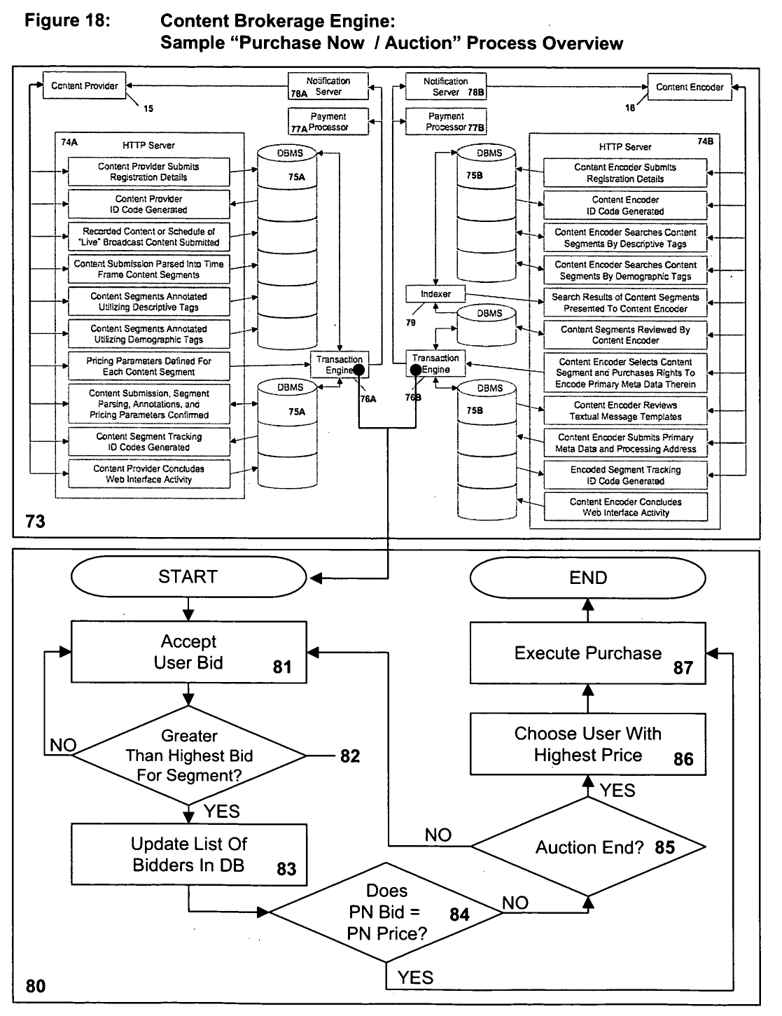

Turning to FIG. 18, it is worth reviewing a sample bidding process as conducted by the content brokerage engine's transaction engine. As will be apparent to those versed in the field, there are numerous bidding models (and corresponding bid selection algorithms) to choose from and the current invention anticipates permutations involving these. For purposes herein, however, the inventors simple wish to show that a bid engine is not only possible, but also very practical to implement within the content brokerage engine pairing process. It is also useful to see that a bid engine function that is practical will contribute to the ultimate adoption of the current invention and therefore acts as a novel and useful component of the current invention. By way of background, however, it is worth walking through the basic interaction between the content brokerage engine's database functions (e.g. content, annotations, etc.) and its transaction functions, whether related to a content encoders outright purchase of the right to encode into content or related to a content encoders bidding on such a right to encode.

As described above, the content brokerage engine is essentially a marketplace that is accessed by various participants seeking the benefits of that marketplace (content providers and content encoders, each technically being a Participant for purposes herein). These Participants access this marketplace through a client device (e.g. Internet enabled desktop computer) at the Participant's site of operations. Typically, the Participant will use a web browser client, which communicates through the hypertext transfer Protocol (HTTP). The browser performs layout and rendering of the hypertext received from the content brokerage engine.

The annotated content segments (each segment being the equivalent of a digital good being stored within the marketplace) resident within the system are effectively categorized by specifying a hierarchical ontology. For instance, in the case of Recorded content segments, the hierarchy could represent the genres and sub-genres of that particular content segment. In addition to the classification, each Recorded content segment will have certain other attributes, which are dependant upon its ultimate application. For example, a particular Recorded content segment might have an associated targeted demographic, author, title, and set of descriptive key words that are stored alongside the segment.

In an exemplary interaction with the content brokerage engine's marketplace, the content encoder (a type of Participant) might choose to browse the collection of Recorded content segments. The content brokerage engine would render and send the hierarchical classification structure, the content encoder would select the category that he or she is interested in, and then the content brokerage engine would serve the collection of Recorded content segments that matched that classification. This could be implemented by looking up the classification within an inverted index structure created and based upon the Recorded content segments. Another possible embodiment for listing the segments is to have a searchable interface whereby the content encoder provides some query terms and/or filtering criteria to the content brokerage engine. The ordering of the resultant matches is ranked according to the relevance of the segment to the search query and served to the content encoder making the search query.

Once a Recorded content segment has been selected by the content encoder, the content brokerage engine returns a more detailed description of the segment including associated segment attributes such as price, time period the segment will remain “for sale”, etc. From this screen a content encoder can choose to purchase or bid on the segment by submitting their buy request to the HTTP server associated with the search. As those well versed in the art will recognize, there are many possible transaction models. The content encoder could choose to simply purchase the rights to encode their primary meta data into the selected segment.

Alternatively, the content encoder can provide a bid price on the segment, if the segment is being auctioned. An auction engine will process all of the bids for this particular segment and determine the winner of the segment (specifically, the winner receiving the right to encode into the segment) according to the auction parameters. For instance, in one type of auction, the winner is determined to be the submitter of the highest bid price at the time in which the auction has been specified to end. In another model, the winner is determined to be the submitter of the second highest bid price at the time in which the auction has been specified to end. The permutations are possibly endless, but the applicability of the auction remains constant.

As has been shown in FIG. 16 and FIG. 17, there is presented one embodiment of the content brokerage engine, including the constituent parts representing the buying and/or bidding functions. Items therein specifically serving the marketplace function include an HTTP server, a database management system (DBMS being navigational, hierarchical, network, relational, or object-oriented), an indexer, a transaction engine, a payment processor (credit cards or otherwise), and a notification server. The content encoder interacts with these components via a web browser installed on the client system. The web browser communicates directly with the HTTP server, which is responsible for rendering the data into HTML format, presenting navigational features and typically securing a secure session via secure sockets (HTTPS).

When the content encoder browses a particular category in the hierarchical ontology, the server satisfies the request by invoking the underlying database. The database houses the totality of the various content segments, including associated data and attributes. Turning to a search for a particular Recorded content segment therein, the database contains a segment schema with possibly an index key on the category of the segment. Similarly, a content encoder can filter for segments meeting a certain criteria if that criteria type is represented in the segment schema. Alternatively, a content encoder may request a listing by performing a keyword search on an index. The indexer generates an index by reading updates to the database and indexing on the field that is to be searched on. Once the results are retrieved via each of the above mechanisms, the list of result summaries is ranked according to a relevance algorithm.

When the content encoder requests to view detailed information relating to a particular segment, the request may also be satisfied by looking up the segment's unique content tracking segment ID code registered within the database segment table. If the content encoder chooses to purchase or bid on a particular segment, the purchase request is satisfied by the HTTP server sending the request to the transaction engine. The transaction engine contains an algorithm for handling buy and bid requests. Several models are possible for handling transactions. One possible model is for the content encoder to directly purchase the segment. In this case, the transaction engine will update the inventory in the database, and notify the HTTP server to send the Recorded content segment to the content encoder (i.e. the purchaser) as well as the content provider. An alternative model is for the content encoder to bid on a segment. In this case, the transaction engine operates as an auction engine. Several possible auction mechanisms are known and one skilled in the art will readily envision alternative implementations.

Once a purchase has been verified (as mentioned above, purchases may be conditional upon fulfilling some other criteria apart from meeting the purchase and/or bid price), the transaction engine executes the purchase by collecting payment (via the payment processor) on the Recorded content segment via wire transfer, credit card, or other payment method and may involve contacting a third party for payment verification (e.g. executing a credit card order by contacting a credit card processor). In the case of an auction, the purchase is resolved at the auction close time and the content encoder and the content provider are notified of the result of the auction by a notification server. The notification server could send an e-mail message or other alert to the content encoder, which directs the content encoder to instructions for obtaining the segment.

FIG. 18 also shows a simplified process diagram of an auction engine function resident within the transaction engine of content brokerage engine. In this embodiment the auction engine implements a variant of a second-price auction (also known as a Vickrey auction), although several possible auction models are possible. In this example, the winner of the auction is the content encoder who bids the highest price, yet the price the content encoder actually pays is the second highest bid price (or the highest if there is only one bidder). There is also an option for the content encoder to “purchase the segment now” (PN) if the content provider has set a PN Price and said PN Price has not been reached. If the seller has not set explicitly set a PN Price, then the PN Price is effectively infinity. In the first step, the auction engine sleeps until a content encoder submits a bid for a particular segment. A bid comprises the unique content encoder ID code (“y1”), a content segment tracking ID code (“x”), and a bid price (“p1”) and is technically accepted by the auction engine 81. In decision node 82, the bid price “p1” is compared against the list of bids (“p1”, “p2”, “p3”, etc.) from bidders (“y1”, “y2”, “y3”, etc.) for content segment tracking ID code “x” as retrieved from the database table.

If the current bid price “p1” is not greater than the maximum bid price in the list, then the bid is rejected and the auction engine returns to the waiting state, waiting for the next bid to be accepted by the auction engine 81. Otherwise, the bid is inserted into the database table of bids indexed on the segment “x” in the next database updating step 83. This updates the display that content encoders see when they browse the bidding history of the segment “x”. In the next decision node 84, the system checks the bid to see if it is a PN Bid and that the bid price equals the PN Price. If it is, then the system proceeds to the step where the purchase is executed 87. Otherwise, the system continues to decision node relating to the determining the auction end 85. In decision node 85, the system checks if the auction has ended by comparing the current time to the content provider (the seller) specified auction end time. If the auction is not over, then the auction engine returns to the waiting state, waiting for the next bid 81. Otherwise, in the next step 86, the system determines which content encoder has submitted the highest bid and the price of the second highest bid. Finally, in step 87 the purchase is executed by notifying the content encoder and the content provider, charging the content encoder for the agreed price, and enabling the content encoder to thereafter encode their primary meta data into the content provider's Recorded content segment by sending each to the meta data encoder (see FIG. 19).

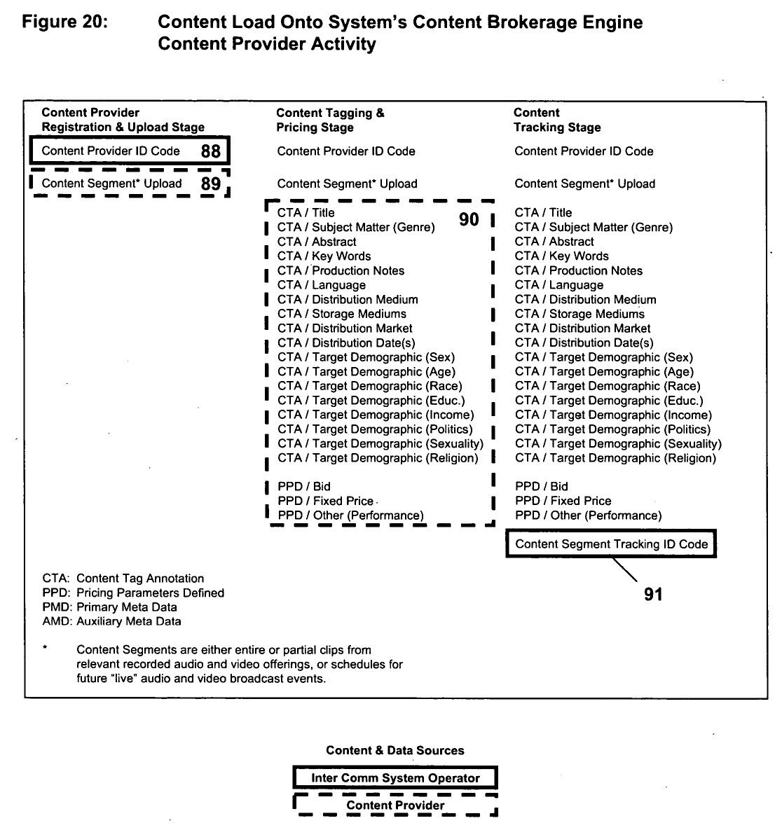

Notwithstanding the aforementioned detailed description relating to the current invention, it is worth further describing the data composite created by the numerous interactions with the interactive communication system as effected by various parties, at various times, and through various devices. As such, we turn to FIG. 20 through FIG. 23 to outline the basic data composites created, sent, modified, and received by elements of the current invention in its preferred embodiment.

Turning to FIG. 20, one can see the incremental aggregation of data within the content brokerage engine resulting from the content provider's input of content and related information, as well as information generated by the content brokerage engine's processing of such inputs by the content provider. Of particular note, one can see that most of the annotation to be provided by the content provider will not be key word based, but instead will be categorical in nature. This is to reflect the fact that content providers are extremely well positioned to provide this type of information, and furthermore it is this information that traditional purchasers of content wish to analyze. Key word annotation will also be encouraged, but it is arguably a primary function of key word searching to create a categorical profile of the content being searched. It is therefore the view of the current invention that such categorical analysis is provided directly by the party submitting the content. It should also be noted that apart from the content segment itself, none of the information presented in this FIG. 20 gets encoded into the content segment by the meta data encoder. This information is gathered by the content brokerage engine (and shared with the affiliated back-end services database where necessary) to facilitate the search, review, and matching of content segments with prospective content encoders.

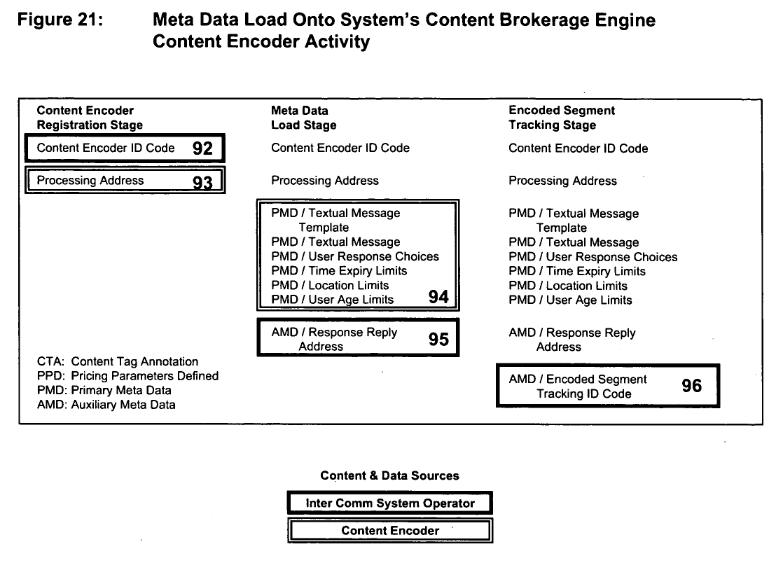

Turning to FIG. 21, one can see the incremental aggregation of data within the content brokerage engine resulting from the content encoder's input of primary meta data and related information and from the content brokerage engine's processing of such. Of particular expiry limits, location limits, user age limits). Further, other information could be requested by the content provider and/or content encoder to be encoded into a content segment, and as such, these lists are illustrative and may be expanded to include other, analogous limitations or information tags. It is also worth noting that of the primary meta data (PMD) and auxiliary meta data (AMD) listed in FIG. 21 is the only information that is actually encoded into the selected content segment. There is no value to be gained by having other information (e.g. content encoder ID code or the content encoder's Processing address) encoded into the content segment since this information will be available to the back-end services database by virtue of receiving the encoded segment tracking ID code that is encoded as auxiliary meta data.

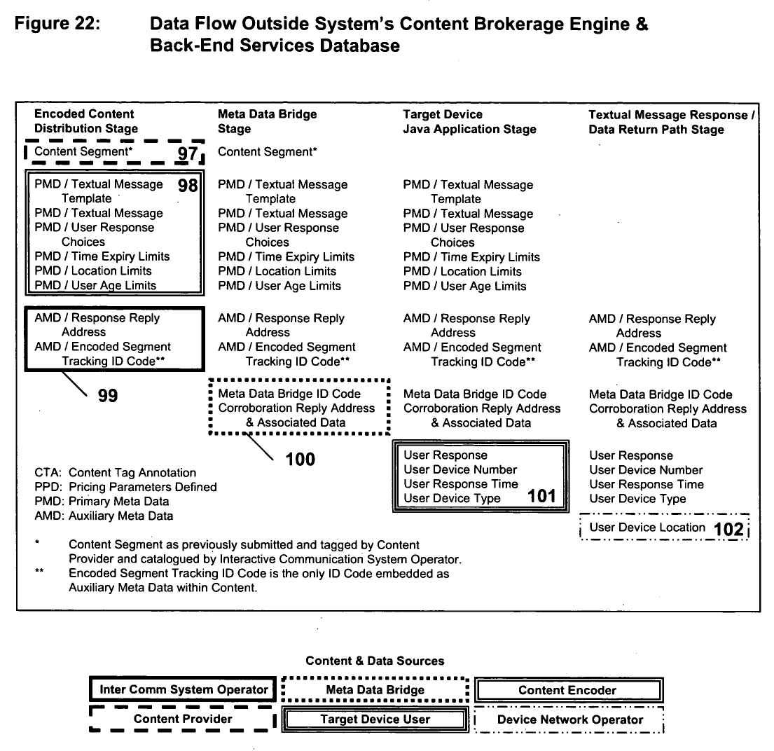

Turning to FIG. 22, one can see the process by which a content segment, primary meta data, auxiliary meta data, and associated information is disseminated across and through a communication environment in which the system of the present invention operates. In particular, this FIG. 22 shows how information is aggregated, modified, and purged during each of the several stages involved in the down stream and return path data flows enabled by the current invention. In the Distribution stage, encoded content is disseminated through various distribution systems with the primary meta data and the auxiliary meta data encoded therein. Once this encoded content reaches a meta data bridge (attached to or housed within a playback console), the content segment (the audio or audio+video carrier) is dropped from the process, and the Meta data bridge ID code and corroboration reply address (and instructions) are added to the relayed data package as it is sent to the target device. Once this relayed data package is internalized by the java application within the target device, presented to the user, and a user response generated in response to this prompt, then all of the primary meta data components are dropped from the data package and the user response and other target device user related data (if available) is added to the data package (e.g. user device number, user response time, user device type, etc.) prior to its being delivered as a textual message response package to the back-end services database via the data return path channel (e.g. the target device's wireless network operator). Furthermore, once within the data return path channel, it may also be possible for the back-end services database to ascertain additional data relating to the user (e.g. user device location). It should be noted, that at every stage outlined in these interactive communications (initial distribution, relay, processing, etc.) the goal of the current invention is to include only data within the data package that is required to initiate and conclude the next stage of the interactive communication sequence and to provide enough data to the back-end services database (i.e. the interactive communication systems operator) to piece together what content and data as provided to the content brokerage engine by the content provider and content encoder actually worked its way through the interactive communication system and prompted interactive responses from audience members. Once there is a complete picture of the interactive activities, then the interactive communication systems operator may forward relevant data to the content provider and content encoder for further fulfillment and bill the same for the service so provided.

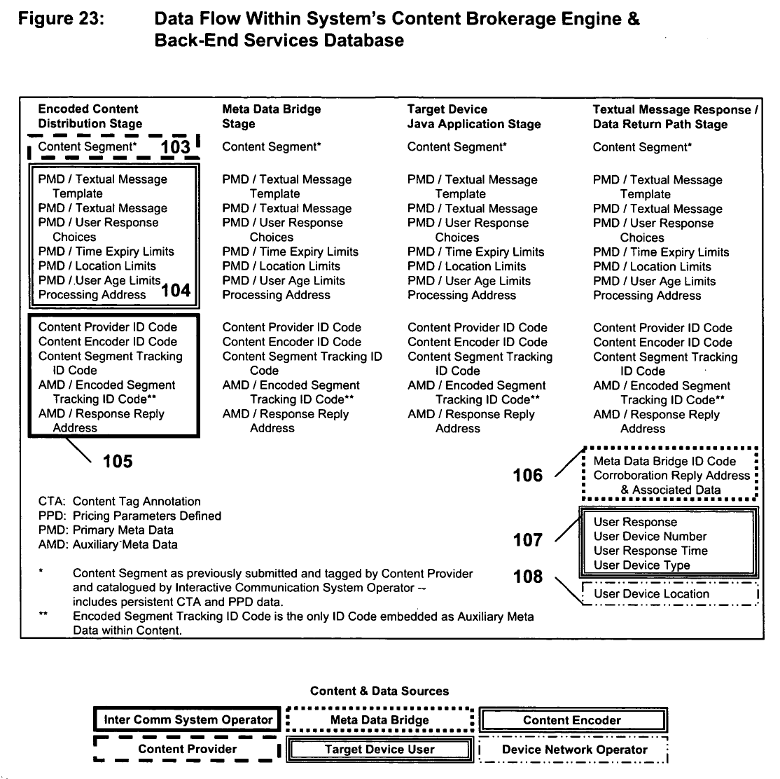

Turning to FIG. 23, one can see the process by which content, primary meta data, auxiliary meta data, user responses, and associated information is incrementally aggregated within the collective operations of the interactive communication system comprised of the content brokerage engine and corresponding back-end services database, with such aggregation derived from input generated by the content brokerage engine, content providers, content encoders, target device users, and various third-party participants within the affiliated communication environment in which the system of the present invention operates. In contrast to the data flow described in FIG. 22, the data aggregation within the back-end services database does not seek to “drop” data at any time. Once data is provided (either through the content brokerage engine operations, or through the operations of the target device user, device network operator, or otherwise), the back-end services database stores such for future analysis, audit, and related processing. It also demonstrates that much of the data collection process takes place away from the back-end services database and only accumulates within the back-end services database once the textual message response is received from the user's target device (e.g. meta data bridge ID code, corroboration reply data, user device type, user response time, user device location, user response).

The Content Brokerage Engine As Stand-Alone Device

Notwithstanding that the content brokerage engine has been created to serve the needs of the interactive communication system and is a critical element of such; the creators of the current invention also believe that the content brokerage engine is a viable system whether paired with the elements set forth above in the description of the current invention or whether used to match content to encoders of meta data in different fields, irrespective of whether the encoded meta is to be distributed via a playback console and relayed back via to a cellular telephone return path (or analogous) or through any one or more of the following scenarios:
(a) meta data distributed via a web page and relayed back via a client's web browser's return path;
(b) meta data distributed via a printed page (or outdoor signage) and relayed back via a cellular telephone's return path (or analogous); and
(c) meta data distributed via a playback console and relayed back via the playback console's return path (or analogous).

As was set forth above, the content brokerage engine serves a vital purpose in terms of making the interactive communication system commercially viable. Absent a system like the content brokerage engine, market participants (content providers, content encoders, audience members, content broadcasters, content distributors, playback console manufacturers, etc.) will have no expectation that there will ever be enough encoded content to justify the effort and cost of getting this type of interactive system up and running. This rationale holds true for other fields where primary content is paired with secondary content. Case in point, without a web-based brokerage system for matching content to advertising, the field of “paid search” may not have developed to the extent we see it today (e.g. Overture, Google). In the case of paid search, an advertiser can bid for the right to embed his ad content into the web content created by the search engine (i.e. the search results page). Viewed more fundamentally, the provider of the search page results is providing an audience member with primary content (content that the audience member specifically seeks out and/or engages with) and the advertiser is embedding their advertising message as sponsored content (usually a brief description of the product or service offered, plus a link to another web site) within the primary content (e.g. off to the side of the search result page). It is well-established that absent a content brokerage system to be accessed by the advertisers and content creator (the search engine), this pairing of primary content and sponsored content could not take place to the degree one witnesses in the current web marketplace, with pairing of content that is not only highly specific in terms of subject matter, but also in terms of geography (e.g. very localized pairings are possible).

And the paid search phenomenon is just one example. Web-based content brokerage engines also exist for the pairing of traditional television broadcast content and traditional radio broadcast content. The same is true for the of selling print media spaces in magazines and newspapers:

In simplest terms, the pairing mechanisms currently found in the marketplace concern themselves with the placement of sponsored content either as a:
(a) “sequential placement” next to primary content or
(b) “embedded placement” within the primary content.

It is on these two points that the current invention's content brokerage engine differs since the content brokerage engine enables the invisible, discrete, “encoded” placement of sponsored content into primary content.

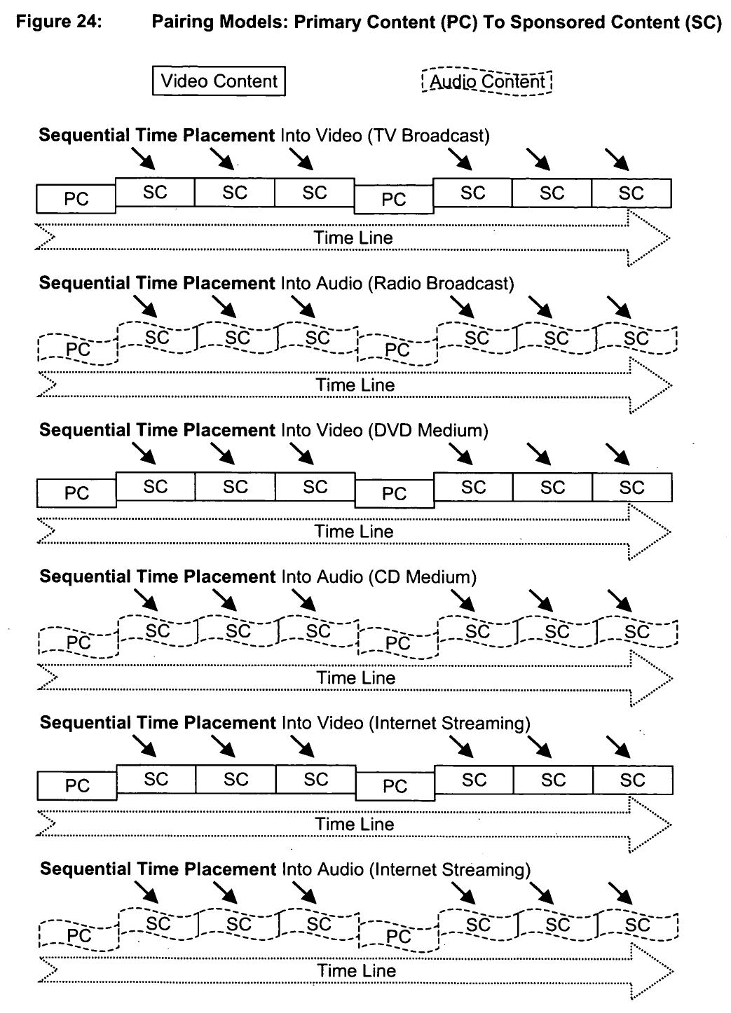

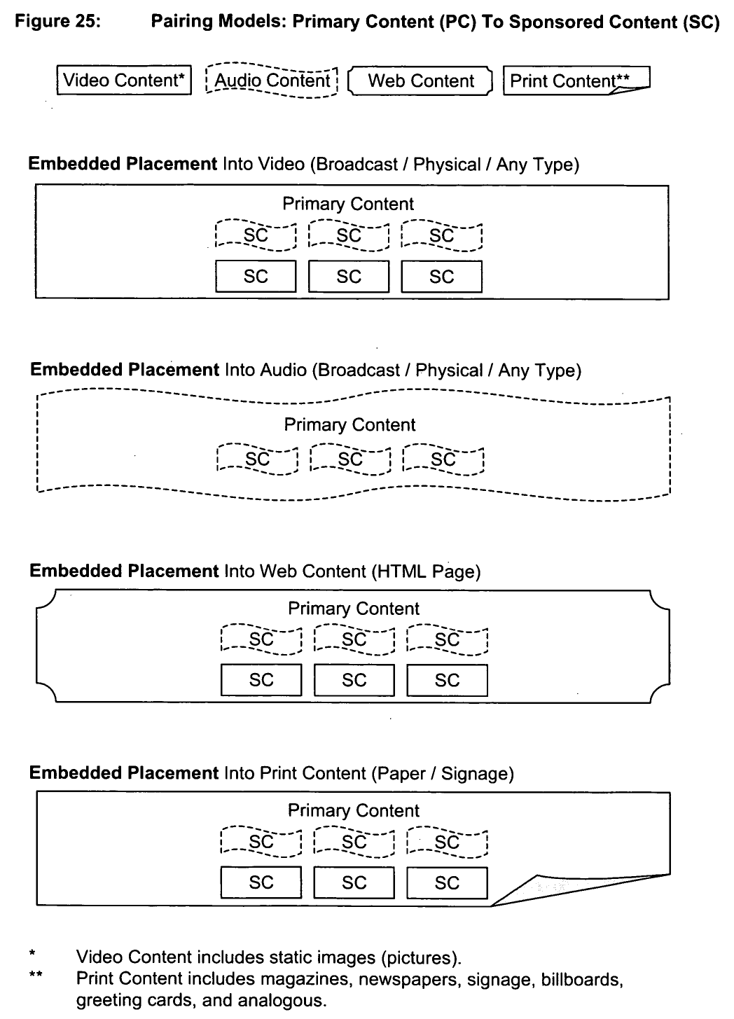

By way of example, sequential placement has an audience member experiencing sponsored content as a temporal interlude between primary content experiences (i.e. the 30 second commercial typically is shown at a “commercial break” of the program currently being watched or listened to). Absent audience member action (e.g. changing the channel, walking away, time shifting utilizing a personal video recorder), all instances of sequential placement result in the audience member seeing or hearing the placed sponsored content (See FIG. 24). Similarly, as shown in FIG. 25, embedded placement result in the audience member seeing and/or hearing the sponsored content at the same time they are hearing and/or seeing the primary content, whether as an ad banner embedded (literally an “overlay”) within the televised program screen image, as a voice over, as a overlay web banner, as overlay web paid link, as an overlay as an “pop-up” web advertisement, as an overlay on printed magazine pages, as an overlays on billboards, or otherwise. Each of these embodiments, whether manifesting in audio or video (including static images) sponsored content being put forth interrupts the experience of the primary content. Literally, the audience member has no choice but to experience the sponsored content since it is a visible or audible addition to the primary content. Even web page pop-up ads require the audience member to affirmatively “turn them off” (the “opt-out” model), lest they appear with an inadvertent rollover of a display curser or pointer. To wit, the current market embodiments relating to content brokerage engines relate to these two types of activities (sequential placement and embedded placement). The current invention's content brokerage engine concerns itself with neither of these two scenarios, but instead enables the marketplace pairing of primary content to sponsored content, where the sponsored content is only to be experienced by an audience member who affirmatively acts to receive the such in conjunction with its primary content (there must be an “opt-in” action by the audience member). Examples of such an “opt-in” process by an audience member to experience the sponsored content might include enabling their cellular telephone to receive Bluetooth transmissions from a television playback console, enabling their cellular telephones to capture and decode audio encodings carried over a radio program, ticking a box on a web-page of primary content to allow sponsored content “pop-up” ads to be displayed, or analogous actions taken by the audience member specifically consenting to the presentation of sponsored content at the time primary content is being experienced.

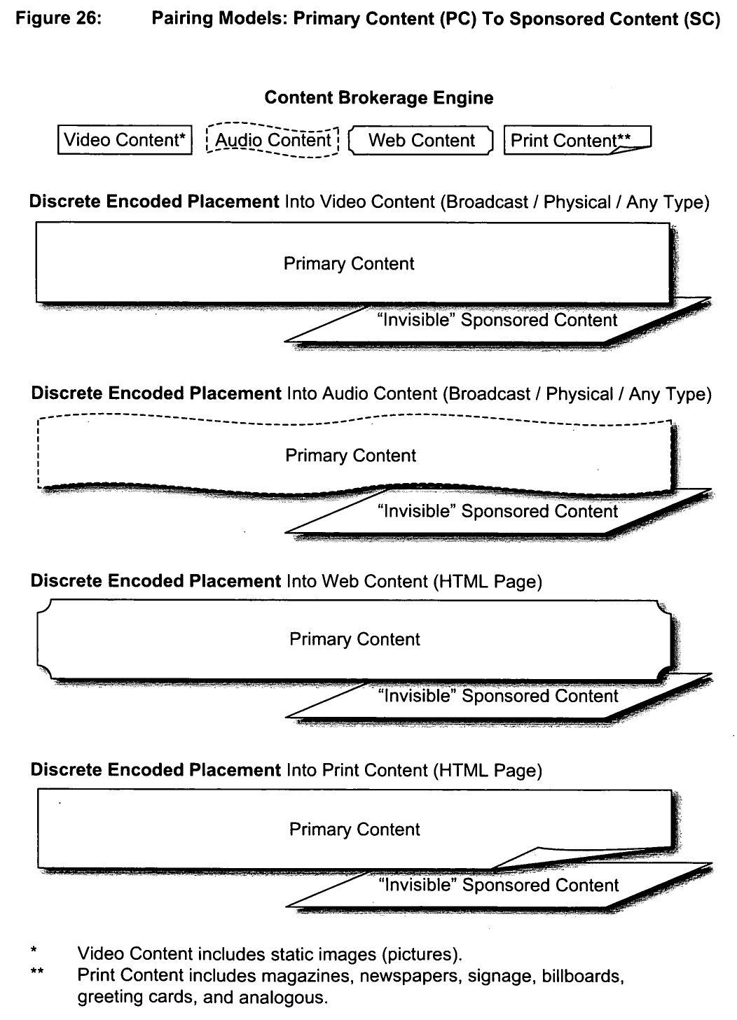

Given that the content brokerage engine is fundamentally distinct from the sequential placement and embedded placement models, it is then worth exploring the related prior art (i.e. yet to be embodied in commercial deployments) as such relates to content brokerage engines tasked with the pairing of sponsored content that is to be discretely encoded into primary content (discrete encoded placement technique as seen in FIG. 26). Based upon our research, there is but one instance in the prior art relating to a brokerage engine enabling discrete encoded placement of sponsored content into primary content. In USPTO application 20060212897 Microsoft posits a system for the encoding of sponsored content into primary content. However, unlike the current invention's own content brokerage engine, the Microsoft system dictates that the pairing and encoding be done using artificial intelligence, specifically any primary content resident on the brokerage system. These key words are auctioned off in a similar manner as seen in the existing paid search models (advertisers bidding for the right to have their product or service affiliated with a particular search result page served in response to an audience member's search request on those same key words) and thereafter the sponsored content is automatically inserted into the primary content associated with the generated key words.

In contrast, the content brokerage engine does not seek to encode any sponsored content into primary content based on encoders (advertisers) bidding on or purchasing the rights associated with certain key words. The encoders on the content brokerage engine must manually choose the primary content to be- encoded and purchase or bid against other encoders for the right to encode into that particular content segment. There is no use of key words as an absolute proxy for reviewing and selecting the primary content itself.

First, it is likely that the annotation system proposed by the current invention's content brokerage engine will be far more relevant (and valuable) to encoders seeking to pair their sponsored content messages with primary content than the results to be delivered by voice recognition and data mining techniques. It is conceded that the Microsoft system could greatly speed up the pairing process, but it does so at a tremendous risk (and likely cost) to the advertiser. There are real and perceived concerns about automatically encoding sponsored content into audio and or video content based just upon key word relevancy. In the advertising industry, this problem is referred to as the “trusted content” issue in that an advertiser cannot take the chance his sponsored content gets encoded into inappropriate primary content. In addition to the lost fees paid for such inappropriate pairings, there is considerable downside in terms of loss of market reputation if mature content (nudity, violence, subject matter) is paired with youth content, or vice-versa. Other scenarios exist as well (liberal messages paired with conservative messages, geographic messages paired with content distributed in non-applicable geographic markets, etc.). While it is certainly possible that these problems can be worked out over time, it is the view of the advertising industry that such automation will not be welcome for many years (perhaps decades) to come. As such, advertisers and other prospective encoders will wish to have both a knowledgeable person annotate the primary content and have a knowledgeable person review the annotated content prior to agreeing to purchase the rights to encode sponsored content therein.

Another difference to the Microsoft model is that the content brokerage engine also allows the outright purchase of the right to embed into primary content. Whether a bid model or fixed price model is affected is the choice of the content provider.

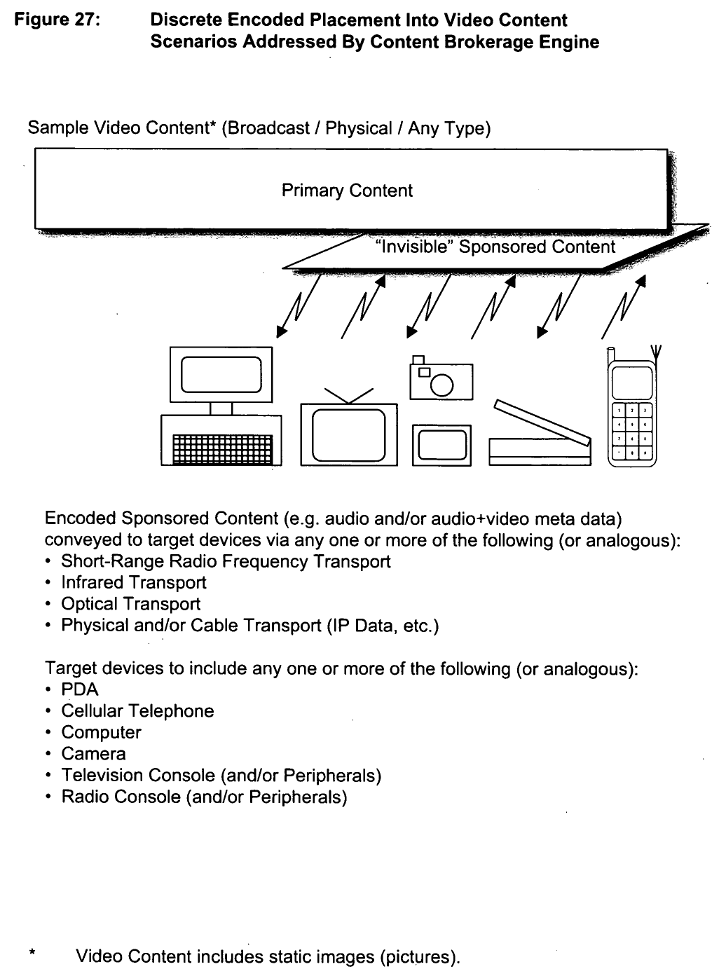

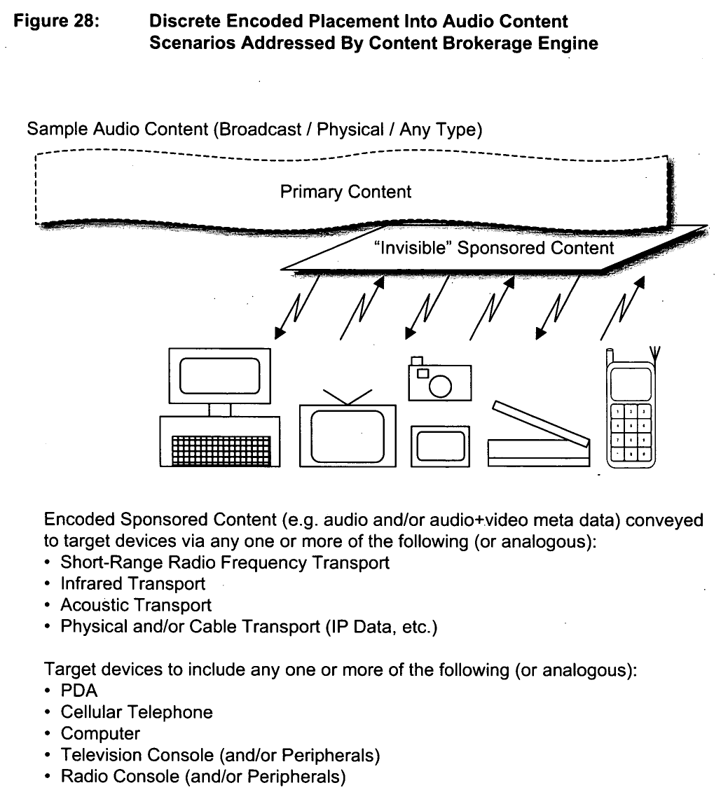

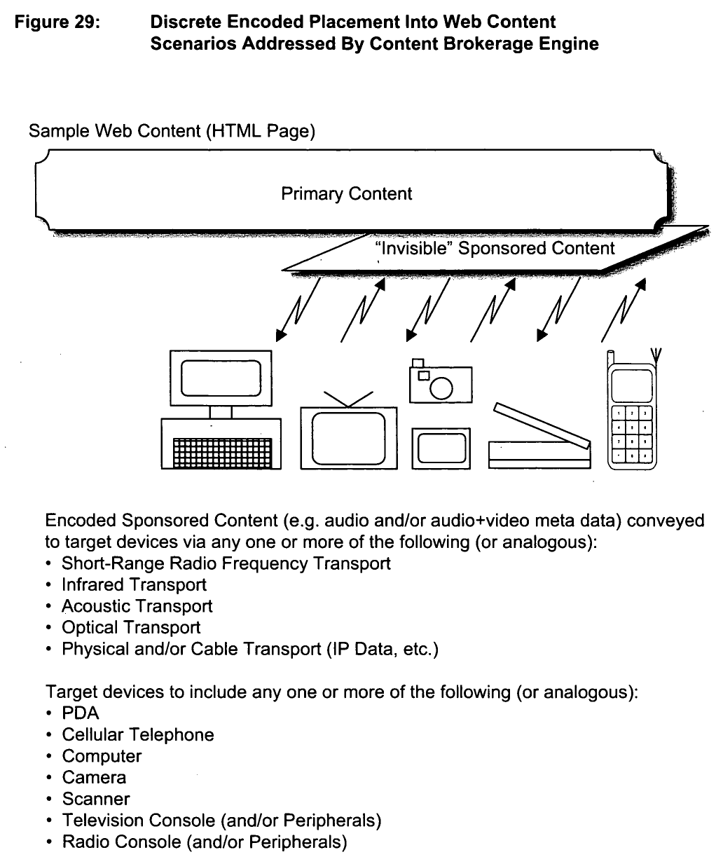

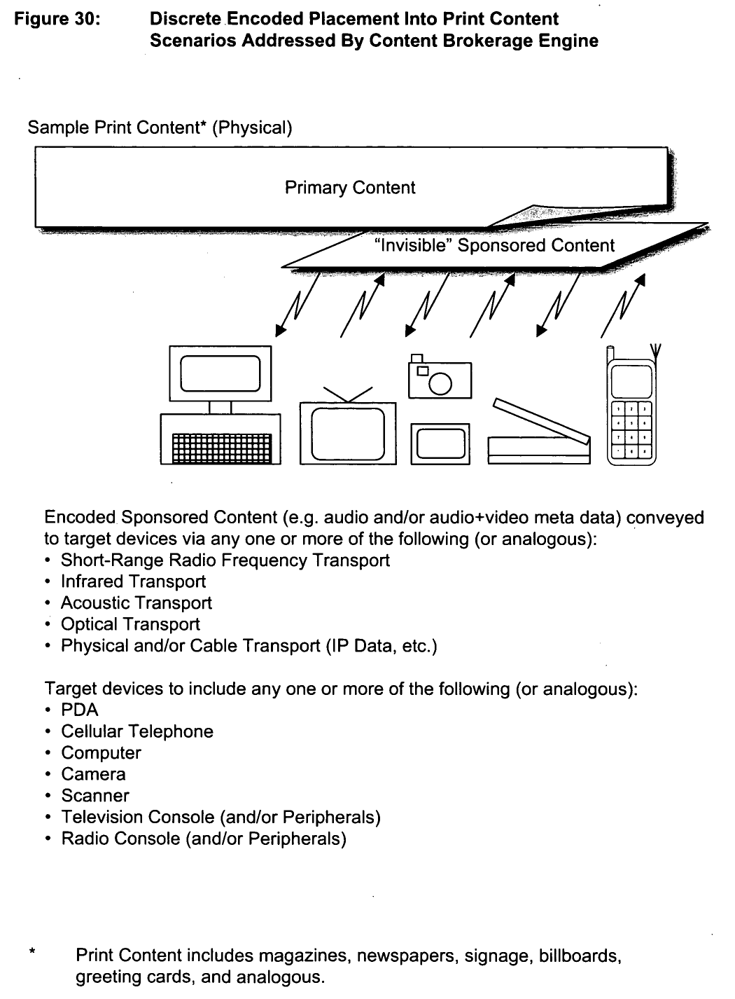

Turning briefly to the markets to be served by such a content brokerage engine, it is envisioned that such an engine can enable numerous interactive scenarios beyond the scope of the interactive communication system described above. For instance, in time there is considerable potential in the market for the actual deployment of interactive communication systems being developed that leverage upon the discrete encoding of sponsored content into primary content. In fact, the prior art details numerous possible methods utilizing technologies as diverse as acoustic transport, infrared transport, optical transport, and radio frequency transport which may eventually be deployed across one or more distinct content distribution platforms that employ video means as the primary content carrier of sponsored content (FIG. 27), audio means as the primary content carrier of sponsored content (FIG. 28), Internet means as the primary content carrier of sponsored content (FIG. 29), and/or print media means as the primary content carrier of sponsored content (FIG. 30).

On a final note, it should not be surprising that the market has yet to deliver a content brokerage engine for encoded placement of sponsored content. To date, there has not been a system deployed capable of justifying the dissemination of primary content encoded with invisible sponsored content. It is true that much of the prior art contemplates such discrete encoding of messages into content (e.g. interactive TV technologies and systems utilizing audio encoding and video encoding), but there has yet to be a meaningful market for such. As a result, there have been no efforts in the prior art that create a web-based platform for the specific encoding of sponsored content into primary content. However, as the aforementioned description relating to the interactive communication system shows, such an interactive market is feasible—so long as it contemplates the systematic use of a content brokerage engine. It might be fair to say that deployment of such systems has presented a “chicken and egg” proposition for market participants (without the encoded content we won't enable the system, but without the enabled system we won't endeavor to encode the content). The solution posited by the current invention is to formulate the devices that enable the system, and to do so in a manner where market participants are motivated to deploy both the devices and the encoded content simultaneously.

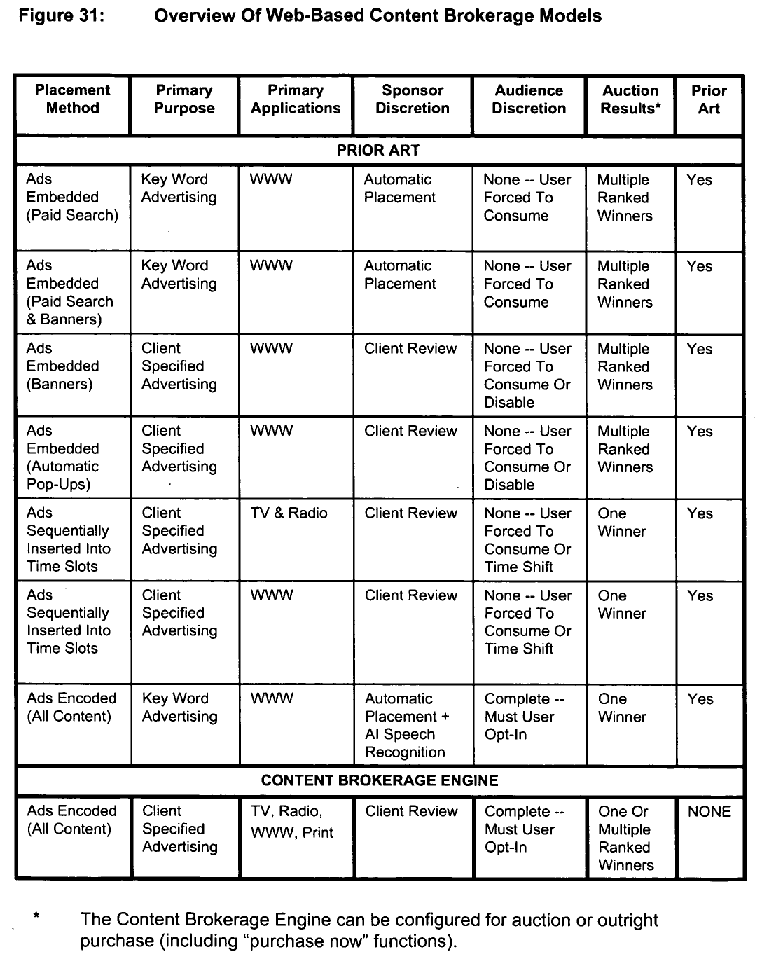

Presuming that enabling market participants accept the coming convergence of various primary content distribution systems and return path communication systems, and the benefits to be gained by discretely encoding sponsored content into primary content, then one can reasonably anticipate that these same market participants will seek to utilize some or all of the elements of the current invention in market scenarios distinct from the ones set forth herein. Foremost, it will be recognized that there is tremendous potential offered by the discrete encoding of sponsored content into primary content (both as a replacement and as a complement to traditional sequential placement and embedded placement techniques) and there will be a need for a web-based content brokerage engine specifically tasked with matching providers of primary content with parties seeking to discrete encode their sponsored content therein. For this reason, the inventors of the current interactive communication system wish to submit their creations relating to the content brokerage engine for consideration as a separate and distinct invention from the interactive communication system described herein. As shown in FIG. 31, it is clear that the there is a need for a novel content brokerage engine that satisfies the market's coming need for a web-based platform that enables the discrete encoding of sponsored content into primary content via outright purchase and/or bidding methods serving various distribution platforms, that relies on relevant and knowledgeable content providers (annotation) wishing to pair their offerings with relevant and knowledgeable content encoders.

It is also worth noting another reason why the market will soon embrace the notion of encoded sponsored content; namely significantly diminished tolerance for any and all forms of advertising where the audience member is forced to watch sponsored content, forced to affirmatively “skip” sponsored content, or affirmatively “opt-out” in order to avoid the sponsored content. In other words, there is a real possibility that “opt-in” models will soon be the guiding principle behind the delivery of sponsored content in conjunction with primary content. This being the case, any technique that allows audience members of audio and/or video content to experience the audio and/or video content without any notion that there is discretely encoded meta data (representing the sponsored content) will be welcome.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A system for performing a multi-stage interactive communication comprising:
(a) a web-based content brokerage engine for the commercial or strategic matching of live broadcast content or recorded content (both termed herein as content, whether being audio content and/or audio+video content) as provided by a content owner to:
(i) contextually relevant primary meta data as provided by a content encoder (such content encoder being either the content owner or a party not the content owner) and
(ii) operationally relevant identification, routing, logistical, and technical auxiliary meta data as provided by the interactive communication system operator of the web-based content brokerage engine,
where the purpose of such matching is to facilitate the subsequent encoding of both the primary meta data and auxiliary meta data (collectively, the meta data) within the content by an apparatus as described in clause (b) herein;
(b) a meta data encoding device (the meta data encoder) providing the means for discrete and secure encoding of such primary meta data and auxiliary meta data within the audio-band or video-band channel of the content (such meta data thereafter becoming encoded meta data) prior to the encoded content's ultimate distribution to its audio listening or video viewing audience, and to do so in a manner where:
(i) the content and its encoded meta data (collectively, the encoded content, digital encoded content, or analog encoded content as the case may be) may be delivered to audio listeners or video viewers by means of any one or more physical means (e.g. CD, DVD), electronic means (e.g. cable), optical means (e.g. fiber optic), and/or radio frequency distribution means (e.g. terrestrial broadcast) and
(ii) the encoded content may be received by and played back through any one or a combination of playback consoles (e.g. television receiver, television set, radio receiver, radio set, associated set-top box receiver, optical disk player, magnetic tape player, magnetic drive player, silicon based memory player, and/or analogous playback devices);
(c) a meta data decoding device (the meta data decoder) providing the means by which to decode encoded meta data from the encoded content as received by the playback console, such meta data decoder being capable of:
(i) physical attachment to, or integration within, the playback console,
(ii) detecting the encoded meta data within the encoded content,
(iii) decoding the meta data from the encoded content,
(iv) enhancing the decoded meta data with additional, related information (such decoded meta data and enhancements collectively termed herein as decoder data package),
(v) formatting and storing the decoder data package in a such a manner that it may be relayed to a target device (e.g. a short-range wireless enabled cellular telephone) via the short-range wireless transceiver attached thereto,
(vi) storing a java application (or analogous user interaction application), in whole or in part, in a such a manner that it may be relayed to a target device via the short-range wireless transceiver attached thereto, and
(vii) sending the decoder data package and/or java application to the short-range wireless transceiver attached thereto in the form of one or more decoder data packages;
(d) a short-range wireless transceiver capable of receiving one or more decoder data packages from the meta data decoder and thereafter relaying the same to any number of target devices in the vicinity operated by any number of users (each user also being an audience member), such short-range wireless transceiver being capable of:
(i) physical attachment to, or integration within, the meta data decoder (collectively, the meta data decoder and the short-range wireless transceiver being termed herein as the meta data bridge),
(ii) enhancing the decoder data packages with additional, related information (such decoder data packages and enhancements collectively termed herein as transceiver data packages),
(iii) formatting and storing each transceiver data package in a such a manner that it may be relayed to a target device,
(iv) storing a java application (or analogous user interaction application), in whole or in part, in a such a manner that it may be relayed to a target device,
(v) making itself visible to any number of target devices in the vicinity,
(vi) establishing permission to send data from itself to one or more target devices in the vicinity (such a target device thereafter becoming a permission granting target device),
(vii) establishing protocols by which to send data from itself to one or more permission granting target devices in the vicinity,
(viii) relaying the transceiver data package and/or java application to permission granting target devices in the form of one or more relayed data packages;
(e) a java application (or analogous user interaction application) capable of managing the receipt and processing of relayed data packages transmitted to the permission granting target device, such java application being capable of:
(i) being stored (in whole or in part) within the meta data decoder or short-range wireless transceiver so that a copy of it may be relayed by the short-range wireless transceiver to any number of permission granting target
(ii) managing the receipt and processing of relayed data packages onto the permission granting target device,
(iii) displaying the relevant portions of the relayed data packages in textual message form on the display of the permission granting target device so that the user of the permission granting target device is prompted to interact with the textual message as displayed by entering an appropriate user response via the keypad of the permission granting target device,
(iv) managing any subsequent modifications to such relayed data package pursuant to the user of the permission granting target device entering an appropriate user response via the keypad of the permission granting target device with such modification specifically altering the data contents of the primary meta data represented in the relayed data package, and resulting in the java application generating a textual message response containing this new information as well as other related information pertaining to the user and the particular interaction,
(v) utilizing the appropriate data transport functionality (DTF) of the permission granting target device (e.g. SMS/short message service or IM/Instant messaging) so that a particular textual message response may be forwarded from the permission granting target device to a designated back-end services database for further audit, analysis, storage, and/or response to the user if need be, as well as any forwarding of data relating to the textual message response to the content owner and/or content encoder, and/or any further permissible action to be undertaken by the interactive communication system operator; and
(f) a back-end services database providing the means by which any keypad generated textual message response sent via a permission granting target device's data transport functionality to a designated back-end services database address will be efficiently, securely, and accurately audited, analyzed, and stored upon receipt thereof, such back-end services database being capable of:
(i) generating and sending a further response to the sender of the textual message response where appropriate,
(ii) forwarding data relating to any textual message response to an appropriate content owner and/or content encoder,
(iii) sharing the data relating to any textual message response with the database systems associated with the content brokerage engine, and
(iv) distributing to third parties data relating to any textual message response in a manner deemed permissible by the interactive communication system operator;
and to do so as to satisfy the expectations of the user of the permission granting target device, as well as the expectations of any content owners and content encoders who have effected the embedding of meta data within such content.

2. A system according to claim 1 wherein the web-based content brokerage engine is comprised of an integrated suite of online systems and applications, including but not limited to an HTTP server, database management system (DBMS being navigational, hierarchical, network, relational, or object-oriented), transaction engine, indexer, payment processor, and notification server, which is capable of accessing and utilizing the meta data encoder referenced in claim 1(b) above, and is further capable of:
(a) allowing a content owner to access a web interface so that they may upload a copy of their Recorded content to the web-based content brokerage engine;
(b) allowing a content owner to access a web interface so that they may segment (divide into time denoted parcels) their recorded content as uploaded to the web-based content brokerage engine;
(c) allowing a content owner to access a web interface so that they may annotate their Recorded content segments as uploaded to the web-based content brokerage engine with such annotations (content tag annotations, or CTA) taking the form of descriptive tags, demographic tags, or analogous;
(d) allowing a content owner to access a web interface so that they may specify the manner in which they will allow content encoders to encode meta data into their Recorded content segments as uploaded to the web-based content brokerage engine, with such specifications setting forth pricing terms, payment delivery terms, and/or other analogous terms;
(e) allowing a content encoder to access a web interface so that they may search and review uploaded and annotated Recorded content segments residing on such a web-based content brokerage engine;
(f) allowing a content encoder to access a web interface so that they may select a particular uploaded Recorded content segment residing on such a web-based content brokerage engine;
(g) allowing a content encoder to access a web interface so that they may effect an on-line purchase from the content owner of the selected content segment the right to embed their primary meta data within that particular Recorded content segment prior to that Recorded content segment's ultimate distribution to its audio listening or video viewing audience;
(h) allowing a content encoder to access a web interface so that they may upload their primary meta data to such a web-based content brokerage engine and do so by utilizing an assortment of dynamic input fields in the form of templates, radio buttons, text insertion fields, scroll down menus, and/or other analogous web-based data submission tools, and do so for the purpose of having such primary meta data encoded into the Recorded content segment referred to in clause (g) herein;
(i) allowing a content encoder to access a web interface so that they may instruct the interactive communication system operator as to where to forward any textual message response data as generated by any user who has interacted with the textual message as delivered to the user's permission granting target device while listening to or viewing the Recorded content segment referred to in clause (g) herein;
(j) allowing the interactive communication system operator of the web-based content brokerage engine the ability to directly load relevant auxiliary meta data to such a web-based content brokerage engine and do so by utilizing an assortment of dynamic input fields in the form of templates, radio buttons, text insertion fields, scroll down menus, and/or other analogous data submission tools, and do so for the purpose of having such auxiliary meta data encoded into the Recorded content segment referred to in clause (g) herein;
(k) allowing the web-based content brokerage engine to serve the uploaded Recorded content segment, primary meta data, and auxiliary meta data to the meta data encoder referenced in claim 1(b) above with further instructions for the meta data encoder to encode the primary meta data and auxiliary meta data into the Recorded content segment;
(l) allowing the meta data encoder referenced in claim 1(b) above to deliver one copy of the Recorded content segment and its encoded meta data to the web-based content brokerage engine for storage by the interactive communication system operator and delivery of the same to a networked location of the content owner's choosing and, if so permitted by the content owner, to a networked location of the content encoder's choosing; and
(m) allowing the meta data encoder referenced in claim 1(b) above to deliver a second copy of the Recorded content segment and its encoded meta data to the interactive communication system operator's back-end services database to facilitate the functions set forth in claim 1(f) above.

3. A system according to claim 1 wherein the web-based content brokerage engine is comprised of an integrated suite of online systems and applications, including but not limited to an HTTP server, database management system (DBMS being navigational, hierarchical, network, relational, or object-oriented), transaction engine, indexer, payment processor, and notification server, which is capable of accessing and utilizing the meta data encoder referenced in claim 1(b) above, and is further capable of:
(a) allowing a content owner to access a web interface so that they may upload a schedule of their anticipated live broadcast content to the web-based content brokerage engine;
(b) allowing a content owner to access a web interface so that they may segment (divide into time denoted parcels) the schedule of their anticipated live broadcast content as uploaded to the web-based content brokerage engine;
(c) allowing a content owner to access a web interface so that they may annotate the schedules of their anticipated live broadcast content segments as uploaded to the web-based content brokerage engine with such annotations (content tag annotations, or CTA) taking the form of descriptive tags, demographic tags, or analogous;
(d) allowing a content owner to access a web interface so that they may specify the manner in which they will allow content encoders to encode meta data into the schedules of their anticipated live broadcast content segments as uploaded to the web-based content brokerage engine, with such specifications setting forth pricing terms, payment delivery terms, and/or other analogous terms;
(e) allowing a content encoder to access a web interface so that they may search and review uploaded and annotated schedules of the anticipated live broadcast content segments residing on such a web-based content brokerage engine;
(f) allowing a content encoder to access a web interface so that they may select a particular uploaded schedule of an anticipated live broadcast content segment residing on such a web-based content brokerage engine;
(g) allowing a content encoder to access a web interface so that they may effect an on-line purchase from the content owner of the selected content segment the right to embed their primary meta data within that particular schedule of the anticipated live broadcast content segment prior to that live broadcast content segment's ultimate distribution to its audio listening or video viewing audience;
(h) allowing a content encoder to access a web interface so that they may upload their primary meta data to such a web-based content brokerage engine and do so by utilizing an assortment of dynamic input fields in the form of templates, radio buttons, text insertion fields, scroll down menus, and/or other analogous web-based data submission tools, and do so for the purpose of having such primary meta data encoded into the schedule of an anticipated live broadcast content segment referred to in clause (g) herein;
(i) allowing a content encoder to access a web interface so that they may instruct the interactive communication system operator as to where to forward any textual message response data as generated by any user who has interacted with the textual message as delivered to the user's permission granting target device while listening to or viewing the live broadcast content segment referred to in clause (g) herein;
(j) allowing the interactive communication system operator of the web-based content brokerage engine the ability to directly load relevant auxiliary meta data to such a web-based content brokerage engine and do so by utilizing an assortment of dynamic input fields in the form of templates, radio buttons, text insertion fields, scroll down menus, and/or other analogous data submission tools, and do so for the purpose of having such auxiliary meta data encoded into the schedule of an anticipated live broadcast content segment referred to in clause (g) herein;
(k) allowing the web-based content brokerage engine to serve the uploaded schedule of an anticipated live broadcast content segment, primary meta data, and auxiliary meta data to the meta data encoder referenced in claim 1(b) above with further instructions for the meta data encoder to encode the primary meta data and auxiliary meta data into the schedule of the anticipated live broadcast content segment;
(l) allowing the meta data encoder referenced in claim 1(b) above to deliver one copy of the schedule of an anticipated live broadcast content segment and its encoded meta data to the web-based content brokerage engine for storage by the interactive communication system operator and delivery of the same to a networked location of the content owner's choosing and, if so permitted by the content owner, to a networked location of the content encoder's choosing; and
(m) allowing the meta data encoder referenced in claim 1(b) above to deliver a second copy of the schedule of an anticipated live broadcast content segment and its encoded meta data to the interactive communication system operator's back-end services database to facilitate the functions set forth in claim 1(f) above.

4. A system according to claim 3 wherein the web-based content brokerage engine allows the content encoder to access a web interface where the content encoder must first engage in a bidding process against other prospective content encoders for the right to purchase from the content owner the right to embed their primary meta data within that particular content segment (Recorded or live broadcast) where the highest bidding content encoder agrees to pay to the content owner up to the value of their highest bid submitted and where the auction process formats are consistent with any one of the following generally accepted auction models:
(a) English Auction;
(b) Dutch Auction;
(c) Absolute Auction, also known as a No-Reserve Auction or Auction Without Reserve;
(d) Sealed First-Price Auction, also known as Sealed High-Bid Auction or First-Price Sealed-Bid Auction;
(e) Sealed Second-Price Auction, also known as a Vickrey Auction;
(f) Reverse Auction or Procurement Auction;
(g) digital Art Auction;
(h) Unique Bid Auction;
(i) Buy-Out Auction;
(j) Combinatorial Auction; or
(k) any analogous or combined auction format drawing from one or more of the auction types listed in this claim 4(a)-(j).

5. A system according to claim 3 wherein the web-based content brokerage engine allows the content owner to access a web interface where the content owner may categorically label their content once it has been uploaded to the web-based content brokerage engine (and do such labeling by utilizing an assortment of dynamic input fields in the form of templates, radio buttons, text insertion fields, scroll down menus, and/or other analogous web-based data submission tools), with such categorical labels producing a set of content tag annotations (CTA) whose information encompasses any one or more of the following descriptive fields:
(a) applicable titles, summaries, or abstracts associated with the content;
(b) applicable subject matter of the content (comedy, drama, music, mystery, horror, sci-fi, documentary, news, educational, public service, home shopping, sport, gaming, gambling, travel, politics, and/or analogous);
(c) applicable production details relating to the content (date of creation, place of creation, language, creation medium, performing artists, script or lyric writers, production crew, direction crews, and/or analogous);
(d) applicable targeted audience demographics of the content (race, sex, sexual orientation, religion, age, geographic location, level of education, political orientation, profession, income bracket, and/or analogous);
(e) applicable storage mediums intended for the content (DVD, CD, VHS Tape, celluloid tape, silicon-based memory, magnetic memory drive, and/or analogous);
(f) applicable delivery mediums intended for the content (television broadcast, radio broadcast, Internet broadcast, physical delivery of recorded medium, public venues, events, and/or analogous);
(g) applicable broadcast standards intended for the content (PAL, NTSC, SECAM, ISDB, ATSC, DVB, DVM, DAB, and/or analogous);
(h) applicable delivery markets intended for the content (geographic regions, times, dates, and/or analogous); and
(i) applicable methods for purchasing the right to embed primary meta data into the content (fixed-price, performance-based, auction type, and/or analogous).

6. A system according to claim 3 wherein the web-based content brokerage engine allows the content encoder to access a web interface where the content encoder may search the web-based content brokerage engine for uploaded content by its categorical content tag annotations prior to taking further steps to encode its own primary meta data into the same, with such categorical content tag annotation search capabilities encompassing any one or more of the following descriptive fields:
(a) applicable titles, summaries, or abstracts associated with the content;
(b) applicable subject matter of the content (comedy, drama, music, mystery, horror, sci-fi, documentary, news, educational, public service, home shopping, sport, gaming, gambling, travel, politics, and/or analogous);
(c) applicable production details relating to the content (date of creation, place of creation, language, creation medium, performing artists, script or lyric writers, production crew, direction crews, and/or analogous);
(d) applicable targeted audience demographics of the content (race, sex, sexual orientation, religion, age, geographic location, level of education, political orientation, profession, income bracket, and/or analogous);
(e) applicable storage mediums intended for the content (DVD, CD, VHS Tape, celluloid tape, silicon-based memory, magnetic memory drive, and/or analogous);
(f) applicable delivery mediums intended for the content (television broadcast, radio broadcast, Internet broadcast, physical delivery of recorded medium, public venues, events, and/or analogous);
(g) applicable broadcast standards intended for the content (PAL, NTSC, SECAM, ISDB, ATSC, DVB, DVM, DAB, and/or analogous);
(h) applicable delivery markets intended for the content (geographic regions, times, dates, and/or analogous); and
(i) applicable methods for purchasing the right to embed primary meta data into the content (fixed-price, performance-based, highest bid, and/or analogous).

7. A system according to claim 1 wherein the java application resident within the meta data decoder or short-range wireless transceiver is capable of being remotely updated by the interactive communication system operator through the delivery of an updated java application to either the meta data decoder or the short-range wireless transceiver as the case may be, with such updated java application having been extracted and processed by the meta data decoder from either:
(a) auxiliary meta data embedded within encoded content so received by the meta data decoder as attached to a participating playback console or
(b) a wired (e.g. USB) or wireless connection (e.g. Bluetooth) made to the meta data decoder from an external device capable of delivering the updated java application.

8. A system according to claim 1 wherein the java application resident within the permission granting target device is capable of being remotely updated by the interactive communication system operator through the delivery of an updated java application to the permission granting target device, with such updated java application coming from either:
(a) the meta data decoder or short-range wireless transceiver having received such updated java application or
(b) as an embedded application delivered to the target device via the data transport functionality of the target device's wireless network (e.g. GSM, GPRS, CDMA, UMTS, TDMA, or analogous cellular network).

9. A system according to claim 1 wherein the java application as loaded onto the permission granting target device is capable of automatically deleting each textual message as displayed on the permission granting target device upon the happening of either:
(a) a set period of time passing from the moment such textual message as displayed initially appears, with the length of such time period being designated in advance by either:
(i) the auxiliary meta data as provided by the interactive communication system operator on its own behalf or on behalf of the content owner or
(ii) the primary meta data provided by the content encoder;
(b) the user of the permission granting target device having responded to the textual message as displayed, such user interaction evidenced by their entering an appropriate user response via the keypad of the permission granting target device;
(c) the user of the permission granting target device having not responded to the textual message as displayed, and a subsequent textual message is received on the permission granting target device and is displayed in place of the previous textual message; or
(d) the user of the permission granting target device having effected a cancellation of the textual message as displayed by entering an appropriate command via the keypad of the permission granting target device.

10. A system according to claim 1 wherein the java application as loaded onto the permission granting target device may facilitate any initial or subsequent “opt-in” processes required of the user of the permission granting target device prior to the permission granting target device accepting incoming data from the short-range wireless transceiver.

11. A system according to claim 1 wherein the java application as loaded onto the permission granting target device is capable of providing to the user of the permission granting target device a series of interrelated textual messages taking the form of an initial textual message paired with multiple user response choices, with subsequent derivative textual message data being presented to the user depending upon the user response given to the initial textual message.

12. A system according to claim 11 wherein the java application as loaded onto the permission granting target device provides only a portion of the data associated with the interrelated textual messages, but at a minimum provides the initial textual message paired with multiple user response choices, with subsequent derivative textual messages data being generated from:
(a) additional follow-on relayed data packages received from the short-range wireless transceiver;
(b) an embedded application instructing the permission granting target device to seek out follow-on textual message data utilizing the target device wireless network data transport functionality; or
(c) from a combination of sources set forth in both clauses (a) and (b) herein.

13. A system according to claim 1 wherein the java application, in conjunction with the primary meta data and the auxiliary meta data, is capable of initiating a series of interactive communication activities with the user of the permission granting target device relating to any one or more of:
(a) monetary game playing (games of skill);
(b) monetary game playing (games of chance);
(c) monetary game playing (games of both skill and chance);
(d) lotteries;
(e) contests;
(f) advertisements;
(g) promotions;
(h) public service messaging;
(i) remote learning;
(j) entertainment;
(k) event voting;
(l) opinion polling;
(m) financial services transactions;
(n) transactions relating to the commercial bidding on goods;
(o) transactions relating to the commercial bidding on services;
(p) transactions relating to the fixed price sale of goods;
(q) transactions relating to the fixed price sale of services;
(r) the submission of any one or more of the user's name, phone number, location, or similar identifying information to a content owner, content encoder, or combination thereof; or
(s) any other analogous task consistent with the operation and objectives of the current invention.

14. A system according to claim 13 wherein the java application, in conjunction with the primary meta data, the auxiliary meta data, and the back-end services database is only capable of executing and completing the series of interactive communication activities where:
(a) each textual message response provided by the permission granting target device is generated by a user who possesses the requisite functional, financial, and legal status and is capable of doing so within the jurisdiction applicable to the location of the permission granting target device at the time of such communication interaction and
(b) the back-end services database platform can confirm the appropriate status and capability of the user set forth in clause (a) herein by examining all data provided to it over the course of the interactive communication process, including, but not limited to data provided by the textual message response sent via the target device wireless network's data transport functionality, data provided by the permission granting target device's native hardware and software system, native data provided by the target device network operator, and any other sources of information reasonably accessible to the back-end services database whether relating to the user's age, citizenship, physical location, financial status, billing address, profession, or otherwise.

15. A system according to claim 1 wherein any textual message response instructs the back-end services database to initiate one or more of a series of communications that do not utilize the data transport functionality (e.g. short message service) of the permission granting target device, but instead initiate one or more of the following communications involving the user:
(a) a voice call by a live or automated operator to the user;
(b) a voice call by the user to a live or automated operator;
(c) a fax by a live or automated operator to the user;
(d) an e-mail message to the user's separate e-mail account;
(e) a physical mail delivery to the user's home or business address; or
(f) any analogous communication not utilizing the permission granting target device's data transport functionality.

16. A system according to claim 1 wherein a textual message response instructs the back-end services database to schedule the sending of a reminder notice via an applicable data transport functionality (e.g. short message service) to the permission granting target device at a later time or date, with such reminder asking the user if they wish to engage in any one or more interactive communications at that later time or date.

17. A system according to claim 1 wherein the java application resident within the permission granting target device is capable of simultaneously initiating and completing a particular task between the user of the permission granting target device and a content owner, a content encoder, a related third-party, or combination thereof (doing so in conjunction with the back-end services database), and specifically effecting the initiation and completion of such task with only a single keypad entry (“one-click” interaction) constituting a user response and thereby generating and sending a textual message response to the back-end services database, and whether such initiation and completion of such task relates to:
(a) monetary game playing (games of skill);
(b) monetary game playing (games of chance);
(c) monetary game playing (games of both skill and chance);
(d) lotteries;
(e) contests;
(f) advertisements;
(g) promotions;
(h) public service messaging;
(i) remote learning;
(j) entertainment;
(k) event voting;
(l) opinion polling;
(m) financial services transactions;
(n) transactions relating to the commercial bidding on goods;
(o) transactions relating to the commercial bidding on services;
(p) transactions relating to the fixed price sale of goods;
(q) transactions relating to the fixed price sale of services;
(r) the submission of any one or more of the user's name, phone number, location, or similar identifying information to a content owner, content encoder, or combination thereof; or
(s) any other analogous task consistent with the operation and objectives of the current invention.

18. A system according to claim 1 wherein the java application resident within the permission granting target device is capable of making the permission granting target device emit an alerting noise and/or vibration when a textual message is being, or is ready to be, displayed on the display of the permission granting target device, such textual message having been received from the short-range wireless transceiver and such alerting noise and/or vibration prompting the user to review the textual message as displayed.

19. A system according to claim 1 wherein the web-based content brokerage engine allows for the encoding of primary meta data specifying time expiry limits which effect cancellation, in whole or in part, of the functionality of the primary meta data at any one or more pre-determined future points in time as specified by the content encoder at the time such content is encoded, with such cancellation of functionality being established in anticipation of the content and its encoded meta data surviving past its initial distribution date due to its potential for being stored within a recordable medium, and where such cancellation of functionality is effected by any combined operation of the:
(a) Meta data decoder;
(b) short-range wireless transceiver;
(c) java application resident on the permission granting target device; or
(d) Back-end services database functionality.

20. A system according to claim 1 wherein the web-based content brokerage engine allows for the encoding of auxiliary meta data specifying time expiry limits which effects cancellation, in whole or in part, of the functionality of the primary meta data at any one or more pre-determined future points in time as specified by the content owner or the interactive communication system operator at the time such content is encoded, with such cancellation of functionality being established in anticipation of the content and its encoded meta data surviving past its initial distribution date due to its potential for being stored within a recordable medium, and where such cancellation of functionality is effected by any combined operation of the:
(a) Meta data decoder;
(b) short-range wireless transceiver;
(c) java application resident on the permission granting target device;
(d) target device's wireless network operator; or
(e) Back-end services database functionality.

21. A system according to claim 20 wherein the whole or partial cancellation of functionality may be effected before the textual message is displayed, or before the user is notified that such textual message is to be displayed, on the permission granting target device when the time expiry limits as specified in the primary meta data or auxiliary meta data calls for the cancellation of functionality to be effected by either the:
(a) Meta data decoder;
(b) short-range wireless transceiver; or
(c) java application resident on the permission granting target device.

22. A system according to claim 1 wherein the web-based content brokerage engine allows for the encoding of primary meta data specifying user age limits which effect cancellation, in whole or in part, of the functionality of the primary meta data if the functionality of the target device and/or java application resident therein has data confirming that the user of the target device is not of a sufficient age to view the contents of the meta data as provided by the content encoder at the time such content is encoded, and where such cancellation of functionality is effected by any combined operation of the:
(a) Meta data decoder;
(b) short-range wireless transceiver;
(c) java application resident on the permission granting target device; or
(d) Back-end services database functionality.

23. A system according to claim 1 wherein the web-based content brokerage engine allows for the encoding of auxiliary meta data specifying user age limits which effect cancellation, in whole or in part, of the functionality of the primary meta data if the functionality of the target device and/or java application resident therein has data confirming that the user of the target device is not of a sufficient age to view the contents of the meta data as provided by the content encoder at the time such content is encoded, and where such cancellation of functionality is effected by any combined operation of the:
(a) Meta data decoder;
(b) short-range wireless transceiver;
(c) java application resident on the permission granting target device; or
(d) Back-end services database functionality.

24. A system according to claim 23 wherein the whole or partial cancellation of functionality may be effected before the textual message is displayed, or before the user is notified that such textual message is to be displayed, on the permission granting target device when the user age limits as specified in the primary meta data or auxiliary meta data calls for the cancellation of functionality to be effected by either the:
(a) Meta data decoder;
(b) short-range wireless transceiver; or
(c) java application resident on the permission granting target device.

25. A system according to claim 1 wherein the web-based content brokerage engine allows for the encoding of primary meta data specifying location limits which effect cancellation, in whole or in part, of the functionality of the primary meta data if the functionality of the target device and/or java application resident therein has data confirming that the user of the target device is not located within a permissive jurisdiction to view the contents of the meta data as provided by the content encoder at the time such content is encoded, and where such cancellation of functionality is effected by any combined operation of the:
(a) Meta data decoder;
(b) short-range wireless transceiver;
(c) java application resident on the permission granting target device;
(d) target device's wireless network operator; or
(e) Back-end services database functionality.

26. A system according to claim 1 wherein the web-based content brokerage engine allows for the encoding of auxiliary meta data specifying user age limits which effect cancellation, in whole or in part, of the functionality of the primary meta data if the functionality of the target device and/or java application resident therein has data confirming that the user of the target device is not located within a permissive jurisdiction to view the contents of the meta data as provided by the content encoder at the time such content is encoded, and where such cancellation of functionality is effected by any combined operation of the:
(a) Meta data decoder;
(b) short-range wireless transceiver;
(c) java application resident on the permission granting target device; or
(d) Back-end services database functionality.

27. A system according to claim 26 wherein the whole or partial cancellation of functionality may be effected before the textual message is displayed, or before the user is notified that such textual message is to be displayed, on the permission granting target device when the location limits as specified in the primary meta data or auxiliary meta data calls for the cancellation of functionality to be effected by either the:
(a) Meta data decoder;
(b) short-range wireless transceiver; or
(c) java application resident on the permission granting target device.

28. A system according to claim 1 wherein each meta data decoder possesses its own unique identification code, termed herein as the meta data decoder ID code (or more generically the meta data bridge ID code), so that any decoder data package sent from the meta data decoder will be imbued with the relevant meta data decoder ID code and recognized by the short-range wireless transceiver, the permission granting target device, and/or any designated back-end services database as having been decoded by that specific meta data decoder, with the purpose of such specific identification being for the determination of which meta data decoder is used in any given interactive communication activity so that the interactive communication system operator may collect this meta data decoder ID code data so as to:
(a) make scientific studies on the nature and flow of information through the interactive communication system;
(b) make commercial studies on the nature and flow of information through the interactive communication system; and/or
(c) effect various revenue share arrangements based upon the flow of information through the interactive communication system between participating content owners, content encoders, third parties, and parties responsible for the physical deployment of the meta data decoders throughout the market.

29. A system according to claim 1 wherein each short-range wireless transceiver possesses its own unique identification code, termed herein as the short-range wireless transceiver ID code (or more generically the meta data bridge ID code), so that any relayed data package sent from the short-range wireless transceiver will be imbued with the relevant short-range wireless transceiver ID code and recognized by the permission granting target device and/or any designated back-end services database as having been transmitted by that specific short-range wireless transceiver, with the purpose of such specific identification being for the determination of which short-range wireless transceiver is used in any given interactive communication activity so that the interactive communication system operator may collect this short-range wireless transceiver ID code data so as to:
(a) make scientific studies on the nature and flow of information through the interactive communication system;
(b) make commercial studies on the nature and flow of information through the interactive communication system; and/or
(c) effect various revenue share arrangements based upon the flow of information through the interactive communication system between participating content owners, content encoders, third parties, and parties responsible for the physical deployment of the short-range wireless transceivers throughout the market.

30. A system according to claim 1 wherein each java application possesses its own unique identification code, termed herein the java application ID code, so that any decoded meta data converted into data transport functionality (DTF) data (SMS data, IM data, or analogous) by the java application will be imbued with such unique identification data and recognized by any designated back-end services database as having been processed by that specific java application, with the purpose of such specific identification being for the determination of which java application is used in any given interactive communication activity so that the interactive communication system operator may:
(a) make scientific studies on the nature and flow of information through the interactive communication system;
(b) make commercial studies on the nature and flow of information through the interactive communication system; and/or
(c) effect various revenue share arrangements based upon the flow of information through the interactive communication system between participating content owners, content encoders, third parties, and parties responsible for the physical deployment of the java application throughout the market.

31. A system according to claim 1 wherein the interactive communication system operator embeds within each meta data decoder a pre-defined corroboration reply address, as well as an instruction to the java application resident on a user's permission granting target device to forward certain data elements relating to any textual message response (herein the corroboration reply data) to that corroboration reply address at the time a textual message response is generated by such a user. The corroboration reply address is linked to a portion of the back-end services database that is charged with the collection of corroborating data elements associated with a standard textual message response, save that the corroboration reply address and its associated incoming corroboration reply data are distinct from the actual textual message response delivered to the back-end services database address specified in the auxiliary meta data. This system of collecting corroborating data elements via delivery to a corroboration reply address is specifically capable of:
(a) confirming whether authorized content, authorized encoded primary meta data, and authorized encoded auxiliary meta data are being sent through the interactive communication system as disclosed to the interactive communication system operator by the content owner and/or content encoders during their use of the web-based content brokerage engine;
(b) detecting instances where unauthorized content, unauthorized encoded primary meta data, or unauthorized encoded auxiliary meta data are being sent through the interactive communication system; and
(c) determining which parties are facilitating the creation and distribution of unauthorized content, unauthorized encoded primary meta data, or unauthorized encoded auxiliary meta data within the interactive communication system.

32. A system according to claim 1 wherein the interactive communication system operator embeds within each short-range wireless transceiver a pre-defined corroboration reply address, as well as an instruction to the java application resident on a user's permission granting target device to forward certain data elements relating to any textual message response (herein the corroboration reply data) to that corroboration reply address at the time a textual message response is generated by such a user. The corroboration reply address is linked to a portion of the back-end services database that is charged with the collection of corroborating data elements associated with a standard textual message response, save that the corroboration reply address and its associated incoming corroboration reply data are distinct from the actual textual message response delivered to the back-end services database address specified in the auxiliary meta data. This system of collecting corroborating data elements via delivery to a corroboration reply address is specifically capable of:
(a) confirming whether authorized content, authorized encoded primary meta data, and authorized encoded auxiliary meta data are being sent through the interactive communication system as disclosed to the interactive communication system operator by the content owner and/or content encoders during their use of the web-based content brokerage engine;
(b) detecting instances where unauthorized content, unauthorized encoded primary meta data, or unauthorized encoded auxiliary meta data are being sent through the interactive communication system; and
(c) determining which parties are facilitating the creation and distribution of unauthorized content, unauthorized encoded primary meta data, or unauthorized encoded auxiliary meta data within the interactive communication system.

33. A system according to claim 1 wherein the interactive communication system operator embeds within each java application a pre-defined corroboration reply address, as well as an instruction for the java application to forward certain data elements relating to any textual message response (herein the corroboration reply data) to that corroboration reply address at the time a textual message response is generated by such a user. The corroboration reply address is linked to a portion of the back-end services database that is charged with the collection of corroborating data elements associated with a standard textual message response, save that the corroboration reply address and its associated incoming corroboration reply data are distinct from the actual textual message response delivered to the back-end services database address specified in the auxiliary meta data. This system of collecting corroborating data elements via delivery to a corroboration reply address is specifically capable of:
(a) confirming whether authorized content, authorized encoded primary meta data, and authorized encoded auxiliary meta data are being sent through the interactive communication system as disclosed to the interactive communication system operator by the content owner and/or content encoders during their use of the web-based content brokerage engine;
(b) detecting instances where unauthorized content, unauthorized encoded primary meta data, or unauthorized encoded auxiliary meta data are being sent through the interactive communication system; and
(c) determining which parties are facilitating the creation and distribution of unauthorized content, unauthorized encoded primary meta data, or unauthorized encoded auxiliary meta data within the interactive communication system.

34. A system according to claims 32 wherein the corroboration reply address and any associated instructions on the delivering of its associated incoming corroboration reply data may be:
(a) hard-coded or soft-coded within either the meta data decoder or short-range wireless transceiver prior to such devices being attached to or integrated within any playback console and
(b) where feasible, remotely updated by the interactive communication system operator through the delivery of an updated Corroboration reply Instruction to either the meta data decoder or the short-range wireless transceiver utilizing the data delivery methods available to the interactive communication system as set forth above.

35. A system according to claim 33 wherein the corroboration reply address and any associated instructions on the delivering of its associated incoming corroboration reply data may be:
(a) soft-coded within the java application prior to the java application being loaded onto a permission granting target devices for the first time as set forth above,
(b) remotely updated by the interactive communication system operator through the delivery of an java application instruction set (new data to be used by the java application, but not to replace the java application) utilizing the data delivery methods available to the interactive communication system as set forth above; and
(c) remotely updated by the interactive communication system operator through the delivery of an updated java application utilizing the java application update methods available to the interactive communication system as set forth above.

36. A system according to claims 33 wherein the instructions relating to the delivering of corroboration reply data may specify a delivery of the corroboration reply data to the corroboration reply address:
(a) every time a textual message response is sent from a user's permission granting target device or
(b) at a frequency less than every time a textual message response is sent from a user's permission granting target device (e.g. one corroboration reply data sent per every one hundred textual message responses generated on a particular permission granting Cellular Phone.

37. A system according to claim 1 wherein any one or more of the data sets created, transported, and received by sanctioned systems and devices present throughout the interactive communication system have been further encrypted using a set of encrypted keys as specified by the interactive communication system operator and/or their affiliates.

38. A system according to claim 1 wherein the content brokerage engine generates any one or more of a content provider ID code, content segment tracking ID code, content encoder ID code, and/or an encoded segment tracking ID code relating to each instance where a content segment (or schedule thereof) is to be paired with a content encoder's primary meta data, and where any one or more of these ID codes are encoded into the relevant content segment (or schedule thereof) as auxiliary meta data by the meta data encoder, with such encoded ID codes being specifically capable of:
(a) being subsequently delivered to the back-end services database as part of a textual message response and
(b) being analyzed in conjunction with other data associated by the textual message response received by the Back-End Services, as well as in conjunction with any data available from the content brokerage engine, thereby assembling content performance data relating to the content being listened to or viewed by a user, such performance data including, but not limited to information relating to the time and place of such listening or viewing, and the user's level and type of interaction with such content.

39. A system according to claim 1 where the meta data decoder and short-range wireless transceiver are jointly housed within an external package (as an externally hosted adaptor) with the means to plug directly into an electrical wall socket (or analogous power source) and not relying upon an electrical cord to connect the external package to the electrical wall socket (or analogous power source), with the physical data connection to the playback console being effected by a data cord emanating from the external package, with the cord's tip being fitted with the appropriate playback console data transfer interface, whether such data transfer interface is configured for connection to SCART, RCA, S-video, USB, FireWire (i-Link), HDMI, Memory Stick Slot, and/or analogous coupling form factor.

40. A system according to claim 1 where the meta data decoder and short-range wireless transceiver are jointly housed within an external package (as an externally hosted adaptor) with the means to plug directly into the appropriate playback console data transfer interface, whether such connector is configured for connection to SCART, RCA, S-video, USB, FireWire (i-Link), HDMI, Memory Stick Slot, and/or analogous coupling form factor, and where the external package draws power from an electrical cord emanating from the external package which is capable of being plugged into an electrical wall socket (or analogous power source).

41. A system according to claim 1 where the meta data decoder and short-range wireless transceiver are jointly housed within an external package (as an externally hosted adaptor) with the means to plug directly into the appropriate playback console data transfer interface, whether such connector is configured for connection to SCART, RCA, S-video, USB, FireWire (i-Link), HDMI, Memory Slot, and/or analogous coupling form factor, and where the external package draws electrical power from one or more of the of the data transfer pin(s) associated with the data transfer interface, or from a secondary set of data transfer pins, plugs, jacks, sockets, or analogous connection embodiments as might be available on the playback console and accessible by the externally hosted adaptor.

42. A system according to claims 40 where the externally hosted adaptor draws its power from a power cord supplied by the audience member, such being the power cord that the audience member uses for charging their own target devices, and where the externally hosted adaptor possesses a series of differing power plug sockets configured to handle the most popular power plug formats used for charging target devices.

43. A system according to claims 42 where the externally hosted adaptor also serves as a splitter (designed to be interposed between the male and female elements) for an additional wall plug socket, appropriate data transfer interface, or both, so as to allow the playback console and its operating environment no loss of data transfer ports or power source plug sockets as a result of using the externally hosted adaptor.

44. A system according to claim 1 where the meta data decoder and short-range wireless transceiver are jointly integrated within the playback console and draw both the encoded content signals and requisite electrical power from internalized connections established within the playback console.

45. A system according to claim 1 where the back-end services database utilizes a suite of hardware and software tools capable of receiving and storing information about a user, including but not limited to, aggregated information relating to the user's name, age, location, phone number, target device type, target device's wireless network operator, content viewing history, textual message response history, and analogous data types as generated at various stages of the interactive communication process, with such functionality allowing the back-end services database to serve bespoke messages back to the user (whether via short message service, voice, fax, e-mail, mail, or otherwise) in response to receiving any one or more textual message responses from the user.

46. A system according to claim 1 where the functional aspects of a playback console, as well as the meta data decoder and java application, are all physically integrated within a target device (e.g. DVB-H cellular phone) in such a manner that there is no need to transport to the cellular phone the java application, relayed data package (including auxiliary meta data and primary meta data) via a short-range wireless transceiver.

47. A system according to claim 1 wherein the meta data encoder is capable of encoding data within the audio-band or video-band channel that is resistant to tampering or scrubbing by third parties by virtue of its use of a proprietary audio-band or video-band encoding algorithm and technique.

48. A system according to claim 1 wherein the meta data decoder is capable of decoding data from encoded content by virtue of its use of a proprietary audio-band or video-band decoding algorithm and technique.

49. A system according to claim 1 wherein the short-range wireless transceiver is capable of maintaining its communication link to a permission granting target device more securely than traditional short-range wireless communication transceivers by virtue of the short-range wireless transceiver's predominantly “one way” transmission features effected subsequent to the short-range wireless transceiver establishing a communication link to a permission granting target device.

50. A system according to claim 1 wherein the short-range wireless transceiver is capable of maintaining its communication link to more permission granting target devices at any given time and do so more securely than comparable implementations of short-range wireless communication transceivers by virtue of the short-range wireless transceiver's predominantly “one way” transmission features effected subsequent to the short-range wireless transceiver establishing a communication link to a permission granting target device.

51. A system according to claim 1 wherein the short-range wireless transceiver is capable of concurrently sending relayed data packages to more permission granting target devices at any given time and do so more securely than comparable implementations of short-range wireless communication transceivers by virtue of the short-range wireless transceiver's predominantly “one way” transmission features effected subsequent to the short-range wireless transceiver establishing a communication link to a permission granting target device.

52. A system according to claim 1 wherein the short-range wireless transceiver is capable of maintaining its communication link to a permission granting target device using fewer hardware-based and soft-ware-based computational resources than traditional short-range wireless communication transceivers by virtue of the short-range wireless transceiver's predominantly “one way” transmission features effected subsequent to the short-range wireless transceiver establishing a communication link to a permission granting target device.

53. A system according to claim 1 wherein the java application is capable of being run on a greater variety of target devices as compared to other similar java applications due its modest relative size and reduced relative operating requirements by virtue of it having to manage only predominantly “one way” transmission features effected subsequent to the short-range wireless transceiver establishing a communication link to a permission granting target device.

54. A system according to claim 1 where the meta data encoder will utilize a meta data content encoding protocol that will be specific enough to be precisely recognized by any associated meta data decoder, where such recognition will also be to the exclusion of any other encoding protocols encountered by the meta data decoder put into the market by parties not sanctioned by the interactive communication system operator.

55. A system applicable to all aspects of web-based pairing of interactive meta data to any type of audio and/or video content, being comprised of an integrated suite of online systems and applications, including but not limited to an HTTP server, a database management system (e.g. relational), transaction engine, indexer, payment processor, and notification server, which is capable of accessing and utilizing any one or more meta data encoding devices, and is further capable of:
(a) allowing any owner of content to access a web interface so that they may upload to a web-based platform a copy of their recorded content;
(b) allowing any owner of content to access a web interface so that they may segment (divide into time denoted parcels) their recorded content as uploaded to the such a web-based platform;
(c) allowing any owner of content to access a web interface so that they may annotate their recorded content segments as uploaded to such a web-based platform with such annotations taking the form of descriptive tags, demographic tags, or analogous;
(d) allowing any owner of content to access a web interface so that they may specify the manner in which they will allow non-content owning parties, affiliates, or themselves to encode meta data into their recorded content segments as uploaded to such a web-based platform, with such specifications setting forth pricing terms, payment delivery terms, and/or other analogous terms;
(e) allowing any party wishing to encode meta data into such uploaded recorded content to access a web interface so that they may search and review uploaded and annotated recorded content segments residing on such a web-based platform;
(f) allowing any party wishing to encode meta data into such uploaded recorded content to access a web interface so that they may select a particular uploaded recorded content segment residing on such a web-based platform;
(g) allowing any party wishing to encode meta data into such uploaded content to access a web interface so that they may effect an on-line purchase from the owner of the selected content the right to embed their meta data within that particular recorded content segment prior to that recorded content segment's ultimate distribution to its audio listening or video viewing audience;
(h) allowing any party wishing to encode meta data into such uploaded recorded content segment to access a web interface so that they may upload their meta data to such a web-based platform and do so by utilizing an assortment of dynamic input fields in the form of templates, radio buttons, text insertion fields, scroll down menus, and/or other analogous web-based data submission tools, and do so for the purpose of having such meta data encoded into the recorded content segment referred to in clause (g) herein;
(i) allowing any party wishing to encode meta data into such uploaded recorded content segment to access a web interface so that they may instruct the system operator of such a web-based platform as to where to forward any interactive response data (e.g. SMS text messages, e-mail, IM data, IP data) as generated by any audience member who has interacted with the meta data as delivered to the audience member via an audience member viewing or listening device (e.g. terrestrial radio and television, cellular phone, Internet enabled computer, satellite radio, Internet enabled television, or any combination thereof) while listening to or viewing the recorded content segment referred to in clause (g) herein;
(j) allowing the system operator of such a web-based platform the ability to directly load relevant additional meta data to such a web-based platform and do so by utilizing an assortment of dynamic input fields in the form of templates, radio buttons, text insertion fields, scroll down menus, and/or other analogous data submission tools, and do so for the purpose of having such additional meta data encoded into the recorded content segment referred to in clause (g) herein;
(k) allowing such a web-based platform to serve the uploaded recorded content segment and meta data (including any system operator provided additional meta data) to any one or more meta data encoding devices with further instructions for the meta data encoding device to encode the meta data (including any system operator provided additional meta data) into the recorded content segment;
(l) allowing the meta data encoding device to deliver one copy of the recorded content segment and its encoded meta data back to the web-based platform for storage by the system operator and delivery of the same to a networked location of the content owner's choosing and, if so permitted by the owner of the content, to a networked location specified by the party providing the encoded meta data; and
(m) allowing the meta data encoding device to deliver a second copy of the recorded content segment and its encoded meta data to the system operator's processing and database facilities for further action to be taken by the system operator.

56. A system applicable to all aspects of web-based pairing of interactive meta data to any type of audio and/or video content, being comprised of an integrated suite of online systems and applications, including but not limited to an HTTP server, relational database management system, transaction engine, indexer, payment processor, and notification server, which is capable of accessing and utilizing any one or more meta data encoding devices, and is further capable of:
(a) allowing any owner of content to access a web interface so that they may upload to a web-based platform a copy of a schedule relating to their anticipated live broadcast content;
(b) allowing any owner of content to access a web interface so that they may segment (divide into time denoted parcels) their schedule relating to their anticipated live broadcast content as uploaded to the such a web-based platform;
(c) allowing any owner of content to access a web interface so that they may annotate their schedule relating to their anticipated live broadcast content segments as uploaded to such a web-based platform with such annotations taking the form of descriptive tags, demographic tags, or analogous;
(d) allowing any owner of content to access a web interface so that they may specify the manner in which they will allow non-content owning parties, affiliates, or themselves to encode meta data into their schedule relating to their anticipated live broadcast content segments as uploaded to such a web-based platform, with such specifications setting forth pricing terms, payment delivery terms, and/or other analogous terms;
(e) allowing any party wishing to encode meta data into such uploaded schedule relating to anticipated live broadcast content segment to access a web interface so that they may search and review uploaded and annotated schedules relating to anticipated live broadcast content segments residing on such a web-based platform;
(f) allowing any party wishing to encode meta data into such uploaded schedules relating to anticipated live broadcast content to access a web interface so that they may select a particular uploaded schedule relating to an anticipated live broadcast content segment residing on such a web-based platform;
(g) allowing any party wishing to encode meta data into such uploaded content to access a web interface so that they may effect an on-line purchase from the owner of the selected content the right to embed their meta data within that particular schedule relating to an anticipated live broadcast content segment prior to that anticipated live broadcast content segment's ultimate distribution to its audio listening or video viewing audience;
(h) allowing any party wishing to encode meta data into such an uploaded schedule relating to a segment of anticipated live broadcast content to access a web interface so that they may upload their meta data to such a web-based platform and do so by utilizing an assortment of dynamic input fields in the form of templates, radio buttons, text insertion fields, scroll down menus, and/or other analogous web-based data submission tools, and do so for the purpose of having such meta data encoded into the uploaded schedule relating to an anticipated live broadcast content segment referred to in clause (g) herein;
(i) allowing any party wishing to encode meta data into such uploaded schedule relating to an anticipated live broadcast content segment to access a web interface so that they may instruct the system operator of such a web-based platform as to where to forward any interactive response data (e.g. SMS text messages, e-mail, IM data, IP data) as generated by any audience member who has interacted with the meta data as delivered to the audience member via an audience member viewing or listening device (e.g. terrestrial radio and television, cellular phone, Internet enabled computer, satellite radio, Internet enabled television, or any combination thereof) while listening to or viewing the uploaded schedule relating to the anticipated live broadcast content segment referred to in clause (g) herein;
(j) allowing the system operator of such a web-based platform the ability to directly load relevant additional meta data to such a web-based platform and do so by utilizing an assortment of dynamic input fields in the form of templates, radio buttons, text insertion fields, scroll down menus, and/or other analogous data submission tools, and do so for the purpose of having such additional meta data encoded into an uploaded schedule relating to an anticipated live broadcast content segment referred to in clause (g) herein;
(k) allowing such a web-based platform to serve the uploaded schedule relating to an anticipated live broadcast content segment and meta data (including any system operator provided additional meta data) to any one or more meta data encoding devices with further instructions for the meta data encoding device to encode the meta data (including any system operator provided additional meta data) into the schedule relating to the anticipated live broadcast content segment;
(l) allowing the meta data encoding device to deliver one copy of the schedule relating to the-anticipated live broadcast content segment and its encoded meta data back to the web-based platform for storage by the system operator and delivery of the same to a networked location of the content owner's choosing and, if so permitted by the owner of the content, to a networked location specified by the party providing the encoded meta data; and
(m) allowing the meta data encoding device to deliver a second copy of the schedule relating to the anticipated live broadcast content segment and its encoded meta data to the system operator's processing and database facilities for further action to be taken by the system operator.

57. A system according to claims 56 wherein the web-based platform allows any party wishing to encode meta data to access a web interface where the party wishing to encode meta data must first engage in a bidding process against other prospective parties wishing to encode meta data for the right to purchase from the owner of the content the right to embed their meta data within that particular segment of content where the highest bidding party wishing to encode meta data agrees to pay to the owner of the content up to the value of their highest bid submitted and where the auction process formats are consistent with any one of the following generally accepted auction models:
(b) English Auction;
(c) Dutch Auction;
(d) Absolute Auction, also known as a No-Reserve Auction or Auction Without Reserve;
(e) Sealed First-Price Auction, also known as Sealed High-Bid Auction or First-Price Sealed-Bid Auction;
(f) Sealed Second-Price Auction, also known as a Vickrey Auction;
(g) Reverse Auction or Procurement Auction;
(h) digital Art Auction;
(i) Unique Bid Auction;
(j) Buy-Out Auction;
(k) Combinatorial Auction; or
(l) any analogous or combined auction format drawing from one or more of the auction types listed in this claim 4(a)-(j).

58. A system according to claims 56 wherein the web-based platform allows the owner of content to access a web interface where the owner of content may categorically label their content once it has been uploaded to the web-based platform (and do such labeling by utilizing an assortment of dynamic input fields in the form of templates, radio buttons, text insertion fields, scroll down menus, and/or other analogous web-based data submission tools), with such categorical labels producing a set of content tag annotations whose information encompasses any one or more of the following descriptive fields:
(a) applicable titles, summaries, or abstracts associated with the content;
(b) applicable subject matter of the content (comedy, drama, music, mystery, horror, sci-fi, documentary, news, educational, public service, home shopping, sport, gaming, gambling, travel, politics, and/or analogous);
(c) applicable production details relating to the content (date of creation, place of creation, language, creation medium, performing artists, script or lyric writers, production crew, direction crews, and/or analogous);
(d) applicable targeted audience demographics of the content (race, sex, sexual orientation, religion, age, geographic location, level of education, political orientation, profession, income bracket, and/or analogous);
(e) applicable storage mediums intended for the content (DVD, CD, VHS Tape, celluloid tape, silicon-based memory, magnetic memory drive, and/or analogous);
(f) applicable delivery mediums intended for the content (television broadcast, radio broadcast, Internet broadcast, physical delivery of recorded medium, public venues, events, and/or analogous);
(g) applicable broadcast standards intended for the content (PAL, NTSC, SECAM, ISDB, ATSC, DVB, DVM, DAB, and/or analogous);
(h) applicable delivery markets intended for the content (geographic regions, times, dates, and/or analogous); and
(i) applicable methods for purchasing the right to embed meta data into the content (fixed-price, performance-based, auction type, and/or analogous).

59. A system according to claims 56 wherein the web-based platform allows any party wishing to encode meta data to access a web interface where the party wishing to encode meta data may search the web-based platform for uploaded content by its categorical content tag annotations prior to taking further steps to encode its own meta data into the same, with such categorical content tag annotation search capabilities encompassing any one or more of the following descriptive fields:
(a) applicable titles, summaries, or abstracts associated with the content;
(b) applicable subject matter of the content (comedy, drama, music, mystery, horror, sci-fi, documentary, news, educational, public service, home shopping, sport, gaming, gambling, travel, politics, and/or analogous);
(c) applicable production details relating to the content (date of creation, place of creation, language, creation medium, performing artists, script or lyric writers, production crew, direction crews, and/or analogous);
(d) applicable targeted audience demographics of the content (race, sex, sexual orientation, religion, age, geographic location, level of education, political orientation, profession, income bracket, and/or analogous);
(e) applicable storage mediums intended for the content (DVD, CD, VHS Tape, celluloid tape, silicon-based memory, magnetic memory drive, and/or analogous);
(f) applicable delivery mediums intended for the content (television broadcast, radio broadcast, Internet broadcast, physical delivery of recorded medium, public venues, events, and/or analogous);
(g) applicable broadcast standards intended for the content (PAL, NTSC, SECAM, ISDB, ATSC, DVB, DVM, DAB, and/or analogous);
(h) applicable delivery markets intended for the content (geographic regions, times, dates, and/or analogous); and
(i) applicable methods for purchasing the right to embed meta data into the content (fixed-price, performance-based, highest bid, and/or analogous).

60. A system according to claims 56 wherein the web-based platform generates any one or more unique tracking identification codes designed to label and monitor each provider of content to the web-based platform, each provider of meta data to the web-based platform, each segment of content (or schedule thereof) uploaded to the web-based platform, and each segment of content (or schedule thereof) uploaded to the web-based platform that has been paired with meta data for subsequent encoding, and where any one or more of these tracking identification codes are encoded into the relevant content segment (or schedule thereof) as additional meta data by any meta data encoding device, with such encoded tracking identification codes being specifically capable of:
(a) being subsequently delivered to the system operator's processing and database facilities as part of any interactive communication sent from the encoded content's viewing and/or listening audience in response to having listened to and/or viewed that encoded content and
(b) being analyzed in conjunction with other data associated with these interactive communications as received by the system operator, such other associated data including, but not limited to information relating to the time and place of such listening or viewing, the audience member's level and type of interaction with such content, or other such data that might be collected by the system operator in the course of these interactive communications.

61. A system according to claims 56 wherein the web-based platform allows for the encoding of meta data specifying time expiry instructions which effects a cancellation, in whole or in part, of the functionality of the meta data at any one or more pre-determined future points in time as specified by the party providing the meta data at the time such content is encoded, with such cancellation of functionality being established in anticipation of the content and its encoded meta data surviving past its initial distribution date due to its potential for being stored within a recordable medium, and where such cancellation of functionality is effected by any combined operation of:
(a) a meta data decoding device;
(b) any interactive data transport apparatus linking an audience member's content listening and/or viewing device with the audience member's interactive data return path device;
(c) any software application (e.g. a java application) resident on any of the audience members' listening and/or viewing devices or any interactive data transport apparatus linked thereto;
(d) any software application (e.g. a java application) resident on any of the audience member's interactive data return path device; or
(e) any system operator processing and database functionality.

62. A system according to claims 56 wherein the web-based platform allows for the encoding of additional meta data by the system operator specifying time expiry instructions which effects a cancellation, in whole or in part, of the functionality of the meta data at any one or more pre-determined future points in time as specified by the owner of the content or the system operator at the time such content is encoded, with such cancellation of functionality being established in anticipation of the content and its encoded meta data surviving past its initial distribution date due to its potential for being stored within a recordable medium, and where such cancellation of functionality is effected by any combined operation of:
(a) a meta data decoding device;
(b) any interactive data relay apparatus linking a audience member's content listening and/or viewing device with the audience member's interactive data return path device;
(c) any software application (e.g. a java application) resident on any of the audience members' listening and/or viewing devices or any interactive data transport apparatus linked thereto;
(d) any software application (e.g. a java application) resident on any of the audience member's interactive data return path device; or
(e) any system operator processing and database functionality.

63. A system according to claims 62 wherein the whole or partial cancellation of functionality may be effected before the substance (e.g. text message, pop-up message) of the interactive meta data is presented to the audience member when the time expiry instruction as specified in the meta data or additional meta data calls for the cancellation of functionality to be effected by either the:
(a) a meta data decoding device;
(b) any interactive data relay apparatus linking a audience member's content listening and/or viewing device with the audience member's interactive data return path device;
(c) any software application (e.g. a java application) resident on any of the audience members' listening and/or viewing devices or any interactive data transport apparatus linked thereto; or
(d) any software application (e.g. a java application) resident on any of the audience member's interactive data return path device.

64. A system according to claims 56 wherein the web-based platform allows for the encoding of meta data specifying age limit instructions which effects a cancellation, in whole or in part, of the functionality of the meta data if the functionality of the data return path device and/or java application resident therein has data confirming that the audience member using the data return path device is not of sufficient age to view the contents of the meta data provided by the party providing the meta data at the time such content is encoded, and where such cancellation of functionality is effected by any combined operation of:
(a) a meta data decoding device;
(b) any interactive data transport apparatus linking an audience member's content listening and/or viewing device with the audience member's interactive data return path device;
(c) any software application (e.g. a java application) resident on any of the audience members' listening and/or viewing devices or any interactive data transport apparatus linked thereto;
(d) any software application (e.g. a java application) resident on any of the audience member's interactive data return path device; or
(e) any system operator processing and database functionality.

65. A system according to claims 56 wherein the web-based platform allows for the encoding of additional meta data by the system operator specifying age limit instructions which effects a cancellation, in whole or in part, of the functionality of the meta data if the functionality of the data return path device and/or java application resident therein has data confirming that the audience member using the data return path device is not of sufficient age to view the contents of the meta data provided by the party providing the meta data at the time such content is encoded, and where such cancellation of functionality is effected by any combined operation of:
(a) a meta data decoding device;
(b) any interactive data relay apparatus linking an audience member's content listening and/or viewing device with the audience member's interactive data return path device;
(c) any software application (e.g. a java application) resident on any of the audience members' listening and/or viewing devices or any interactive data transport apparatus linked thereto;
(d) any software application (e.g. a java application) resident on any of the audience member's interactive data return path device; or
(e) any system operator processing and database functionality.

66. A system according to claims 65 wherein the whole or partial cancellation of functionality may be effected before the substance (e.g. text message, pop-up message) of the interactive meta data is presented to the audience member when the age limit instruction as specified in the meta data or additional meta data calls for the cancellation of functionality to be effected by either the:
(a) a meta data decoding device;
(b) any interactive data relay apparatus linking an audience member's content listening and/or viewing device with the audience member's interactive data return path device;
(c) any software application (e.g. a java application) resident on any of the audience members' listening and/or viewing devices or any interactive data transport apparatus linked thereto; or
(d) any software application (e.g. a java application) resident on any of the audience member's interactive data return path device.

67. A system according to claims 56 wherein the web-based platform allows for the encoding of meta data specifying location limit instructions which effects a cancellation, in whole or in part, of the functionality of the meta data if the functionality of the data return path device and/or java application resident therein has data confirming that the audience member using the data return path device is not located within a permissive jurisdiction to view the contents of the meta data provided by the party providing the meta data at the time such content is encoded, and where such cancellation of functionality is effected by any combined operation of:
(a) a meta data decoding device;
(b) any interactive data transport apparatus linking an audience member's content listening and/or viewing device with the audience member's interactive data return path device;
(c) any software application (e.g. a java application) resident on any of the audience members' listening and/or viewing devices or any interactive data transport apparatus linked thereto;
(d) any software application (e.g. a java application) resident on any of the audience member's interactive data return path device; or
(e) any system operator processing and database functionality.

68. A system according to claims 56 wherein the web-based platform allows for the encoding of additional meta data by the system operator specifying location limit instructions which effects a cancellation, in whole or in part, of the functionality of the meta data if the functionality of the data return path device and/or java application resident therein has data confirming that the audience member using the data return path device is not located within a permissive jurisdiction to view the contents of the meta data provided by the party providing the meta data at the time such content is encoded, and where such cancellation of functionality is effected by any combined operation of:
(a) a meta data decoding device;
(b) any interactive data relay apparatus linking an audience member's content listening and/or viewing device with the audience member's interactive data return path device;
(c) any software application (e.g. a java application) resident on any of the audience members' listening and/or viewing devices or any interactive data transport apparatus linked thereto;
(d) any software application (e.g. a java application) resident on any of the audience member's interactive data return path device; or
(e) any system operator processing and database functionality.

69. A system according to claims 68 wherein the whole or partial cancellation of functionality may be effected before the substance (e.g. text message, pop-up message) of the interactive meta data is presented to the audience member when the location limit instruction as specified in the meta data or additional meta data calls for the cancellation of functionality to be effected by either the:
(a) meta data decoding device;
(b) any interactive data relay apparatus linking an audience member's content listening and/or viewing device with the audience member's interactive data return path device;
(c) any software application (e.g. a java application) resident on any of the audience members' listening and/or viewing devices or any interactive data transport apparatus linked thereto; or
(d) any software application (e.g. a java application) resident on any of the audience member's interactive data return path device.

70. A system according to claims 44 wherein the externally hosted and/or internally housed component comprised of the meta data decoder and short-range wireless transceiver have therein an externally accessible slot for insertion, storage, and removal of a digital memory stick or analogous, with the purpose of such slot and memory stick facilitating the delivery of initial and/or updated software components to any one or more of the meta data decoder, short-range wireless transceiver, and/or target devices involved in the operation of the current invention.
